(19) United States
(12) Patent Application Publication
(10) Pub. No.: US 2024/0109398 A1
(43) Pub. Date: Apr. 4, 2024

(54) VEHICLE THERMAL MANAGEMENT SYSTEM AND METHOD FOR CONTROLLING THE SAME

(71) Applicants: Hyundai Motor Company, Seoul (KR); Kia Corporation, Seoul (KR)

(72) Inventors: Ki Hyun Kim, Seoul (KR); Jin Hwan Lee, Boryeong-si (KR); Wan Je Cho, Hwaseong-si (KR); Jung Ha Park, Gunpo-si (KR)

(21) Appl. No.: 18/180,201

(22) Filed: Mar. 8, 2023

(30) Foreign Application Priority Data
Sep. 29, 2022 (KR) 10-2022-0124642

(51) Int. Cl. B60H 1/00; B60H 1/06; B60H 1/14

(52) U.S. Cl. CPC B60H 1/00885; B60H 1/00342; B60H 1/00485; B60H 1/06; B60H 1/143; B60H 3/024

(57) ABSTRACT

Provided is a vehicle thermal management system, including: an HVAC subsystem thermally connected to a passenger compartment; and a powertrain cooling subsystem thermally connected to a powertrain component. The HVAC subsystem includes a compressor, an interior condenser disposed on the downstream side of the compressor, a heating-side expansion valve disposed on the downstream side of the interior condenser, an exterior heat exchanger disposed on the downstream side of the heating-side expansion valve, a first distribution conduit extending from a downstream point of the heating-side expansion valve to an upstream point of the compressor, a water-cooled heat exchanger disposed on the first distribution conduit, a first control valve disposed on the upstream side of the exterior heat exchanger, a second control valve disposed on the first distribution conduit, a third control valve disposed on the downstream side of the exterior heat exchanger, a cooling-side expansion valve disposed on the downstream side of the third control valve, and an evaporator disposed on the downstream side of the cooling-side expansion valve. The water-cooled heat exchanger transfers heat between the first distribution conduit and the powertrain cooling subsystem.

### CROSS-REFERENCE TO RELATED APPLICATION

This application is based on and claims the benefit of priority to Korean Patent Application No. 10-2022-0124642, filed on Sep. 29, 2022, in the Korean Intellectual Property Office, the disclosure of which is incorporated herein in its entirety by reference.

### TECHNICAL FIELD

The present disclosure relates to a vehicle thermal management system and a method for controlling the same, and more particularly, to a vehicle thermal management system configured to improve heating performance of a heating, ventilation, and air conditioning (HVAC) subsystem by allowing a refrigerant to selectively absorb heat from ambient air and/or waste heat of a powertrain component based on a temperature of the ambient air, a temperature of the powertrain component (a powertrain-side coolant), and a phase of the refrigerant.

### BACKGROUND

With a growing interest in energy efficiency and environmental issues, there is a demand for development of eco-friendly vehicles that can replace internal combustion engine vehicles. Such eco-friendly vehicles are classified into electric vehicles which are driven by using fuel cells or electricity as a power source and hybrid vehicles which are driven by using an engine and a battery.

Electric vehicles or hybrid vehicles include a heating, ventilation, and air conditioning (HVAC) subsystem for air conditioning in a passenger compartment. The HVAC subsystem may be configured to heat and cool the air in the passenger compartment for passenger comfort.

In order to ensure driving safety, electric vehicles or hybrid vehicles include a powertrain cooling subsystem designed to keep powertrain components of a powertrain system at appropriate temperatures and a battery cooling subsystem designed to keep a battery at an appropriate temperature. The powertrain cooling subsystem may cool the powertrain components such as an electric motor, an inverter, OBC, and LDC, thereby keeping the powertrain components at their respective appropriate temperatures. The battery cooling subsystem may cool the battery, thereby keeping the battery at its appropriate temperature.

The powertrain cooling subsystem and the battery cooling subsystem may be thermally connected to the HVAC subsystem for air conditioning in the passenger compartment of the vehicle so that the powertrain cooling subsystem, the battery cooling subsystem, and the HVAC subsystem may form an integrated vehicle thermal management system.

When the HVAC subsystem operates in a heating mode, a refrigerant may absorb heat from a heat source having a relatively high temperature so that the refrigerant may be evaporated (vaporized).

In a vehicle thermal management system according to the related art, however, when the HVAC subsystem operates in the heating mode, the refrigerant may fail to sufficiently absorb heat from the heat source, so the refrigerant evaporation performance of the HVAC subsystem may be relatively reduced. Accordingly, the heating performance of the HVAC subsystem may be reduced.

The above information described in this background section is provided to assist in understanding the background of the inventive concept, and may include any technical concept which is not considered as the prior art that is already known to those skilled in the art.

### SUMMARY

The present disclosure has been made to solve the above-mentioned problems occurring in the prior art while advantages achieved by the prior art are maintained intact.

An aspect of the present disclosure provides a vehicle thermal management system and a method for controlling the same designed to allow a refrigerant to selectively absorb heat from ambient air and/or waste heat of a powertrain component based on a temperature of the ambient air, a temperature of the powertrain component (a powertrain-side coolant), and a phase of the refrigerant, thereby improving refrigerant evaporation performance and heating performance of a heating, ventilation, and air conditioning (HVAC) subsystem.

According to an aspect of the present disclosure, a vehicle thermal management system may include: an HVAC subsystem thermally connected to a passenger compartment; and a powertrain cooling subsystem thermally connected to a powertrain component. The HVAC subsystem may include a compressor, an interior condenser disposed on the downstream side of the compressor, a heating-side expansion valve disposed on the downstream side of the interior condenser, an exterior heat exchanger disposed on the downstream side of the heating-side expansion valve, a first distribution conduit extending from a downstream point of the heating-side expansion valve to an upstream point of the compressor, a water-cooled heat exchanger disposed on the first distribution conduit, a first control valve disposed on the upstream side of the exterior heat exchanger, a second control valve disposed on the first distribution conduit, a third control valve disposed on the downstream side of the exterior heat exchanger, a cooling-side expansion valve disposed on the downstream side of the third control valve, and an evaporator disposed on the downstream side of the cooling-side expansion valve. The water-cooled heat exchanger may be configured to transfer heat between the first distribution conduit and the powertrain cooling subsystem.

The first control valve may include an inlet port communicating with the heating-side expansion valve, and a first outlet port communicating with the exterior heat exchanger. The first control valve may be configured to adjust the opening degree of the first outlet port.

The vehicle thermal management system may further include a dehumidification bypass conduit extending from the downstream point of the heating-side expansion valve to an upstream point of the evaporator. The first control valve may further include a second outlet port communicating with the dehumidification bypass conduit.

The second control valve may include an inlet port communicating with the water-cooled heat exchanger, and a first outlet port communicating with the compressor. The second control valve may be configured to adjust the opening degree of the first outlet port.

The vehicle thermal management system may further include a first branch conduit extending from the first distribution conduit to an upstream point of the exterior heat exchanger. The second control valve may further include a second outlet port communicating with the first branch conduit. The second control valve may be configured to adjust the opening degree of the second outlet port.

The vehicle thermal management system may further include a second branch conduit extending from the first distribution conduit to a downstream point of the exterior heat exchanger.

The third control valve may include an inlet port communicating with the exterior heat exchange and a first outlet port communicating with the second branch conduit.

The vehicle thermal management system may further include a battery cooling subsystem thermally connected to a battery; a second distribution conduit extending from an upstream point of the cooling-side expansion valve to the upstream point of the compressor; and a battery chiller configured to transfer heat between the second distribution conduit and the battery cooling subsystem.

The third control valve may further include a second outlet port communicating with the battery chiller.

According to another aspect of the present disclosure, a method for controlling a vehicle thermal management system may include: allowing a powertrain-side coolant to circulate through a powertrain cooling subsystem; allowing a refrigerant to circulate through an HVAC subsystem in a heating mode; and selectively adjusting a flow rate of the refrigerant into an exterior heat exchanger and/or a flow rate of the refrigerant into a water-cooled heat exchanger based on a temperature of the powertrain-side coolant or a phase of the refrigerant. The exterior heat exchanger may be configured to transfer heat between ambient air and the refrigerant, and the water-cooled heat exchanger may be configured to transfer heat between the refrigerant and the powertrain-side coolant.

The method may further include: adjusting the flow rate of the refrigerant into the exterior heat exchanger based on the temperature of the powertrain-side coolant, a temperature of the ambient air, and a temperature of a powertrain component when the temperature of the powertrain-side coolant is lower than the temperature of the ambient air; and increasing the flow rate of the refrigerant into the exterior heat exchanger by a predetermined flow rate when actual heating performance of the HVAC subsystem for a passenger compartment is higher than reference heating performance.

The method may further include: adjusting the flow rate of the refrigerant into the water-cooled heat exchanger based on the temperature of the powertrain-side coolant, a temperature of the ambient air, and a temperature of a powertrain component when a temperature difference value between the temperature of the powertrain-side coolant and the temperature of the ambient air is greater than or equal to a threshold value; and increasing the flow rate of the refrigerant into the water-cooled heat exchanger by a predetermined flow rate when actual heating performance of the HVAC subsystem for a passenger compartment is higher than reference heating performance.

The method may further include: increasing the flow rate of the refrigerant into the exterior heat exchanger above the flow rate of the refrigerant into the water-cooled heat exchanger when a temperature of a powertrain component is higher than or equal to a first reference temperature.

The method may further include: adjusting the flow rate of the refrigerant into the exterior heat exchanger based on the temperature of the powertrain-side coolant, the temperature of the ambient air, and the temperature of the powertrain component when the temperature of the powertrain component is lower than the first reference temperature; and increasing the flow rate of the refrigerant into the water-cooled heat exchanger by a predetermined flow rate when actual heating performance of the HVAC subsystem for a passenger compartment is higher than reference heating performance.

The method may further include: allowing a battery-side coolant to circulate through a battery cooling subsystem; and directing the refrigerant discharged from the exterior heat exchanger to a battery chiller when a temperature of a battery is higher than or equal to a second reference temperature. The battery chiller may be configured to transfer heat between the refrigerant and the battery-side coolant.

The method may further include: adjusting the flow rate of the refrigerant into the exterior heat exchanger based on the temperature of the powertrain-side coolant, a temperature of the ambient air, and a temperature of a powertrain component; and increasing the flow rate of the refrigerant into the water-cooled heat exchanger by a predetermined flow rate when actual heating performance of the HVAC subsystem for a passenger compartment is higher than reference heating performance.

The method may further include: allowing a battery-side coolant to circulate through a battery cooling subsystem when a charging time of a battery is within a threshold time; and directing the refrigerant discharged from the exterior heat exchanger to a battery chiller when a temperature of the battery is higher than or equal to a second reference temperature. The battery chiller may be configured to transfer heat between the refrigerant and the battery-side coolant.

The method may further include: adjusting the flow rate of the refrigerant into the exterior heat exchanger based on temperature and pressure of the refrigerant when the refrigerant discharged from the exterior heat exchanger or the water-cooled heat exchanger is in a vapor phase; and increasing the flow rate of the refrigerant into the water-cooled heat exchanger by a predetermined flow rate when actual heating performance of the HVAC subsystem for a passenger compartment is higher than reference heating performance.

The method may further include: determining whether the powertrain-side coolant bypasses a powertrain radiator when the refrigerant discharged from the exterior heat exchanger or the water-cooled heat exchanger is in two phases; and adjusting the flow rate of the refrigerant into the water-cooled heat exchanger based on temperature and pressure of the refrigerant when the powertrain-side coolant bypasses the powertrain radiator.

### BRIEF DESCRIPTION OF THE DRAWINGS

The above and other objects, features and advantages of the present disclosure will be more apparent from the following detailed description taken in conjunction with the accompanying drawings:

FIG. 1 illustrates a configuration of a vehicle thermal management system according to an exemplary embodiment of the present disclosure;

FIG. 2 illustrates a configuration of the vehicle thermal management system illustrated in FIG. 1, in a state in which a heating, ventilation, and air conditioning (HVAC) subsystem operates in a heating mode;

FIG. 3 illustrates a configuration of the vehicle thermal management system illustrated in FIG. 1, in a state in which an HVAC subsystem operates in a heating mode and a refrigerant passes through a battery chiller;

FIG. 4 illustrates a configuration of a vehicle thermal management system according to another exemplary embodiment of the present disclosure;

FIG. 5 illustrates a configuration of a vehicle thermal management system according to another exemplary embodiment of the present disclosure;

FIG. 6 illustrates a flowchart of a method for controlling a vehicle thermal management system according to an exemplary embodiment of the present disclosure;

FIG. 7A illustrates a flowchart of a method for controlling the flow of a refrigerant and/or the flow rate of the refrigerant based on a temperature of a powertrain-side coolant when an HVAC subsystem operates in a heating mode in a vehicle thermal management system according to an exemplary embodiment of the present disclosure;

FIG. 7B illustrates another flowchart of a method for controlling the flow of a refrigerant and/or the flow rate of the refrigerant based on a temperature of a powertrain-side coolant when an HVAC subsystem operates in a heating mode in a vehicle thermal management system according to an exemplary embodiment of the present disclosure;

FIG. 7C illustrates another flowchart of a method for controlling the flow of a refrigerant and/or the flow rate of the refrigerant based on a temperature of a powertrain-side coolant when an HVAC subsystem operates in a heating mode in a vehicle thermal management system according to an exemplary embodiment of the present disclosure;

FIG. 8 illustrates a flowchart of a method for controlling the flow of a refrigerant and/or the flow rate of the refrigerant in a condition in which a battery is overheated in a vehicle thermal management system according to an exemplary embodiment of the present disclosure;

FIG. 9A illustrates a flowchart of a method for controlling the flow of a refrigerant and/or the flow rate of the refrigerant based on a phase of the refrigerant when an HVAC subsystem operates in a heating mode in a vehicle thermal management system according to an exemplary embodiment of the present disclosure;

FIG. 9B illustrates another flowchart of a method for controlling the flow of a refrigerant and/or the flow rate of the refrigerant based on a phase of the refrigerant when an HVAC subsystem operates in a heating mode in a vehicle thermal management system according to an exemplary embodiment of the present disclosure;

FIG. 10 illustrates a flowchart of a method for controlling the flow of a refrigerant and/or the flow rate of the refrigerant based on whether frosting occurs in an exterior heat exchanger in a vehicle thermal management system according to an exemplary embodiment of the present disclosure;

FIG. 11A illustrates a partially cut-away perspective view of a first control valve in the vehicle thermal management system illustrated in FIG. 1;

FIG. 11B illustrates a partially cut-away perspective view of a first control valve in the vehicle thermal management system illustrated in FIG. 1, which is viewed in a different direction;

FIG. 11C illustrates a perspective view of a ball component of the first control valve illustrated in FIGS. 11A and 11B;

FIG. 11D illustrates a side sectional view of a state in which an L-shaped passage of a ball component is fully aligned with a second outlet port in a first control valve of the vehicle thermal management system illustrated in FIG. 1;

FIG. 11E illustrates a side sectional view of a state in which an L-shaped passage of a ball component is fully aligned with a first outlet port in a first control valve of the vehicle thermal management system illustrated in FIG. 1;

FIG. 11F illustrates a top sectional view of a state in which an L-shaped passage of a ball component is fully aligned with a second outlet port in a first control valve of the vehicle thermal management system illustrated in FIG. 1;

FIG. 11G illustrates a top sectional view of a state in which an L-shaped passage of a ball component is fully aligned with a first outlet port in a first control valve of the vehicle thermal management system illustrated in FIG. 1;

FIG. 11H illustrates a top sectional view of a state in which an L-shaped passage of a ball component is partially aligned with a first outlet port and the L-shaped passage of the ball component communicates with a second outlet port through a groove in a first control valve of the vehicle thermal management system illustrated in FIG. 1;

FIG. 11I illustrates a top sectional view of a state in which an L-shaped passage of a ball component is fully aligned with a second outlet port in a first control valve according to another exemplary embodiment of the present disclosure;

FIG. 11J illustrates a top sectional view of a state in which an L-shaped passage of a ball component is fully aligned with a first outlet port in a first control valve according to another exemplary embodiment of the present disclosure;

FIG. 11K illustrates a top sectional view of a state in which an L-shaped passage of a ball component is partially aligned with a first outlet port and the L-shaped passage of the ball component communicates with a second outlet port through a groove in a first control valve according to another exemplary embodiment of the present disclosure;

FIG. 12 illustrates a partially cut-away perspective view of a first control valve in the vehicle thermal management system illustrated in FIG. 4;

FIG. 13A illustrates a partially cut-away perspective view of a second control valve in the vehicle thermal management system illustrated in FIG. 1;

FIG. 13B illustrates a partially cut-away perspective view of a second control valve in the vehicle thermal management system illustrated in FIG. 1, which is viewed in a different direction;

FIG. 13C illustrates a perspective view of a ball component of the second control valve illustrated in FIGS. 13A and 13B;

FIG. 13D illustrates a side sectional view of a state in which an L-shaped passage of a ball component is fully aligned with a second outlet port in a second control valve of the vehicle thermal management system illustrated in FIG. 1;

FIG. 13E illustrates a side sectional view of a state in which an L-shaped passage of a ball component is fully aligned with a first outlet port in a second control valve of the vehicle thermal management system illustrated in FIG. 1;

FIG. 13F illustrates a top sectional view of a state in which an L-shaped passage of a ball component is fully aligned with a second outlet port in a second control valve of the vehicle thermal management system illustrated in FIG. 1;

FIG. 13G illustrates a top sectional view of a state in which an L-shaped passage of a ball component is fully aligned with a first outlet port in a second control valve of the vehicle thermal management system illustrated in FIG. 1;

FIG. 13H illustrates a top sectional view of a state in which an L-shaped passage of a ball component is partially aligned with a first outlet port and the L-shaped passage of the ball component communicates with a second outlet port through a groove in a second control valve of the vehicle thermal management system illustrated in FIG. 1;

FIG. 13I illustrates a top sectional view of a state in which an L-shaped passage of a ball component is fully aligned with a second outlet port in a second control valve according to another exemplary embodiment of the present disclosure;

FIG. 13J illustrates a top sectional view of a state in which an L-shaped passage of a ball component is fully aligned with a first outlet port in a second control valve according to another exemplary embodiment of the present disclosure;

FIG. 13K illustrates a top sectional view of a state in which an L-shaped passage of a ball component is partially aligned with a first outlet port and the L-shaped passage of the ball component communicates with a second outlet port through a groove in a second control valve according to another exemplary embodiment of the present disclosure;

FIG. 14A illustrates a cut-away perspective view of a third control valve in the vehicle thermal management system illustrated in FIG. 1;

FIG. 14B illustrates a cut-away perspective view of a third control valve in the vehicle thermal management system illustrated in FIG. 1, which is viewed in a different direction;

FIG. 14C illustrates a perspective view of a ball component of the third control valve illustrated in FIGS. 14A and 14B;

FIG. 14D illustrates a side sectional view of a state in which an L-shaped passage of a ball component is fully aligned with a second outlet port in a third control valve of the vehicle thermal management system illustrated in FIG. 1;

FIG. 14E illustrates a side sectional view of a state in which an L-shaped passage of a ball component is fully aligned with a first outlet port in a third control valve of the vehicle thermal management system illustrated in FIG. 1;

FIG. 14F illustrates a top sectional view of a state in which an L-shaped passage of a ball component is fully aligned with a second outlet port in a third control valve of the vehicle thermal management system illustrated in FIG. 1;

FIG. 14G illustrates a top sectional view of a state in which an L-shaped passage of a ball component is fully aligned with a first outlet port in a third control valve of the vehicle thermal management system illustrated in FIG. 1;

FIG. 14H illustrates a top sectional view of a state in which an L-shaped passage of a ball component is partially aligned with a first outlet port and the L-shaped passage of the ball component communicates with a second outlet port through a groove in a third control valve of the vehicle thermal management system illustrated in FIG. 1;

FIG. 14I illustrates a top sectional view of a state in which an L-shaped passage of a ball component is fully aligned with a second outlet port in a third control valve according to another exemplary embodiment of the present disclosure;

FIG. 14J illustrates a top sectional view of a state in which an L-shaped passage of a ball component is fully aligned with a first outlet port in a third control valve according to another exemplary embodiment of the present disclosure; and

FIG. 14K illustrates a top sectional view of a state in which an L-shaped passage of a ball component is partially aligned with a first outlet port and the L-shaped passage of the ball component communicates with a second outlet port through a groove in a third control valve according to another exemplary embodiment of the present disclosure.

### DETAILED DESCRIPTION

Hereinafter, exemplary embodiments of the present disclosure will be described in detail with reference to the accompanying drawings. In the drawings, the same reference numerals will be used throughout to designate the same or equivalent elements. In addition, a detailed description of well-known techniques associated with the present disclosure will be ruled out in order not to unnecessarily obscure the gist of the present disclosure.

Terms such as first, second, A, B, (a), and (b) may be used to describe the elements in exemplary embodiments of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

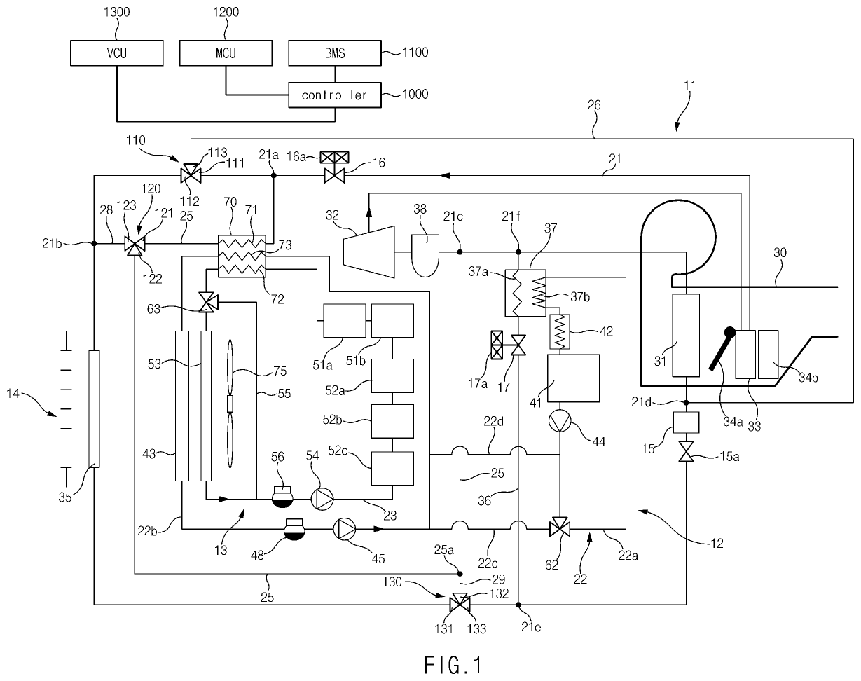

Referring to FIG. 1, a vehicle thermal management system according to an exemplary embodiment of the present disclosure may include a heating, ventilation, and air conditioning (HVAC) subsystem 11 thermally connected to a passenger compartment, a battery cooling subsystem 12 thermally connected to a battery, and a powertrain cooling subsystem 13 thermally connected to powertrain components 51a, 51b, 52a, 52b, and 52c of an electric powertrain system.

(HVAC Subsystem)

The HVAC subsystem 11 may be configured to provide air conditioning (cooling and heating) in the passenger compartment. In particular, the HVAC subsystem 11 may be configured to heat or cool the air in the passenger compartment of the vehicle using a refrigerant circulating in a refrigerant loop 21. The HVAC subsystem 11 may include the refrigerant loop 21 and an HVAC case 30. The refrigerant loop 21 may be fluidly connected to an evaporator 31, a compressor 32, an interior condenser 33, a heating-side expansion valve 16, a water-cooled heat exchanger 70, an exterior heat exchanger 35, a cooling-side expansion valve 15, and a battery chiller 37. The refrigerant loop 21 may be configured to provide various refrigerant circulation paths or refrigerant flow paths based on various operating modes of the vehicle thermal management system.

The compressor 32 may compress the refrigerant and allow the refrigerant to circulate. In particular, the compressor 32 may compress the refrigerant received from the evaporator 31 and/or the battery chiller 37. The compressor 32 may include a compressor motor and a compression section operated by the compressor motor. The refrigerant loop 21 may be fluidly connected to the compression section of the compressor 32.

The HVAC subsystem 11 may include an accumulator 38 located on the upstream side of the compressor 32. The accumulator 38 may be located between the evaporator 31 and the compressor 32, and the accumulator 38 may separate a liquid refrigerant from the refrigerant which is received from the evaporator 31, thereby preventing the liquid refrigerant from being directed into the compressor 32.

The interior condenser 33 may be configured to condense the refrigerant received from the compressor 32, and accordingly the air passing through the interior condenser 33 may be heated by the interior condenser 33. As the air heated by the interior condenser 33 is directed into the passenger compartment, the passenger compartment may be heated.

The exterior heat exchanger 35 may be adjacent to a front grille 14 of the vehicle. Since the exterior heat exchanger 35 is exposed to the outside, heat may be transferred between the exterior heat exchanger 35 and the ambient air (outdoor air). During a cooling operation of the HVAC subsystem 11, the exterior heat exchanger 35 may be configured to condense the refrigerant received from the interior condenser 33. That is, the exterior heat exchanger 35 may serve as an exterior condenser that condenses the refrigerant by transferring heat to the ambient air during the cooling operation of the HVAC subsystem 11. During a heating operation of the HVAC subsystem 11, the exterior heat exchanger 35 may be configured to evaporate the refrigerant received from the heating-side expansion valve 16 and/or the water-cooled heat exchanger 70. That is, the exterior heat exchanger 35 may serve as an exterior evaporator that evaporates the refrigerant by absorbing heat from the ambient air during the heating operation of the HVAC subsystem 11. In particular, the exterior heat exchanger 35 may exchange heat with the ambient air forcibly blown by a cooling fan 75 so that a heat transfer rate between the exterior heat exchanger 35 and the ambient air may be further increased.

The heating-side expansion valve 16 may be located on the upstream side of the exterior heat exchanger 35 and the water-cooled heat exchanger 70 in the refrigerant loop 21. During the heating operation of the HVAC subsystem 11, the heating-side expansion valve 16 may adjust the flow of the refrigerant and/or the flow rate of the refrigerant into the exterior heat exchanger 35 and/or the water-cooled heat exchanger 70. The heating-side expansion valve 16 may be configured to expand the refrigerant received from the interior condenser 33 during the heating operation of the HVAC subsystem 11.

According to an exemplary embodiment, the heating-side expansion valve 16 may be an electronic expansion valve (EXV) having a drive motor 16a. The drive motor 16a may have a shaft which is movable to open or close an orifice defined in a valve body of the heating-side expansion valve 16, and the position of the shaft may be varied depending on the rotation direction, rotation degree, and the like of the drive motor 16a, and thus the opening degree of the orifice of the heating-side expansion valve 16 may be varied. A controller 1000 may control the operation of the drive motor 16a. The opening degree of the heating-side expansion valve 16 may be varied by the controller 1000. As the opening degree of the heating-side expansion valve 16 is varied, the flow rate of the refrigerant into the exterior heat exchanger 35 and/or the water-cooled heat exchanger 70 may be varied. The operation of the drive motor 16a of the heating-side expansion valve 16 may be controlled by the controller 1000 during the heating operation of the HVAC subsystem 11. The heating-side expansion valve 16 may be a full open type EXV. When the HVAC subsystem 11 operates in a cooling mode, the heating-side expansion valve 16 may be fully opened. As the heating-side expansion valve 16 is fully opened to 100%, the refrigerant may pass through the heating-side expansion valve 16 without expansion of the refrigerant.

The HVAC subsystem 11 according to an exemplary embodiment of the present disclosure may include a first distribution conduit 25 extending from a downstream point 21a of the heating-side expansion valve 16 to an upstream point 21c of the compressor 32. The water-cooled heat exchanger 70 may be fluidly connected to the first distribution conduit 25. The refrigerant may be distributed from the downstream point 21a of the heating-side expansion valve 16 to the exterior heat exchanger 35 and the water-cooled heat exchanger 70 through the first distribution conduit 25.

According to an exemplary embodiment, the water-cooled heat exchanger 70 may be configured to transfer heat between the first distribution conduit 25 of the HVAC subsystem 11 and a powertrain coolant loop 23 of the powertrain cooling subsystem 13. That is, the HVAC subsystem 11 may be thermally connected to the powertrain cooling subsystem 13 through the water-cooled heat exchanger 70. The water-cooled heat exchanger 70 may include a first passage 71 fluidly connected to the first distribution conduit 25 of the HVAC subsystem 11, and a second passage 72 fluidly connected to the powertrain coolant loop 23 of the powertrain cooling subsystem 13.

During the heating operation of the HVAC subsystem 11, the refrigerant passing through the first distribution conduit 25 may be evaporated by the water-cooled heat exchanger 70. Specifically, the water-cooled heat exchanger 70 may be configured to evaporate the refrigerant using heat which is received from a powertrain-side coolant circulating in the powertrain coolant loop 23 of the powertrain cooling subsystem 13. That is, during the heating operation of the HVAC subsystem 11, the water-cooled heat exchanger 70 may serve as an evaporator that evaporates the refrigerant by recovering waste heat from the powertrain components 51a, 51b, 52a, 52b, and 52c of the powertrain cooling subsystem 13.

During the cooling operation of the HVAC subsystem 11, the refrigerant passing through the first distribution conduit 25 may be condensed by the water-cooled heat exchanger 70. Specifically, the water-cooled heat exchanger 70 may be configured to condense the refrigerant using heat which is received from the powertrain-side coolant circulating in the powertrain coolant loop 23 of the powertrain cooling subsystem 13.

According to another exemplary embodiment, the water-cooled heat exchanger 70 may further include a third passage 73 fluidly connected to a battery coolant loop 22. The water-cooled heat exchanger 70 may be a plate heat exchanger having the first passage 71, the second passage 72, and the third passage 73 partitioned by a plurality of plates.

The HVAC subsystem 11 according to an exemplary embodiment of the present disclosure may include a first control valve 110 located on the upstream side of the exterior heat exchanger 35, a second control valve 120 located on the first distribution conduit 25, and a third control valve 130 located on the downstream side of the exterior heat exchanger 35.

The first control valve 110 may be located between the downstream point 21a of the heating-side expansion valve 16 and an inlet of the exterior heat exchanger 35. The first control valve 110 may include an inlet port 111 communicating with an outlet of the heating-side expansion valve 16, and a first outlet port 112 communicating with the inlet of the exterior heat exchanger 35. The first control valve 110 may be configured to adjust the opening degree of the first outlet port 112. The first control valve 110 may adjust the opening degree of the first outlet port 112, thereby adjusting the flow rate of the refrigerant into the exterior heat exchanger 35.

Referring to FIG. 1, the HVAC subsystem 11 according to an exemplary embodiment of the present disclosure may further include a dehumidification bypass conduit 26 branching off from the refrigerant loop 21. The dehumidification bypass conduit 26 may extend from the downstream point 21a of the heating-side expansion valve 16 to an upstream point 21d of the evaporator 31. The first control valve 110 may further include a second outlet port 113 communicating with the dehumidification bypass conduit 26. The first control valve 110 may adjust the opening degree of the second outlet port 113. The first control valve 110 may adjust the opening degree of the second outlet port 113, thereby adjusting the flow rate of the refrigerant into the dehumidification bypass conduit 26. When dehumidification in the passenger compartment is required during the heating operation of the HVAC subsystem 11, the first control valve 110 may adjust the opening degree of the second outlet port 113 so that a portion of the refrigerant discharged from the heating-side expansion valve 16 may be directed into the evaporator 31 through the dehumidification bypass conduit 26. Accordingly, the refrigerant directed into the evaporator 31 may absorb heat from the air passing through the evaporator 31, and thus the heating and dehumidification of the passenger compartment may be simultaneously performed. Otherwise, as the first outlet port 112 is closed, the refrigerant may be blocked from flowing into the exterior heat exchanger 35, and the opening degree of the second outlet port 113 may be adjusted to thereby allow the refrigerant to flow into the dehumidification bypass conduit 26. Then, as necessary, the opening degree of the first outlet port 112 may be adjusted so that the refrigerant may also be directed into the exterior heat exchanger 35.

According to an exemplary embodiment, the first control valve 110 may be configured to adjust the opening degree of the first outlet port 112 and the opening degree of the second outlet port 113 individually or simultaneously. Thus, the flow rate of the refrigerant into the exterior heat exchanger and the flow rate of the refrigerant into the dehumidification bypass conduit 26 may be adjusted independently. For example, when the first outlet port 112 is fully opened and the second outlet port 113 is fully closed, the refrigerant may be directed into the exterior heat exchanger 35, and may not be directed into the dehumidification bypass conduit 26. When the second outlet port 113 is fully opened and the first outlet port 112 is fully closed, the refrigerant may be directed into the dehumidification bypass conduit 26, and may not be directed into the exterior heat exchanger 35. In a condition in which dehumidification is prioritized, the opening degree of the second outlet port 113 may be greater than the opening degree of the first outlet port 112 so that the flow rate of the refrigerant into the dehumidification bypass conduit 26 may be higher than the flow rate of the refrigerant into the exterior heat exchanger 35. In a condition in which heat absorption is prioritized, the opening degree of the first outlet port 112 may be greater than the opening degree of the second outlet port 113 so that the flow rate of the refrigerant into the exterior heat exchanger 35 may be higher than the flow rate of the refrigerant into the dehumidification bypass conduit 26.

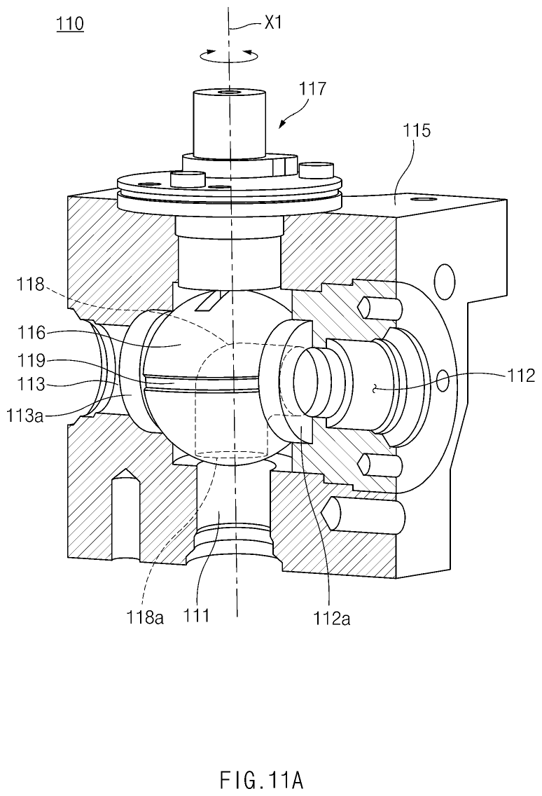

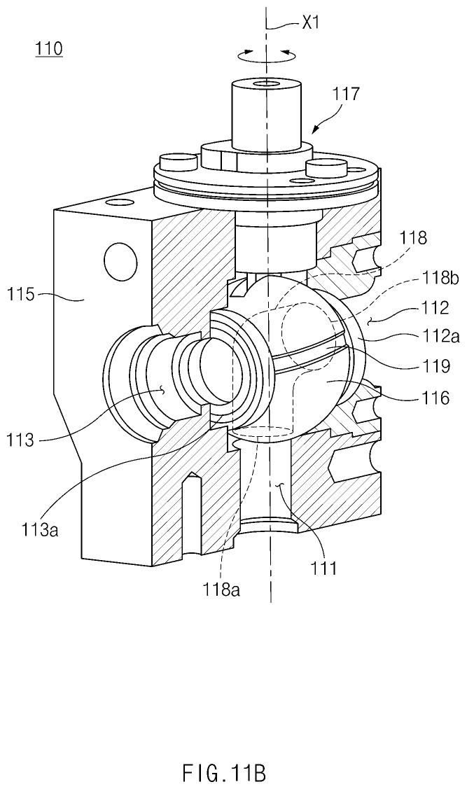

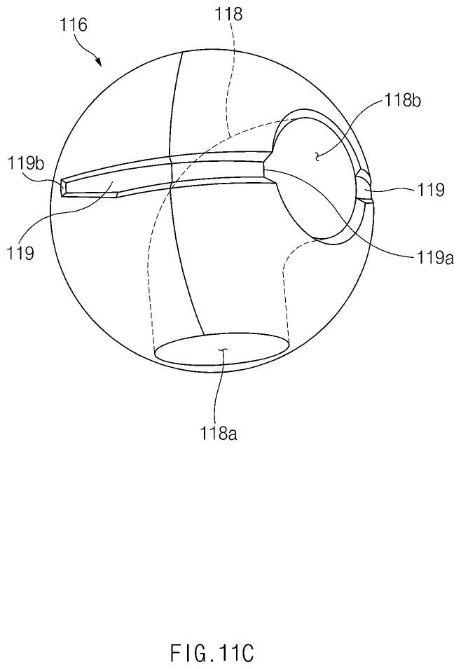

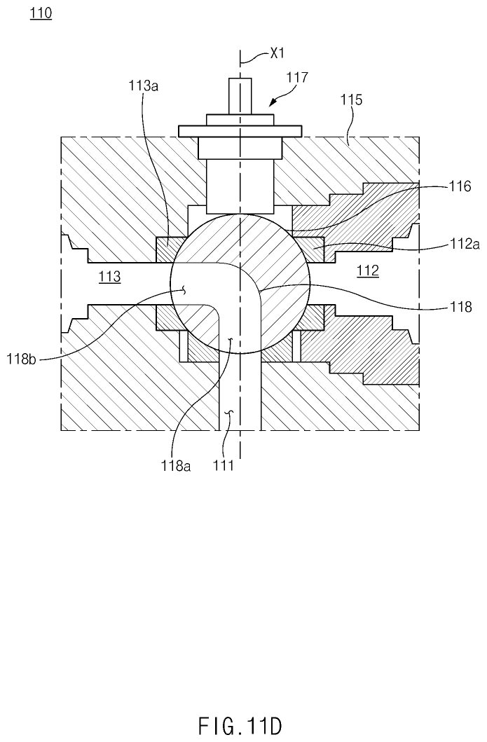

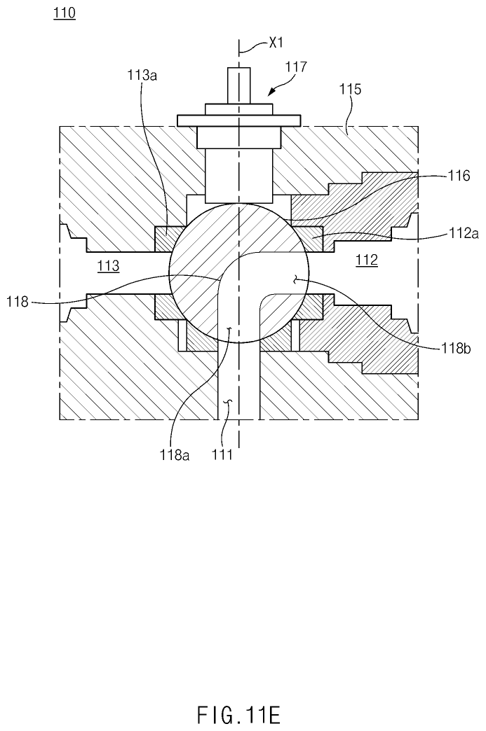

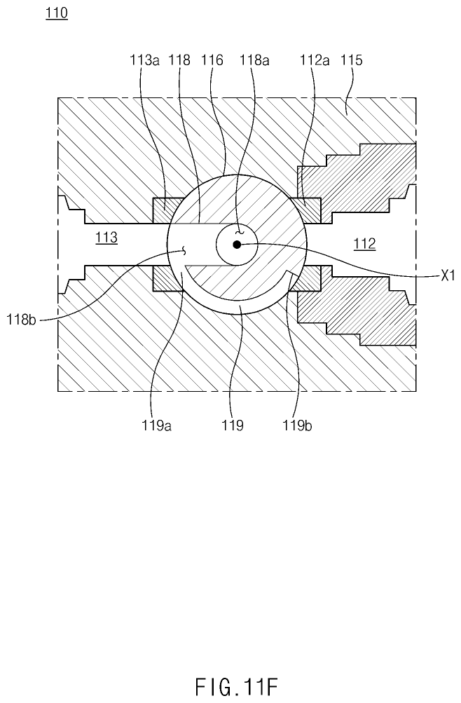

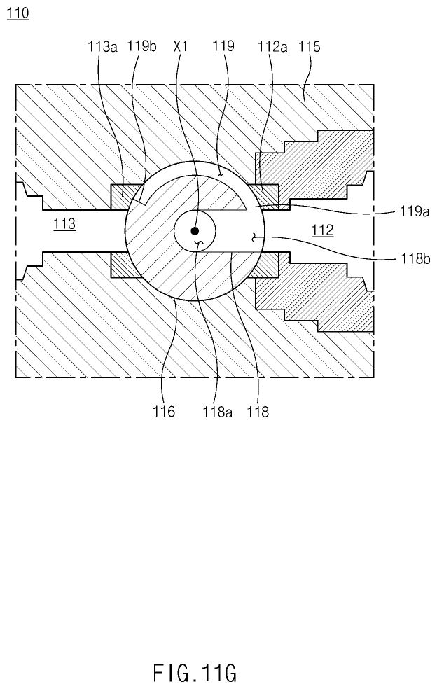

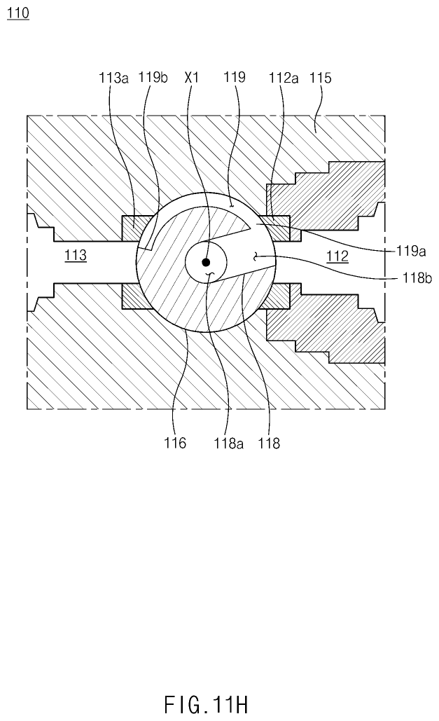

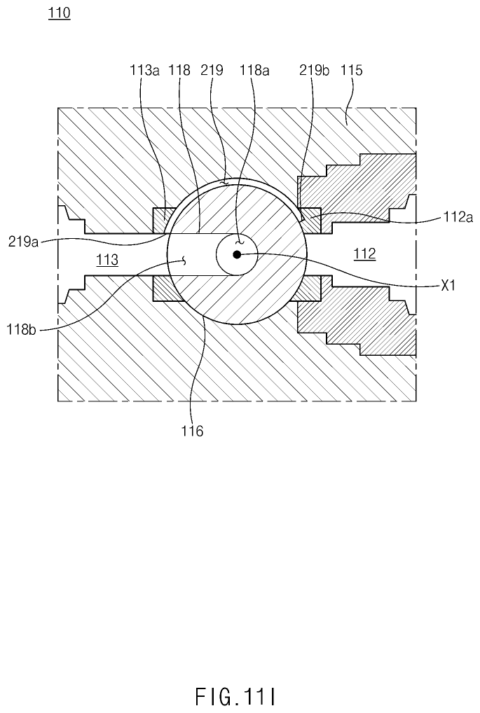

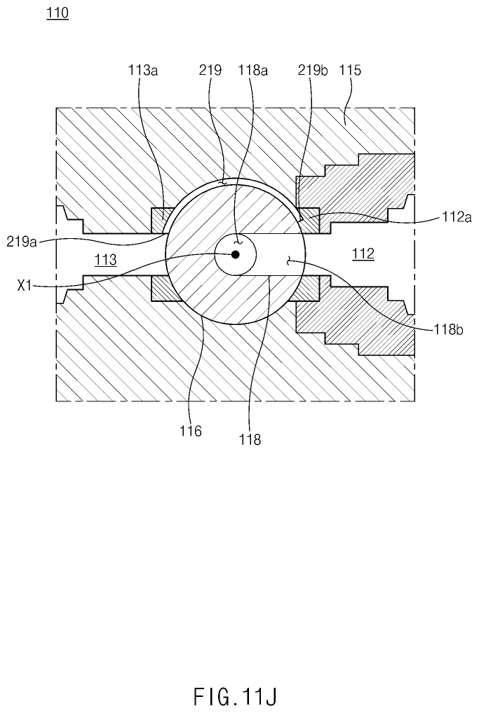

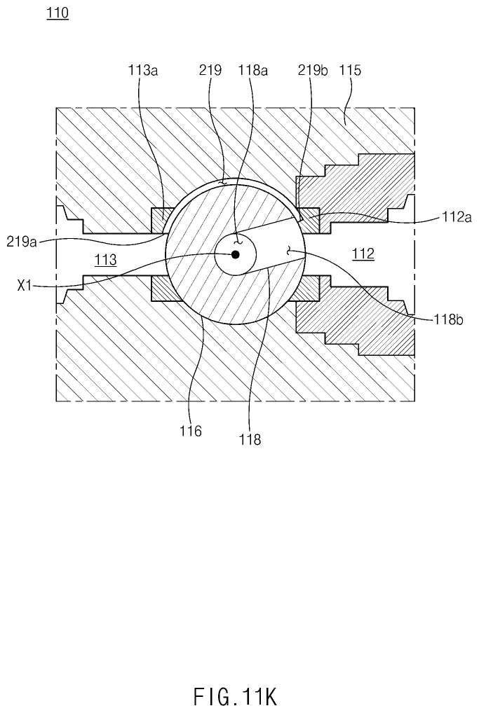

FIGS. 11A to 11H illustrate the first control valve 110 according to an exemplary embodiment of the present disclosure.

Referring to FIGS. 11A and 11B, the first control valve 110 may include a valve body 115, a ball component 116 rotatably received in the valve body 115, and an actuator 117 causing the ball component 116 to rotate.

Referring to FIGS. 11A and 11B, the valve body 115 may have the inlet port 111, the first outlet port 112, and the second outlet port 113. The first outlet port 112 may be opposite to the second outlet port 113, and a central axis of the first outlet port 112 may be aligned with a central axis of the second outlet port 113. The central axis of the first outlet port 112 and the central axis of the second outlet port 113 may be perpendicular to a central axis of the inlet port 111. A first sealing member 112a may be disposed in the first outlet port 112, and the first sealing member 112a may contact the ball component 116. A second sealing member 113a may be disposed in the second outlet port 113, and the second sealing member 113a may contact the ball component 116.

The ball component 116 may be configured to rotate around a rotation axis X1 between the inlet port 111, the first outlet port 112, and the second outlet port 113 in the valve body 115. The rotation axis X1 of the ball component 116 may be aligned with the central axis of the inlet port 111.

Referring to FIG. 11C, the ball component 116 may have an L-shaped passage 118 defined therein, and the L-shaped passage 118 may have a first opening 118a and a second opening 118b. As illustrated in FIGS. 11A and 11B, the first opening 118a may continuously communicate with the inlet port 111. When an alignment (an overlap area) between the second opening 118b of the ball component 116 and the first outlet port 112 is varied, the opening degree of the first outlet port 112 may be adjusted. In addition, when an alignment (an overlap area) between the second opening 118b of the ball component 116 and the second outlet port 113 is varied, the opening degree of the second outlet port 113 may be adjusted. A full rotation of the ball component 116 may be divided into a number of equal steps. As the ball component 116 rotates step by step at predetermined angles around the rotation axis X1, the opening degree of the first outlet port 112 or the opening degree of the second outlet port 113 may be adjusted. In particular, as the rotation axis X1 is aligned with the central axis of the inlet port 111, the first opening 118a of the L-shaped passage 118 may continuously communicate with the inlet port 111, and the opening degree of the inlet port 111 may be kept constant regardless of the rotation position of the ball component 116.

Referring to FIG. 11C, the ball component 116 may have a groove 119 extending from the second opening 118b toward the opposite point of the second opening 118b, and the groove 119 may extend along an exterior surface of the ball component 116. The groove 119 may include an open end 119a and a closed end 119b. The open end 119a may be open to the second opening 118b, and the closed end 119b may be spaced apart from the open end 119a.

Referring to FIGS. 11D and 11F, the second opening 118b of the L-shaped passage 118 may be fully aligned with the second outlet port 113 so that the second outlet port 113 may be fully opened, and the first outlet port 112 may be fully closed. Referring to FIG. 11F, since the closed end 119b is not located in the first outlet port 112, the groove 119 may be fluidly separated from the first outlet port 112, and accordingly the refrigerant may flow from the inlet port 111 to the second outlet port 113.

Referring to FIGS. 11E and 11G, the second opening 118b of the L-shaped passage 118 may be fully aligned with the first outlet port 112 so that the first outlet port 112 may be fully opened, and the second outlet port 113 may be fully closed. Referring to FIG. 11G, since the closed end 119b is not located in the second outlet port 113, the groove 119 may be fluidly separated from the second outlet port 113. Accordingly, the refrigerant may flow from the inlet port 111 to the first outlet port 112.

Referring to FIG. 11H, as the ball component 116 rotates at a predetermined angle, the second opening 118b of the L-shaped passage 118 may be partially aligned with the first outlet port 112, and accordingly the first outlet port 112 may be partially opened. Since the closed end 119b is located in the second outlet port 113, the groove 119 may partially communicate with the second outlet port 113. That is, the second outlet port 113 may partially communicate with the L-shaped passage 118 through the groove 119, and accordingly the second outlet port 113 may be partially opened. The opening degree of the first outlet port 112 illustrated in FIG. 11H may be relatively reduced compared to the opening degree of the first outlet port 112 illustrated in FIG. 11G. The refrigerant may flow from the inlet port 111 to the first outlet port 112 and the second outlet port 113. Here, the flow rate of the refrigerant discharged from the first outlet port 112 may be higher than the flow rate of the refrigerant discharged from the second outlet port 113.

FIGS. 11I to 11K illustrate the first control valve 110 according to an alternative embodiment. Referring to FIGS. 11I to 11K, a groove 219 may be formed in a portion of the valve body 115 contacting the ball component 116, the first sealing member 112a, and the second sealing member 113a. The groove 219 may extend along an interior surface of the valve body 115 matching the surface of the ball component 116. The groove 219 may extend from the second outlet port 113 to the the first sealing member 112a. The groove 219 may have an open end 219a and a closed end 219b. The open end 219a may be open to the second sealing member 113a, and the open end 219a may communicate with the second outlet port 113. The closed end 219b may be formed in the first sealing member 112a, and the closed end 219b may be spaced apart from the first outlet port 112.

Referring to FIG. 11I, when the second opening 118b of the L-shaped passage 118 is fully aligned with the second outlet port 113, the second outlet port 113 may be fully opened, and the first outlet port 112 may be fully closed. The open end 219a of the groove 219 may communicate with the second outlet port 113. Since the closed end 219b of the groove 219 is not located in the second opening 118b of the L-shaped passage 118, the groove 219 may be fluidly separated from the first outlet port 112, and accordingly the refrigerant may flow from the inlet port 111 to the second outlet port 113.

Referring to FIG. 11J, when the second opening 118b of the L-shaped passage 118 is fully aligned with the first outlet port 112, the first outlet port 112 may be fully opened, and the second outlet port 113 may be fully closed. Since the closed end 219b is not located in the second opening 118b of the L-shaped passage 118, the groove 219 may be fluidly separated from the first outlet port 112, and accordingly the refrigerant may flow from the inlet port 111 to the first outlet port 112.

Referring to FIG. 11K, as the ball component 116 rotates at a predetermined angle, the second opening 118b of the L-shaped passage 118 may be partially aligned with the first outlet port 112. Since the closed end 219b of the groove 219 is located in the second opening 118b of the L-shaped passage 118, the groove 219 may partially communicate with the second outlet port 113. That is, the second outlet port 113 may partially communicate with the L-shaped passage 118 through the groove 219. The opening degree of the first outlet port 112 illustrated in FIG. 11K may be relatively reduced compared to the opening degree of the first outlet port 112 illustrated in FIG. 11J, and the opening degree of the second outlet port 113 illustrated in FIG. 11K may be relatively increased compared to the opening degree of the second outlet port 113 illustrated in FIG. 11J. Accordingly, the refrigerant may flow from the inlet port 111 to the first outlet port 112 and the second outlet port 113. Here, the flow rate of the refrigerant discharged from the first outlet port 112 may be higher than the flow rate of the refrigerant discharged from the second outlet port 113.

When the second opening 118b of the L-shaped passage 118 is partially aligned with the first outlet port 112, the groove 119 or 219 may partially communicate with the second outlet port 113 so that the opening degree of the first outlet port 112 and the opening degree of the second outlet port 113 may be adjusted relative to each other. When the second opening 118b of the L-shaped passage 118 is partially aligned with the second outlet port 113, the groove 119 or 219 may partially communicate with the first outlet port 112 so that the opening degree of the first outlet port 112 and the opening degree of the second outlet port 113 may be adjusted relative to each other. Accordingly, the flow rate of the refrigerant from the first control valve 110 to the exterior heat exchanger 35 and the flow rate of the refrigerant from the first control valve 110 to the dehumidification bypass conduit 26 may be adjusted at a predetermined ratio.

The actuator 117 may be configured to adjust the rotation position of the ball component 116 step by step. For example, the actuator 117 may include a step motor.

The second control valve 120 may be disposed on the downstream side of the first passage 71 of the water-cooled heat exchanger 70 on the first distribution conduit 25. The second control valve 120 may include an inlet port 121 communicating with an outlet of the first passage 71 of the water-cooled heat exchanger 70, and a first outlet port 122 communicating with an inlet of the compressor 32. The second control valve 120 may be configured to adjust the opening degree of the first outlet port 122. The second control valve 120 may adjust the opening degree of the first outlet port 122, thereby adjusting the flow rate of the refrigerant into the first passage 71 of the water-cooled heat exchanger 70.

As the first control valve 110 adjusts the opening degree of the first outlet port 112, and the second control valve 120 adjusts the opening degree of the first outlet port 122, the refrigerant may be directed into the exterior heat exchanger 35 and/or the water-cooled heat exchanger 70. During the heating operation of the HVAC subsystem 11, the refrigerant may absorb heat from the exterior heat exchanger 35 and/or the water-cooled heat exchanger 70 so that refrigerant evaporation performance of the HVAC subsystem 11 may be improved. Thus, the heating performance of the HVAC subsystem 11 for the passenger compartment may be improved.

Referring to FIG. 1, the HVAC subsystem 11 according to an exemplary embodiment of the present disclosure may further include a first branch conduit 28 branching off from the first distribution conduit 25. The first branch conduit 28 may extend from the first distribution conduit 25 to an upstream point 21b of the exterior heat exchanger 35. An inlet of the first branch conduit 28 may be connected to the downstream side of the first passage 71 of the water-cooled heat exchanger 70 on the first distribution conduit 25, and be connected to the upstream point 21b of the exterior heat exchanger 35. The second control valve 120 may further include a second outlet port 123 communicating with the first branch conduit 28. The second control valve 120 may be configured to adjust the opening degree of the second outlet port 123.

When the HVAC subsystem 11 operates in the cooling mode, the first control valve 110 may fully close the first outlet port 112, and the second control valve 120 may fully close the first outlet port 122 and fully open the second outlet port 123 so that the refrigerant may sequentially pass through the first passage 71 of the water-cooled heat exchanger 70 and the exterior heat exchanger 35. That is, during the cooling operation of the HVAC subsystem 11, the first control valve 110 may fully close the first outlet port 112 and the second control valve 120 may fully open the second outlet port 123 so that the first passage 71 of the water-cooled heat exchanger 70 and the exterior heat exchanger 35 may be connected in series.

According to an exemplary embodiment, the second control valve 120 may adjust the opening degree of the first outlet port 122 so that the flow rate of the refrigerant into the exterior heat exchanger may be adjusted. For example, when the opening degree of the first outlet port 122 of the second control valve 120 is reduced, resistance to the flow of the refrigerant in the second control valve 120 may be relatively increased. While the flow rate of the refrigerant into the first passage 71 of the water-cooled heat exchanger 70 is relatively reduced, the flow rate of the refrigerant passing through the first control valve 110 may be relatively increased, and accordingly the flow rate of the refrigerant into the exterior heat exchanger 35 may be relatively increased. When the opening degree of the first outlet port 122 of the second control valve 120 is increased, resistance to the flow of the refrigerant in the second control valve 120 may be relatively reduced. While the flow rate of the refrigerant into the first passage 71 of the water-cooled heat exchanger 70 is relatively increased, the flow rate of the refrigerant passing through the first control valve 110 may be relatively reduced, and accordingly the flow rate of the refrigerant into the exterior heat exchanger 35 may be relatively reduced.

In addition, in a state in which the first outlet port 122 is fully opened, as the opening degree of the first outlet port 122 is relatively reduced and the second outlet port 123 is partially opened, the refrigerant may be distributed through the first outlet port 122 and the second outlet port 123. When the second outlet port 123 is fully opened and the first outlet port 122 is fully closed, the refrigerant may be directed into the exterior heat exchanger 35 through the first branch conduit 28.

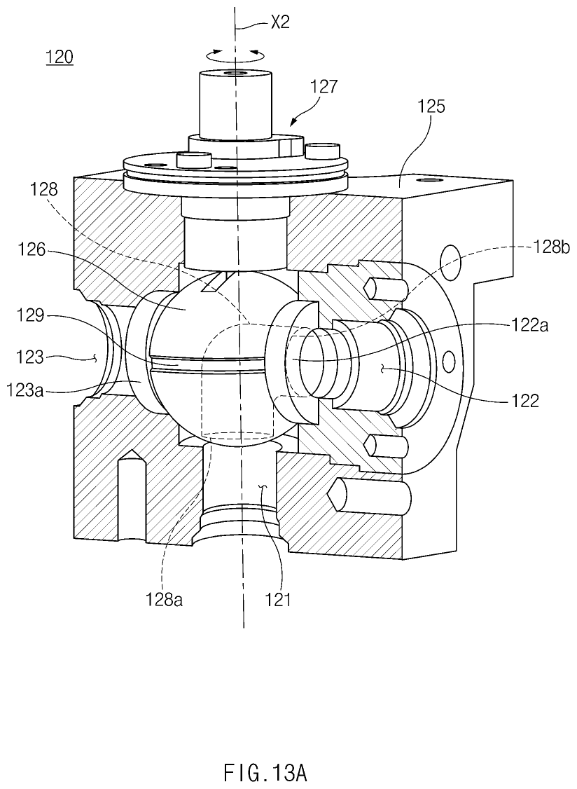

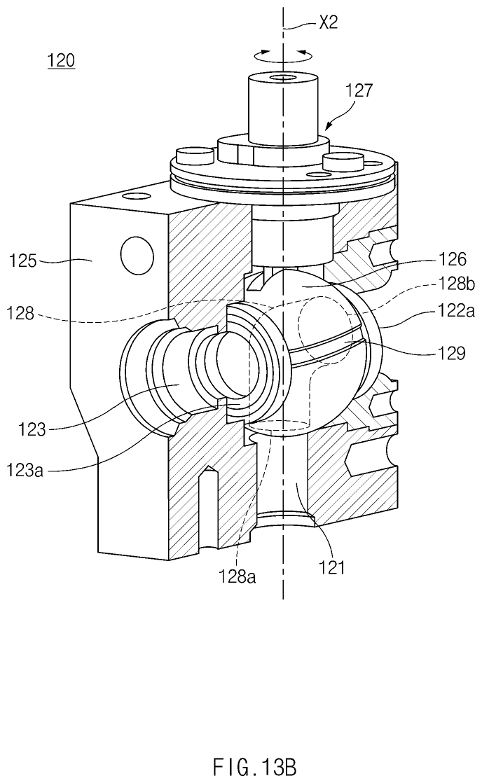

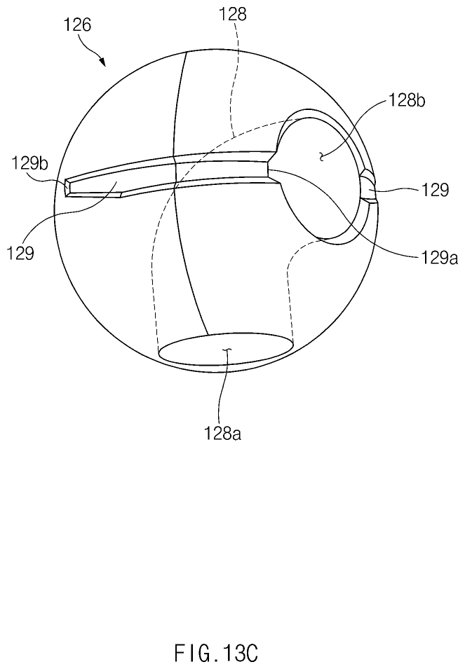

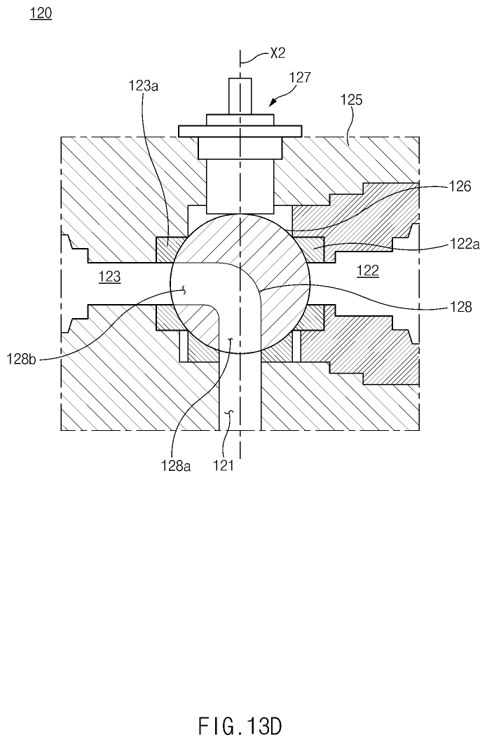

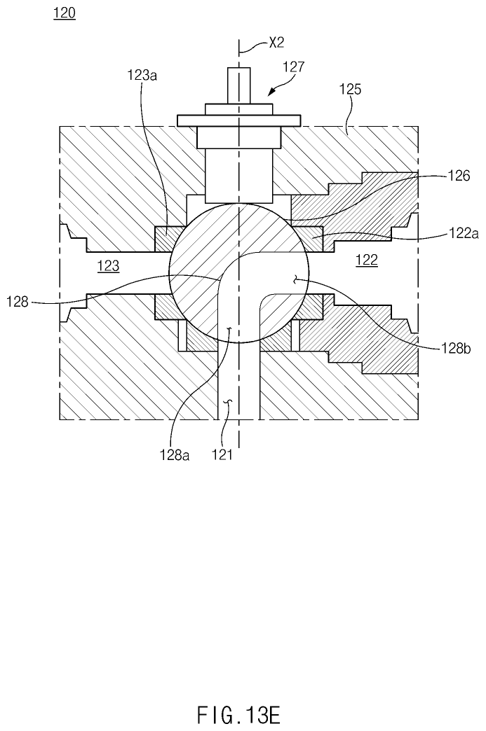

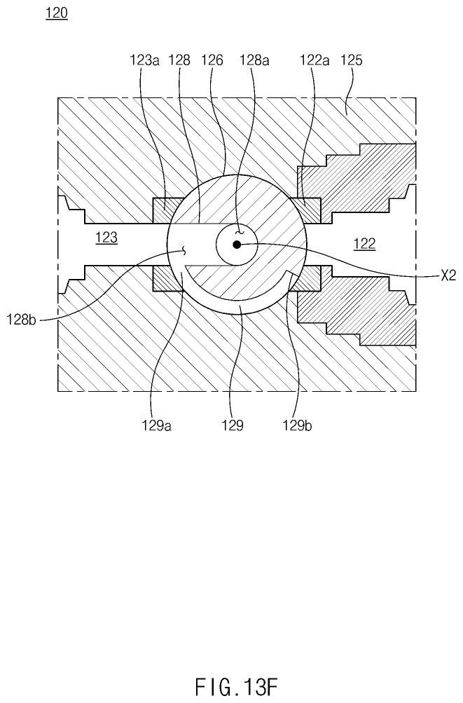

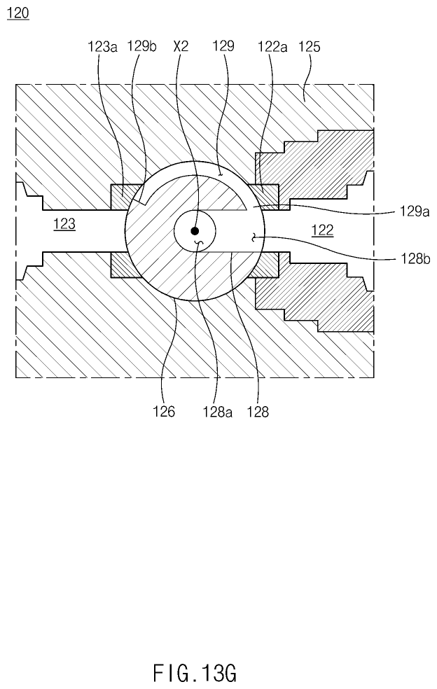

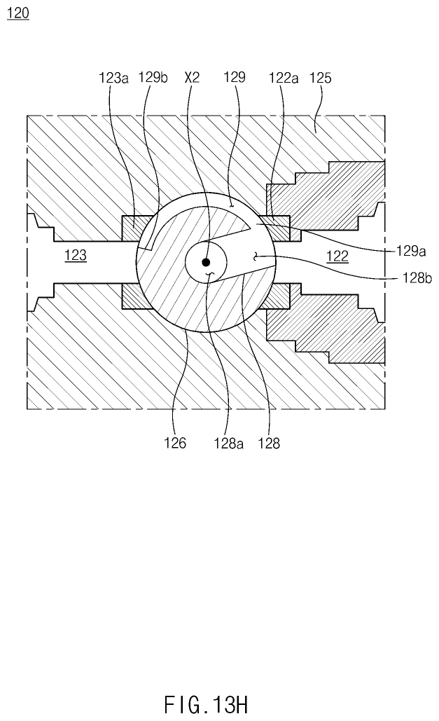

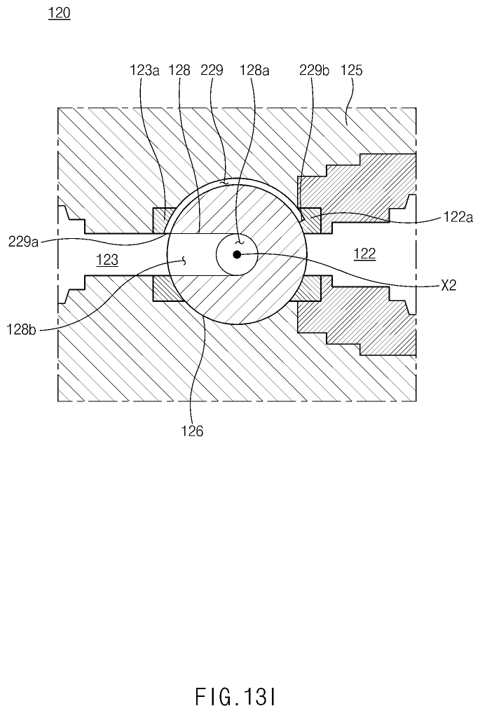

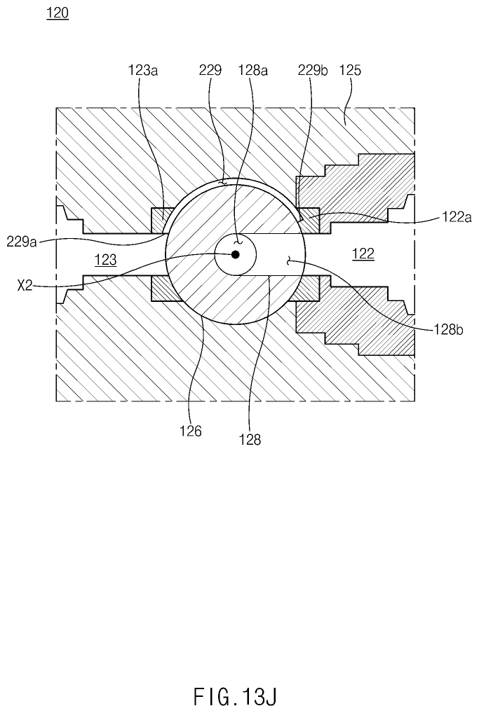

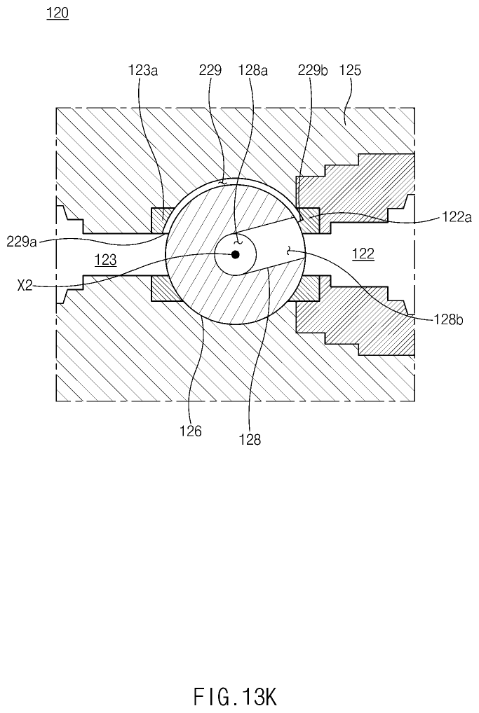

FIGS. 13A to 13H illustrate the second control valve 120 according to an exemplary embodiment of the present disclosure. Referring to FIGS. 13A and 13B, the second control valve 120 may include a valve body 125, a ball component 126 rotatably received in the valve body 125, and an actuator 127 causing the ball component 126 to rotate.

Referring to FIGS. 13A and 13B, the valve body 125 may have the inlet port 121, the first outlet port 122, and the second outlet port 123. The first outlet port 122 may be opposite to the second outlet port 123, and a central axis of the first outlet port 122 may be aligned with a central axis of the second outlet port 123. The central axis of the first outlet port 122 and the central axis of the second outlet port 123 may be perpendicular to a central axis of the inlet port 121. A first sealing member 122a may be disposed in the first outlet port 122, and the first sealing member 122a may contact the ball component 126. A second sealing member 123a may be disposed in the second outlet port 123, and the second sealing member 123a may contact the ball component 126.

The ball component 126 may be configured to rotate around a rotation axis X2 between the inlet port 121, the first outlet port 122, and the second outlet port 123 in the valve body 125. The rotation axis X2 of the ball component 126 may be aligned with the central axis of the inlet port 121.

Referring to FIG. 13C, the ball component 126 may have an L-shaped passage 128 defined therein, and the L-shaped passage 128 may have a first opening 128a and a second opening 128b. As illustrated in FIGS. 13A and 13B, the first opening 128a may continuously communicate with the inlet port 121. When an alignment (an overlap area) between the second opening 128b of the ball component 126 and the first outlet port 122 is varied, the opening degree of the first outlet port 122 may be adjusted. In addition, when an alignment (an overlap area) between the second opening 128b of the ball component 126 and the second outlet port 123 is varied, the opening degree of the second outlet port 123 may be adjusted. A full rotation of the ball component 126 may be divided into a number of equal steps. As the ball component 126 rotates step by step at predetermined angles around the rotation axis X2, the opening degree of the first outlet port 122 or the opening degree of the second outlet port 123 may be adjusted. In particular, as the rotation axis X2 is aligned with the central axis of the inlet port 121, the first opening 128a of the L-shaped passage 128 may continuously communicate with the inlet port 121, and the opening degree of the inlet port 121 may be kept constant regardless of the rotation position of the ball component 126.

Referring to FIG. 13C, the ball component 126 may have a groove 129 extending from the second opening 128b toward the opposite point of the second opening 128b, and the groove 129 may extend along an exterior surface of the ball component 126. The groove 129 may include an open end 129a and a closed end 129b. The open end 129a may be open to the second opening 128b, and the closed end 129b may be spaced apart from the open end 129a.

Referring to FIGS. 13D and 13F, the second opening 128b of the L-shaped passage 128 may be fully aligned with the second outlet port 123 so that the second outlet port 123 may be fully opened, and the first outlet port 122 may be fully closed. Referring to FIG. 13F, since the closed end 129b is not located in the first outlet port 122, the groove 129 may be fluidly separated from the first outlet port 122, and accordingly the refrigerant may flow from the inlet port 121 to the second outlet port 123.

Referring to FIGS. 13E and 13G, the second opening 128b of the L-shaped passage 128 may be fully aligned with the first outlet port 122 so that the first outlet port 122 may be fully opened, and the second outlet port 123 may be fully closed. Referring to FIG. 13G, since the closed end 129b is not located in the second outlet port 123, the groove 129 may be fluidly separated from the second outlet port 123. Accordingly, the refrigerant may flow from the inlet port 121 to the first outlet port 122.

Referring to FIG. 13H, as the ball component 126 rotates at a predetermined angle, the second opening 128b of the L-shaped passage 128 may be partially aligned with the first outlet port 122, and accordingly the first outlet port 122 may be partially opened. Since the closed end 129b is located in the second outlet port 123, the groove 129 may partially communicate with the second outlet port 123. That is, the second outlet port 123 may partially communicate with the L-shaped passage 128 through the groove 129, and accordingly the second outlet port 123 may be partially opened. The opening degree of the first outlet port 122 illustrated in FIG. 13H may be relatively reduced compared to the opening degree of the first outlet port 122 illustrated in FIG. 13G. The refrigerant may flow from the inlet port 121 to the first outlet port 122 and the second outlet port 123. Here, the flow rate of the refrigerant discharged from the first outlet port 122 may be higher than the flow rate of the refrigerant discharged from the second outlet port 123.

FIGS. 13I to 13K illustrate the second control valve 120 according to an alternative embodiment. Referring to FIGS. 13I to 13K, a groove 229 may be formed in a portion of the valve body 125 contacting the ball component 126, the first sealing member 122a, and the second sealing member 123a. The groove 229 may extend along an interior surface of the valve body 125 matching the exterior surface of the ball component 126. The groove 229 may have an open end 229a and a closed end 229b. The open end 229a may be open to the second sealing member 123a, and the open end 229a may communicate with the second outlet port 123. The closed end 229b may be formed in the first sealing member 122a, and the closed end 229b may be spaced apart from the first outlet port 122.

Referring to FIG. 13I, when the second opening 128b of the L-shaped passage 128 is fully aligned with the second outlet port 123, the second outlet port 123 may be fully opened, and the first outlet port 122 may be fully closed. The open end 229a of the groove 229 may communicate with the second outlet port 123. Since the closed end 229b of the groove 229 is not located in the second opening 128b of the L-shaped passage 128, the groove 229 may be fluidly separated from the first outlet port 122, and accordingly the refrigerant may flow from the inlet port 121 to the second outlet port 123.

Referring to FIG. 13J, when the second opening 128b of the L-shaped passage 128 is fully aligned with the first outlet port 122, the first outlet port 122 may be fully opened, and the second outlet port 123 may be fully closed. Since the closed end 229b is not located in the second opening 128b of the L-shaped passage 128, the groove 229 may be fluidly separated from the first outlet port 122, and accordingly the refrigerant may flow from the inlet port 121 to the first outlet port 122.

Referring to FIG. 13K, as the ball component 126 rotates at a predetermined angle, the second opening 128b of the L-shaped passage 128 may be partially aligned with the first outlet port 122. Since the closed end 229b of the groove 229 is located in the second opening 128b of the L-shaped passage 128, the groove 229 may partially communicate with the second outlet port 123. That is, the second outlet port 123 may partially communicate with the L-shaped passage 128 through the groove 229. The opening degree of the first outlet port 122 illustrated in FIG. 13K may be relatively reduced compared to the opening degree of the first outlet port 122 illustrated in FIG. 13J, and the opening degree of the second outlet port 123 illustrated in FIG. 13K may be relatively increased compared to the opening degree of the second outlet port 123 illustrated in FIG. 13J. Accordingly, the refrigerant may flow from the inlet port 121 to the first outlet port 122 and the second outlet port 123. Here, the flow rate of the refrigerant discharged from the first outlet port 122 may be higher than the flow rate of the refrigerant discharged from the second outlet port 123.

When the second opening 128b of the L-shaped passage 128 is partially aligned with the first outlet port 122, the groove 129 or 229 may partially communicate with the second outlet port 123 so that the opening degree of the first outlet port 122 and the opening degree of the second outlet port 123 may be adjusted relative to each other. When the second opening 128b of the L-shaped passage 128 is partially aligned with the second outlet port 123, the groove 129 or 229 may partially communicate with the first outlet port 122 so that the opening degree of the first outlet port 122 and the opening degree of the second outlet port 123 may be adjusted relative to each other. Accordingly, the flow rate of the refrigerant from the second control valve 120 to the exterior heat exchanger 35 and the flow rate of the refrigerant from the second control valve 120 to the compressor 32 may be adjusted at a predetermined ratio.

The actuator 127 may be configured to adjust the rotation position of the ball component 126 step by step. For example, the actuator 127 may include a step motor.

According to another exemplary embodiment, the second control valve 120 may adjust the opening degree of the first outlet port 122 while adjusting the opening degree of the second outlet port 123 to be in inverse proportion to the opening degree of the first outlet port 122, and thus the flow rate of the refrigerant from the second control valve 120 to the exterior heat exchanger 35 may be adjusted. For example, when the second control valve 120 increases the opening degree of the first outlet port 122 and reduces the opening degree of the second outlet port 123, the flow rate of the refrigerant from the second outlet port 123 of the second control valve 120 to the exterior heat exchanger 35 may be reduced. When the second control valve 120 reduces the opening degree of the first outlet port 122 and increases the opening degree of the second outlet port 123, the flow rate of the refrigerant from the second outlet port 123 of the second control valve 120 to the exterior heat exchanger 35 may be increased.

Referring to FIG. 1, the HVAC subsystem 11 according to an exemplary embodiment of the present disclosure may further include a second branch conduit 29 branching off from the first distribution conduit 25. The second branch conduit 29 may extend from a branch point 25a of the first distribution conduit 25 to a downstream point of the exterior heat exchanger 35. The branch point 25a may be on a downstream point of the second control valve 120.

The third control valve 130 may be disposed on the downstream side of the exterior heat exchanger 35 in the refrigerant loop 21. In particular, the third control valve 130 may be disposed at a junction between the second branch conduit 29 and the refrigerant loop 21. The third control valve 130 may include an inlet port 131 communicating with an outlet of the exterior heat exchanger 35, a first outlet port 132 communicating with the second branch conduit 29, and a second outlet port 133 communicating with an inlet of a first passage 37a of the battery chiller 37 to be described below.

According to an exemplary embodiment, the third control valve 130 may be configured to adjust the opening degree of the first outlet port 132 and the opening degree of the second outlet port 133 individually or simultaneously. Thus, the flow rate of the refrigerant into the second branch conduit 29 and the flow rate of the refrigerant into the first passage 37a of the battery chiller 37 may be adjusted independently. For example, when the first outlet port 132 is fully opened and the second outlet port 133 is fully closed, the refrigerant may be directed into the compressor 32 through the second branch conduit 29, and may not be directed into the first passage 37a of the battery chiller 37. In a state in which the second outlet port 133 is fully opened, as the opening degree of the second outlet port 133 is relatively reduced and the first outlet port 132 is partially opened, the refrigerant may be distributed to the first passage 37a of the battery chiller 37 and the second branch conduit 29. As the third control valve 130 adjusts the opening degree of the first outlet port 132 and/or the opening degree of the second outlet port 133, the flow rate of the refrigerant discharged from the exterior heat exchanger 35 may be directed into the second branch conduit 29 and/or the first passage 37a of the battery chiller 37.

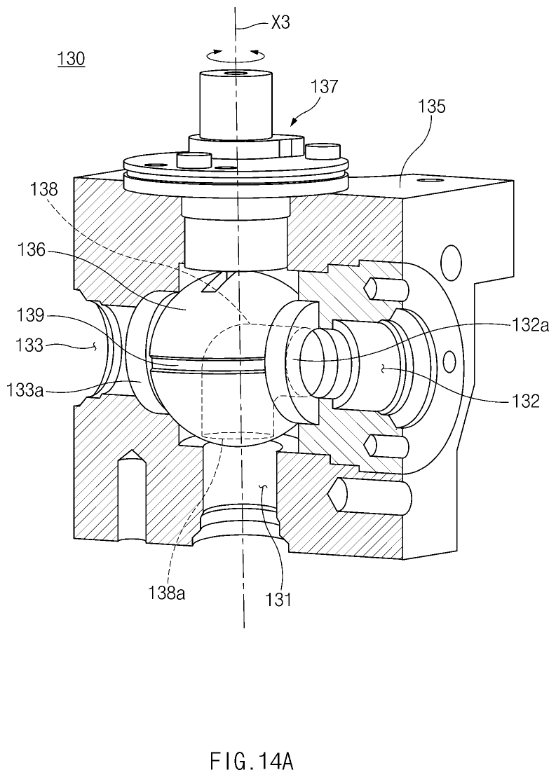

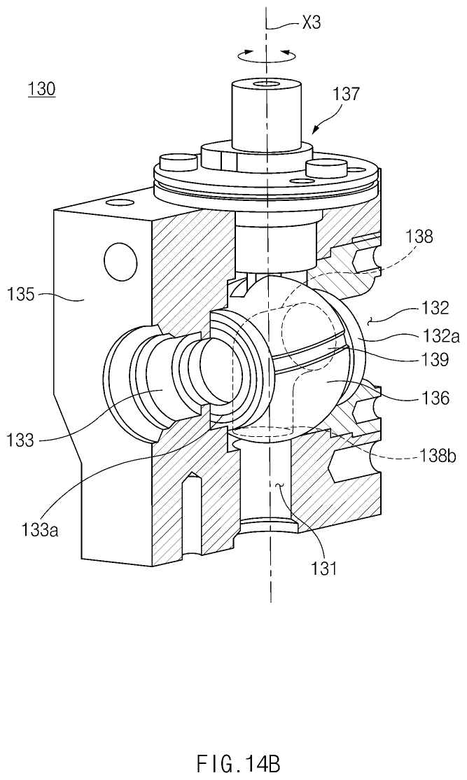

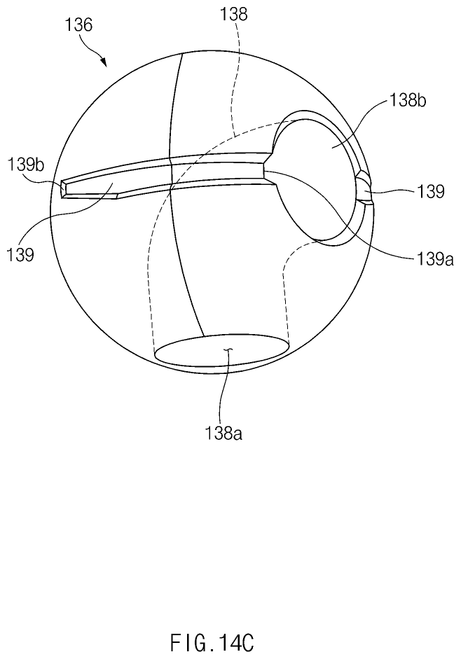

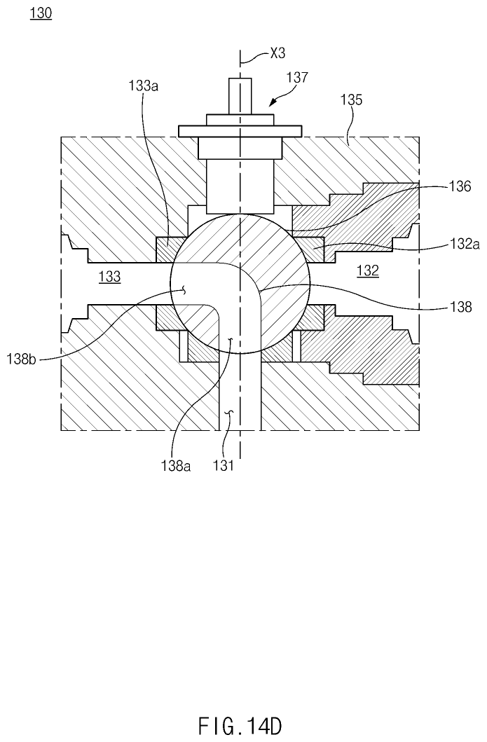

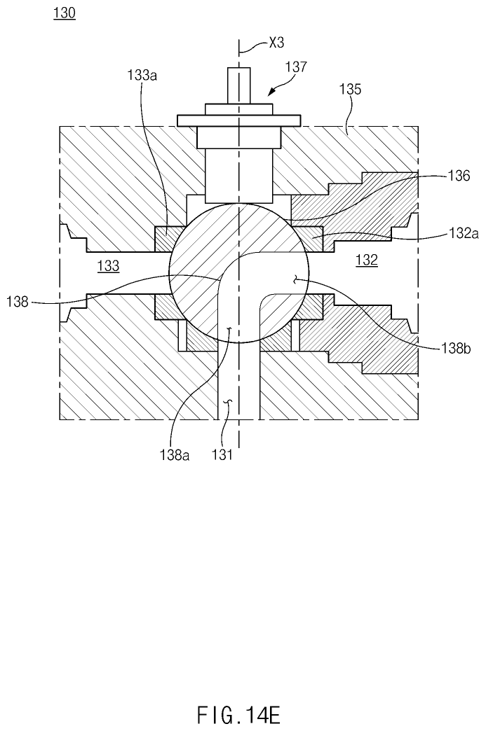

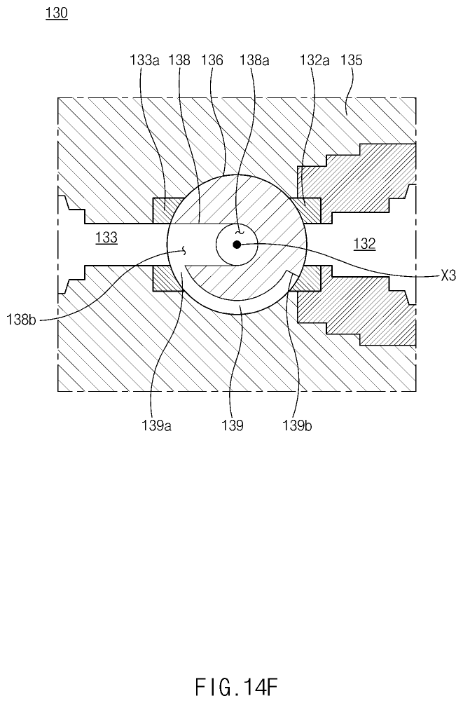

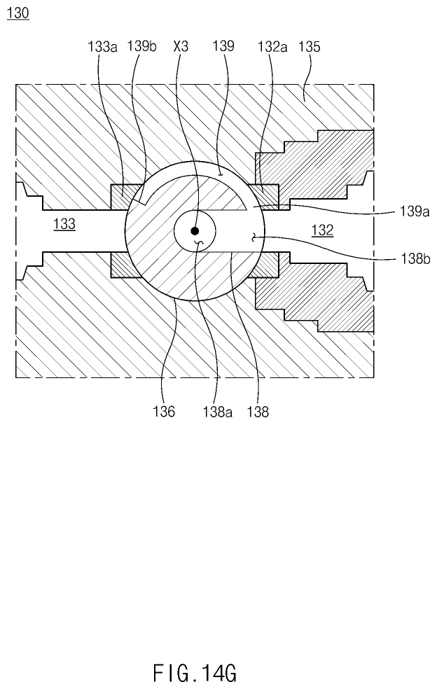

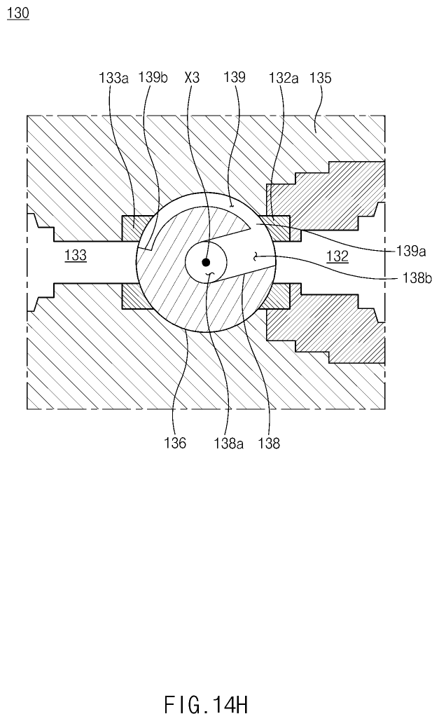

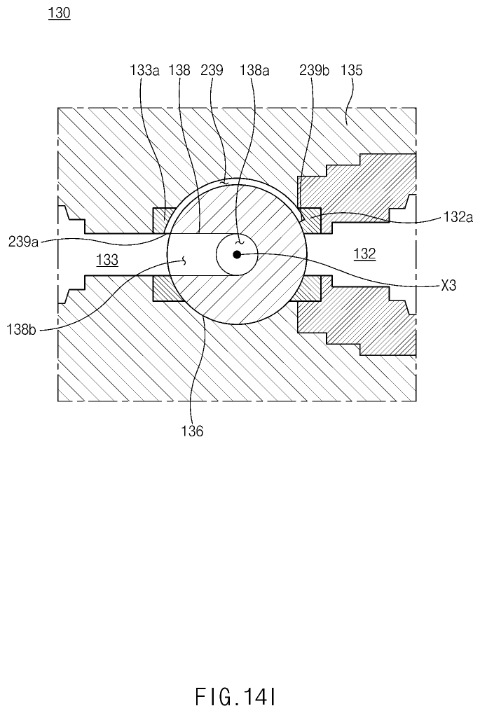

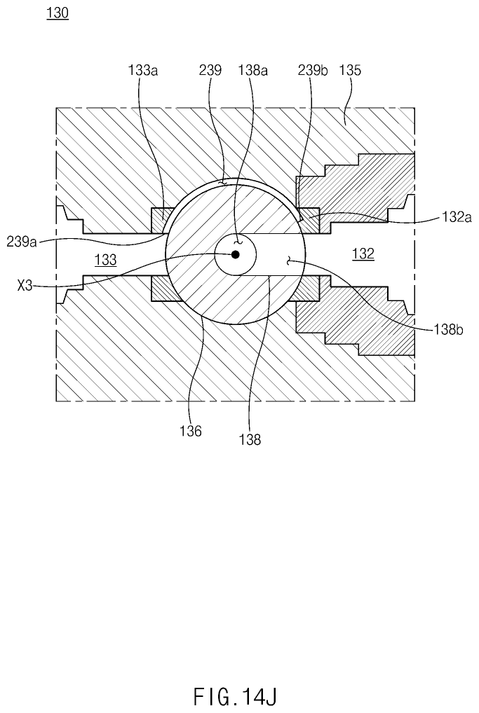

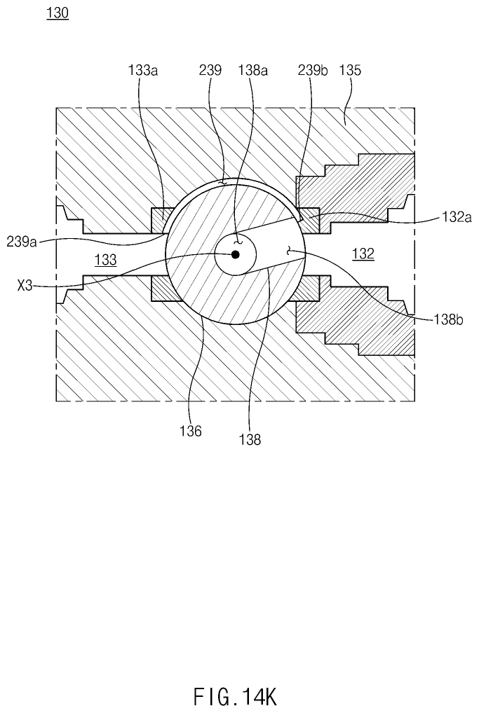

FIGS. 14A to 14H illustrate the third control valve 130 according to an exemplary embodiment of the present disclosure. Referring to FIGS. 14A and 14B, the third control valve 130 may include a valve body 135, a ball component 136 rotatably received in the valve body 135, and an actuator 137 causing the ball component 136 to rotate.

Referring to FIGS. 14A and 14B, the valve body 135 may have the inlet port 131, the first outlet port 132, and the second outlet port 133. The first outlet port 132 may be opposite to the second outlet port 133, and a central axis of the first outlet port 132 may be aligned with a central axis of the second outlet port 133. The central axis of the first outlet port 132 and the central axis of the second outlet port 133 may be perpendicular to a central axis of the inlet port 131. A first sealing member 132a may be disposed in the first outlet port 132, and the first sealing member 132a may contact the ball component 136. A second sealing member 133a may be disposed in the second outlet port 133, and the second sealing member 133a may contact the ball component 136.

The ball component 136 may be configured to rotate around a rotation axis X3 between the inlet port 131, the first outlet port 132, and the second outlet port 133 in the valve body 135. The rotation axis X3 of the ball component 136 may be aligned with the central axis of the inlet port 131.

Referring to FIG. 14C, the ball component 136 may have an L-shaped passage 138 defined therein, and the L-shaped passage 138 may have a first opening 138a and a second opening 138b. As illustrated in FIGS. 14A and 14B, the first opening 138a may continuously communicate with the inlet port 131. When an alignment (an overlap area) between the second opening 138b of the ball component 136 and the first outlet port 132 is varied, the opening degree of the first outlet port 132 may be adjusted. In addition, when an alignment (an overlap area) between the second opening 138b of the ball component 136 and the second outlet port 133 is varied, the opening degree of the second outlet port 133 may be adjusted. A full rotation of the ball component 136 may be divided into a number of equal steps. As the ball component 136 rotates step by step at predetermined angles around the rotation axis X3, the opening degree of the first outlet port 132 or the opening degree of the second outlet port 133 may be adjusted. In particular, as the rotation axis X3 is aligned with the central axis of the inlet port 131, the first opening 138a of the L-shaped passage 138 may continuously communicate with the inlet port 131, and the opening degree of the inlet port 131 may be kept constant regardless of the rotation position of the ball component 136.

Referring to FIG. 14C, the ball component 136 may have a groove 139 extending from the second opening 138b toward the opposite point of the second opening 138b, and the groove 139 may extend along an exterior surface of the ball component 136. The groove 139 may include an open end 139a and a closed end 139b. The open end 139a may be open to the second opening 138b, and the closed end 139b may be spaced apart from the open end 139a.

Referring to FIGS. 14D and 14F, the second opening 138b of the L-shaped passage 138 may be fully aligned with the second outlet port 133 so that the second outlet port 133 may be fully opened, and the first outlet port 132 may be fully closed. Referring to FIG. 14F, since the closed end 139b is not located in the first outlet port 132, the groove 139 may be fluidly separated from the first outlet port 132, and accordingly the refrigerant may flow from the inlet port 131 to the second outlet port 133.

Referring to FIGS. 14E and 14G, the second opening 138b of the L-shaped passage 138 may be fully aligned with the first outlet port 132 so that the first outlet port 132 may be fully opened, and the second outlet port 133 may be fully closed. Referring to FIG. 14G, since the closed end 139b is not located in the second outlet port 133, the groove 139 may be fluidly separated from the second outlet port 133. Accordingly, the refrigerant may flow from the inlet port 131 to the first outlet port 132. In a state in which the second outlet port 133 is fully closed, as the ball component 136 rotates at a predetermined angle, the opening degree of the first outlet port 132 may be adjusted.

Referring to FIG. 14H, as the ball component 136 rotates at a predetermined angle, the second opening 138b of the L-shaped passage 138 may be partially aligned with the first outlet port 132, and accordingly the first outlet port 132 may be partially opened. Since the closed end 139b is located in the second outlet port 133, the groove 139 may partially communicate with the second outlet port 133. That is, the second outlet port 133 may partially communicate with the L-shaped passage 138 through the groove 139, and accordingly the second outlet port 133 may be partially opened. The opening degree of the first outlet port 132 illustrated in FIG. 14H may be relatively reduced compared to the opening degree of the first outlet port 132 illustrated in FIG. 14G. The refrigerant may flow from the inlet port 131 to the first outlet port 132 and the second outlet port 133. Here, the flow rate of the refrigerant discharged from the first outlet port 132 may be higher than the flow rate of the refrigerant discharged from the second outlet port 133.

FIGS. 14I to 14K illustrate the third control valve 130 according to an alternative embodiment. Referring to FIGS. 14I to 14K, a groove 239 may be formed in a portion of the valve body 135 contacting the ball component 136, the first sealing member 132a, and the second sealing member 133a. The groove 239 may extend along an interior surface of the valve body 135 matching the exterior surface of the ball component 136. The groove 239 may have an open end 239a and a closed end 239b. The open end 239a may be open to the second sealing member 133a, and the open end 239a may communicate with the second outlet port 133. The closed end 239b may be formed in the first sealing member 132a, and the closed end 239b may be spaced apart from the first outlet port 132.

Referring to FIG. 14I, when the second opening 138b of the L-shaped passage 138 is fully aligned with the second outlet port 133, the second outlet port 133 may be fully opened, and the first outlet port 132 may be fully closed. The open end 239a of the groove 239 may communicate with the second outlet port 133. Since the closed end 239b of the groove 239 is not located in the second opening 138b of the L-shaped passage 138, the groove 239 may be fluidly separated from the first outlet port 132, and accordingly the refrigerant may flow from the inlet port 131 to the second outlet port 133.

Referring to FIG. 14J, when the second opening 138b of the L-shaped passage 138 is fully aligned with the first outlet port 132, the first outlet port 132 may be fully opened, and the second outlet port 133 may be fully closed. Since the closed end 239b is not located in the second opening 138b of the L-shaped passage 138, the groove 239 may be fluidly separated from the first outlet port 132, and accordingly the refrigerant may flow from the inlet port 131 to the first outlet port 132.

Referring to FIG. 14K, as the ball component 136 rotates at a predetermined angle, the second opening 138b of the L-shaped passage 138 may be partially aligned with the first outlet port 132. Since the closed end 239b of the groove 239 is located in the second opening 138b of the L-shaped passage 138, the groove 239 may partially communicate with the second outlet port 133. That is, the second outlet port 133 may partially communicate with the L-shaped passage 138 through the groove 239. The opening degree of the first outlet port 132 illustrated in FIG. 14K may be relatively reduced compared to the opening degree of the first outlet port 132 illustrated in FIG. 14J, and the opening degree of the second outlet port 133 illustrated in FIG. 14K may be relatively increased compared to the opening degree of the second outlet port 133 illustrated in FIG. 14J. Accordingly, the refrigerant may flow from the inlet port 131 to the first outlet port 132 and the second outlet port 133. Here, the flow rate of the refrigerant discharged from the first outlet port 132 may be higher than the flow rate of the refrigerant discharged from the second outlet port 133.

When the second opening 138b of the L-shaped passage 138 is partially aligned with the first outlet port 132, the groove 139 or 239 may partially communicate with the second outlet port 133 so that the opening degree of the first outlet port 132 and the opening degree of the second outlet port 133 may be adjusted relative to each other. When the second opening 138b of the L-shaped passage 138 is partially aligned with the second outlet port 133, the groove 139 or 239 may partially communicate with the first outlet port 132 so that the opening degree of the first outlet port 132 and the opening degree of the second outlet port 133 may be adjusted relative to each other. Accordingly, the flow rate of the refrigerant from the third control valve 130 to the second branch conduit 29 and the flow rate of the refrigerant from the third control valve 130 to the first passage 37a of the battery chiller 37 may be adjusted at a predetermined ratio.

The actuator 137 may be configured to adjust the rotation position of the ball component 136 step by step. For example, the actuator 137 may include a step motor.

According to another exemplary embodiment, the third control valve 130 may adjust the opening degree of the first outlet port 132 while adjusting the opening degree of the second outlet port 133 to be in inverse proportion to the opening degree of the first outlet port 132, and thus the flow rate of the refrigerant from the third control valve 130 to the second branch conduit 29 and the flow rate of the refrigerant from the third control valve 130 to the first passage 37a of the battery chiller 37 may be adjusted at a predetermined ratio.

The cooling-side expansion valve 15 may be disposed between the exterior heat exchanger 35 and the evaporator 31 in the refrigerant loop 21. The cooling-side expansion valve 15 may be located on the upstream side of the evaporator 31, thereby adjusting the flow of the refrigerant and/or the flow rate of the refrigerant into the evaporator 31. During the cooling operation of the HVAC subsystem 11, the cooling-side expansion valve 15 may be configured to expand the refrigerant received from the exterior heat exchanger 35.

According to an exemplary embodiment, the cooling-side expansion valve 15 may be a thermal expansion valve (TXV) which senses the temperature and/or pressure of the refrigerant and adjusts the opening degree of the cooling-side expansion valve 15. Specifically, the cooling-side expansion valve 15 may be a TXV having a shut-off valve 15a selectively blocking the flow of the refrigerant toward an internal passage of the cooling-side expansion valve 15, and the shut-off valve 15a may be a solenoid valve. The shut-off valve 15a may be opened or closed by the controller 1000, thereby unblocking or blocking the flow of the refrigerant into the cooling-side expansion valve 15. When the shut-off valve 15a is opened, the refrigerant may be allowed to flow into the cooling-side expansion valve 15, and when the shut-off valve 15a is closed, the refrigerant may be blocked from flowing into the cooling-side expansion valve 15. According to an exemplary embodiment, the shut-off valve 15a may be mounted in the inside of a valve body of the cooling-side expansion valve 15, thereby opening or closing the internal passage of the cooling-side expansion valve 15. According to another exemplary embodiment, the shut-off valve 15a may be located on the upstream side of the cooling-side expansion valve 15, thereby selectively opening or closing an inlet of the cooling-side expansion valve 15.

When the shut-off valve 15a is closed, the flow of the refrigerant into the cooling-side expansion valve 15 may be blocked, and accordingly the refrigerant may only be directed into the battery chiller 37 without flowing into the cooling-side expansion valve 15 and the evaporator 31. That is, when the shut-off valve 15a of the cooling-side expansion valve 15 is closed, the cooling operation of the HVAC subsystem 11 may not be performed, and only the battery chiller 37 may be cooled or the heating operation of the HVAC subsystem 11 may be performed. When the shut-off valve 15a is opened, the refrigerant may be directed into the cooling-side expansion valve 15 and the evaporator 31. That is, when the shut-off valve 15a of the cooling-side expansion valve 15 is opened, the cooling operation of the HVAC subsystem 11 may be performed.

The evaporator 31 may be disposed on the downstream side of the cooling-side expansion valve 15, and may receive the refrigerant expanded by the cooling-side expansion valve 15. The evaporator 31 may be configured to cool the air using the refrigerant received from the cooling-side expansion valve 15. That is, the refrigerant expanded by the cooling-side expansion valve 15 may absorb heat from the air and evaporate in the evaporator 31. During the cooling operation of the HVAC subsystem 11, the evaporator 31 may cool the air using the refrigerant cooled by the exterior heat exchanger 35 and expanded by the cooling-side expansion valve 15, and the air cooled by the evaporator 31 may be directed into the passenger compartment.

The HVAC case 30 may have an inlet and an outlet. The HVAC case 30 may be configured to allow the air to be directed into the passenger compartment of the vehicle. The evaporator 31 and the interior condenser 33 may be located in the HVAC case 30. An air mixing door 34a may be disposed between the evaporator 31 and the interior condenser 33, and a PTC (positive temperature coefficient) heater 34b may be disposed on the downstream side of the interior condenser 33.

The HVAC subsystem 11 may further include a second distribution conduit 36 branching off from the refrigerant loop 21. The second distribution conduit 36 may extend from an upstream point 21e of the cooling-side expansion valve 15 to an upstream point 21f of the compressor 32 in the refrigerant loop 21. The battery chiller 37 may be fluidly connected to the second distribution conduit 36, and the battery chiller 37 may be configured to transfer heat between the second distribution conduit 36 and the battery coolant loop 22 of the battery cooling subsystem 12. The battery chiller 37 may be configured to transfer heat between the refrigerant circulating in the HVAC subsystem 11 and a battery-side coolant circulating in the battery cooling subsystem 12. The HVAC subsystem 11 may be thermally connected to the battery cooling subsystem 12 through the battery chiller 37.

Specifically, the battery chiller 37 may include the first passage 37a fluidly connected to the second distribution conduit 36, and a second passage 37b fluidly connected to the battery coolant loop 22. The first passage 37a and the second passage 37b may be adjacent to or contact each other within the battery chiller 37, and the first passage 37a may be fluidly separated from the second passage 37b. Accordingly, the battery chiller 37 may be configured to transfer heat between the battery-side coolant passing through the second passage 37b and the refrigerant passing through the first passage 37a. The refrigerant may absorb heat from the battery-side coolant, thereby being evaporated and superheated, and the battery-side coolant may release heat to the refrigerant, thereby being cooled.

The second distribution conduit 36 may be fluidly connected to the accumulator 38, and the refrigerant passing through the second distribution conduit 36 may be received in the accumulator 38.

A chiller-side expansion valve 17 may be disposed on the upstream side of the battery chiller 37 on the second distribution conduit 36. The chiller-side expansion valve 17 may be configured to adjust the flow of the refrigerant and/or the flow rate of the refrigerant into the battery chiller 37, and the chiller-side expansion valve 17 may be configured to expand the refrigerant received from the exterior heat exchanger 35.

According to an exemplary embodiment, the chiller-side expansion valve 17 may be an EXV having a drive motor 17a. The drive motor 17a may have a shaft which is movable to open or close an orifice defined in a valve body of the chiller-side expansion valve 17, and the position of the shaft may be varied depending on the rotation direction, rotation degree, and the like of the drive motor 17a, and thus the opening degree of the orifice of the chiller-side expansion valve 17 may be varied. The controller 1000 may control the operation of the drive motor 17a so that the opening degree of the chiller-side expansion valve 17 may be varied. As the opening degree of the chiller-side expansion valve 17 is varied, the flow rate of the refrigerant into the first passage 37a of the battery chiller 37 may be varied. The operation of the drive motor 17a of the chiller-side expansion valve 17 may be controlled by the controller 1000 during a cooling operation of a battery 41. When the cooling of the battery 41 is not required, the chiller-side expansion valve 17 may be fully closed. The chiller-side expansion valve 17 may be a full open type EXV.

As the opening degree of the chiller-side expansion valve 17 is varied, the flow rate of the refrigerant into the battery chiller 37 may be varied. For example, when the opening degree of the chiller-side expansion valve 17 is greater than a reference opening degree, the flow rate of the refrigerant into the battery chiller 37 may be relatively increased above a reference flow rate, and when the opening degree of the chiller-side expansion valve 17 is less than the reference opening degree, the flow rate of the refrigerant into the battery chiller 37 may be similar to the reference flow rate or be relatively lowered below the reference flow rate. Here, the reference opening degree refers to an opening degree of the chiller-side expansion valve 17 required for maintaining a target evaporator temperature, and the reference flow rate refers to a flow rate of the refrigerant which is allowed to flow into the battery chiller 37 when the chiller-side expansion valve 17 is opened to the reference opening degree. When the chiller-side expansion valve 17 is opened to the reference opening degree, the refrigerant may be directed into the battery chiller 37 at the corresponding reference flow rate.

As the opening degree of the chiller-side expansion valve 17 is adjusted by the controller 1000, the flow rate of the refrigerant into the battery chiller 37 may be varied so that the flow rate of the refrigerant into the evaporator 31 may be varied. Accordingly, as the opening degree of the chiller-side expansion valve 17 is adjusted, the refrigerant may be distributed to the evaporator 31 and the battery chiller 37 at a predetermined ratio, and thus the cooling of the HVAC subsystem 11 and the cooling of the battery chiller 37 may be performed simultaneously or selectively.

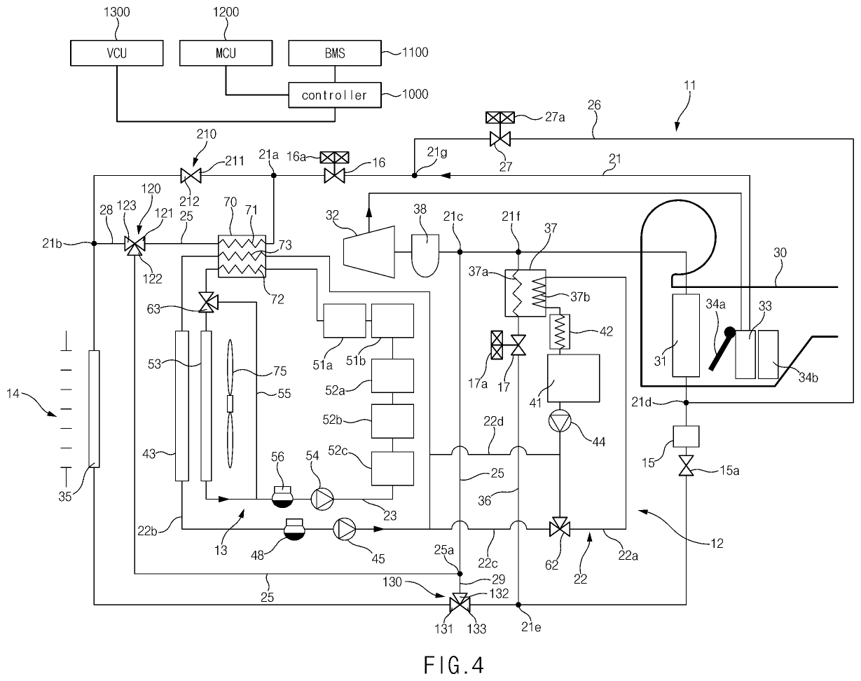

According to an exemplary embodiment illustrated in FIG. 4, the dehumidification bypass conduit 26 may extend from an upstream point 21g of the heating-side expansion valve 16 to the upstream point 21d of the evaporator 31. A dehumidification-side expansion valve 27 may be disposed on the dehumidification bypass conduit 26, and when the HVAC subsystem 11 operates in a dehumidification mode, the dehumidification-side expansion valve 27 may adjust the flow of the refrigerant and/or the flow rate of the refrigerant into the dehumidification bypass conduit 26. The dehumidification-side expansion valve 27 may be configured to expand the refrigerant received from the interior condenser 33. When the HVAC subsystem 11 operates in the dehumidification mode, the opening degree of the dehumidification-side expansion valve 27 may be adjusted so that at least a portion of the refrigerant discharged from the interior condenser 33 may be directed into the evaporator 31 through the dehumidification bypass conduit 26 and the cooling-side expansion valve 15. Accordingly, the refrigerant directed into the evaporator 31 may absorb heat from the air passing through the evaporator 31, and thus the heating and dehumidification of the passenger compartment may be simultaneously performed.

According to an exemplary embodiment, the dehumidification-side expansion valve 27 may be an EXV having a drive motor 27a. The drive motor 27a may have a shaft which is movable to open or close an orifice defined in a valve body of the dehumidification-side expansion valve 27, and the position of the shaft may be varied depending on the rotation direction, rotation degree, and the like of the drive motor 27a, and thus the opening degree of the orifice of the dehumidification-side expansion valve 27 may be varied. The controller 1000 may control the operation of the drive motor 27a. The opening degree of the dehumidification-side expansion valve 27 may be varied by the controller 1000. As the opening degree of the dehumidification-side expansion valve 27 is varied, the flow rate of the refrigerant into the evaporator 31 may be varied. The operation of the drive motor 27a of the dehumidification-side expansion valve 27 may be controlled by the controller 1000 during the dehumidification operation of the HVAC subsystem 11.

The controller 1000 may be configured to control respective operations of the shut-off valve 15a of the cooling-side expansion valve 15, the heating-side expansion valve 16, the chiller-side expansion valve 17, the compressor 32, and the like, and thus the overall operation of the HVAC subsystem 11 may be controlled by the controller 1000. According to an exemplary embodiment, the controller 1000 may be a full automatic temperature control system (FATC).

The controller 1000 may be configured to control the overall operation of the vehicle thermal management system including the battery cooling subsystem 12 and the powertrain cooling subsystem 13 as well as the HVAC subsystem 11.

When the HVAC subsystem 11 operates in a cooling mode, the shut-off valve 15a of the cooling-side expansion valve 15 may be opened. The first control valve 110 may fully close the first outlet port 112, the second control valve 120 may fully open the second outlet port 123, and the third control valve 130 may fully open the second outlet port 133. Accordingly, the refrigerant may sequentially pass through the compressor 32, the interior condenser 33, the heating-side expansion valve 16, the first passage 71 of the water-cooled heat exchanger 70, the exterior heat exchanger 35, the cooling-side expansion valve 15, and the evaporator 31. Here, as the heating-side expansion valve 16 is fully opened to 100%, the refrigerant may be not expanded in the heating-side expansion valve 16. A portion of the refrigerant discharged from the second outlet port 133 of the third control valve 130 may be directed into the chiller-side expansion valve 17 and the first passage 37a of the battery chiller 37.

When the HVAC subsystem 11 operates in a heating mode, the shut-off valve 15a of the cooling-side expansion valve 15 may be closed. The first control valve 110 may adjust the opening degree of the first outlet port 112, the second control valve 120 may adjust the opening degree of the first outlet port 122, and the third control valve 130 may adjust the opening degree of the first outlet port 132. The opening degree of the heating-side expansion valve 16 may be adjusted in response to a heating temperature of the passenger compartment set by a user. Accordingly, the refrigerant may sequentially pass through the compressor 32, the interior condenser 33, and the heating-side expansion valve 16, and the refrigerant may be expanded by the heating-side expansion valve 16. The expanded refrigerant may be directed into the first passage 71 of the water-cooled heat exchanger 70 and/or the exterior heat exchanger 35. The refrigerant discharged from the first passage 71 of the water-cooled heat exchanger 70 and/or the exterior heat exchanger 35 may be directed into the compressor 32 and/or the chiller-side expansion valve 17.

According to the exemplary embodiment illustrated in FIG. 4, a first control valve 210 may be located on the downstream point of the heating-side expansion valve 16. The first control valve 210 may include an inlet port 211 communicating with the heating-side expansion valve 16, and an outlet port 212 communicating with the exterior heat exchanger 35. The first control valve 210 may adjust the opening degree of the outlet port 212, thereby adjusting the flow rate of the refrigerant into the exterior heat exchanger 35.

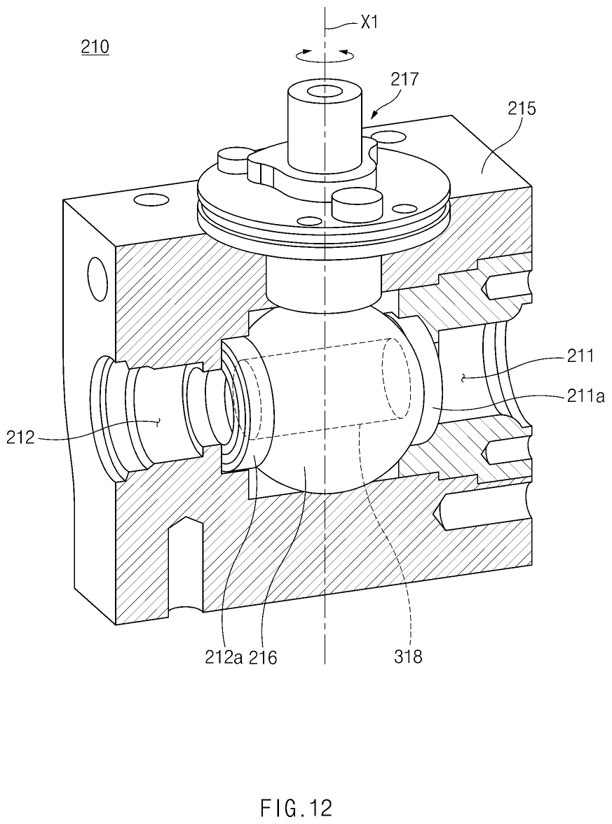

FIG. 12 illustrates the first control valve 210 illustrated in FIG. 4. Referring to FIG. 12, the first control valve 210 may include a valve body 215, a ball component 216 rotatably received in the valve body 215, and an actuator 217 causing the ball component 216 to rotate.

Referring to FIG. 12, the valve body 215 may have an inlet port 211 and an outlet port 212. The inlet port 211 may be opposite to the outlet port 212, and a central axis of the inlet port 211 may be aligned with a central axis of the outlet port 212.

Referring to FIG. 12, the ball component 216a may have a passage 318 extending straightly, and the ball component 216 may rotate around the rotation axis X1 to thereby adjust the opening degree of the outlet port 212. The rotation axis X1 may be perpendicular to the central axis of the inlet port 211 and the central axis of the outlet port 212. The actuator 217 may be configured to adjust the rotation position of the ball component 216 step by step. For example, the actuator 217 may include a step motor. A first sealing member 211a may be disposed in the first outlet port 211, and the first sealing member 211a may contact the ball component 216. A second sealing member 21a may be disposed in the second outlet port 212, and the second sealing member 212a may contact the ball component 216.

(Battery Cooling Subsystem)

The battery cooling subsystem 12 may include the battery coolant loop 22, and the battery-side coolant for cooling the battery 41 may circulate in the battery coolant loop 22.

The battery cooling subsystem 12 may be configured to cool the battery 41 or increase a temperature of the battery 41 using the battery-side coolant circulating in the battery coolant loop 22. The battery coolant loop 22 may be fluidly connected to a battery radiator 43, a reservoir tank 48, a first battery-side pump 44, the battery chiller 37, a heater 42, the battery 41, a second battery-side pump 45, and the water-cooled heat exchanger 70.

The battery 41 may have a coolant passage provided inside or outside thereof, and the battery-side coolant may pass through the coolant passage. The battery coolant loop 22 may be fluidly connected to the coolant passage of the battery 41.

The heater 42 may be disposed between the battery chiller 37 and the battery 41, and the heater 42 may heat the battery-side coolant circulating in the battery coolant loop 22 to warm up the coolant. According to an exemplary embodiment, the heater 42 may be an electric heater. According to another exemplary embodiment, the heater 42 may heat the battery-side coolant by exchanging heat with a high-temperature fluid.

The battery radiator 43 may be adjacent to the front grille of the vehicle, and the battery radiator 43 may be cooled using the ambient air forcibly blown by the cooling fan 75. The battery radiator 43 may be adjacent to the exterior heat exchanger 35. According to an exemplary embodiment, the battery radiator 43 may be referred to as a low temperature radiator (LTR).

The first battery-side pump 44 may be configured to allow the battery-side coolant to circulate through at least a first portion of the battery coolant loop 22, and the second battery-side pump 45 may be configured to allow the battery-side coolant to circulate through at least a second portion of the battery coolant loop 22.

The reservoir tank 48 may be located between an outlet of the battery radiator 43 and an inlet of the second battery-side pump 45.

According to an exemplary embodiment, the battery coolant loop 22 may include a first coolant conduit 22a and a second coolant conduit 22b connected through a first connection conduit 22c and a second connection conduit 22d. The first coolant conduit 22a may be fluidly connected to the battery chiller 37, the heater 42, the battery 41, and the first battery-side pump 44. The second coolant conduit 22b may be fluidly connected to the battery radiator 43, the reservoir tank 48, the second battery-side pump 45, and the third passage 73 of the water-cooled heat exchanger 70.

The first connection conduit 22c may connect a downstream point of the second battery-side pump 45 and an upstream point of the second passage 37b of the battery chiller 37. Specifically, an inlet of the first connection conduit 22c may be connected to the downstream point of the second battery-side pump 45, and an outlet of the first connection conduit 22c may be connected to the upstream point of the second passage 37b of the battery chiller 37.

The second connection conduit 22d may connect a downstream point of the first battery-side pump 44 and an upstream point of the third passage 73 of the water-cooled heat exchanger 70. Specifically, an inlet of the second connection conduit 22d may be connected to the downstream point of the first battery-side pump 44, and an outlet of the second connection conduit 22d may be connected to the upstream point of the third passage 73 of the water-cooled heat exchanger 70.

The first battery-side pump 44 may be disposed on a downstream point of the battery 41 in the first coolant conduit 22a of the battery coolant loop 22.

The second battery-side pump 45 may be disposed on a downstream point of the battery radiator 43 in the second coolant conduit 22b of the battery coolant loop 22.

The first battery-side pump 44 and the second battery-side pump 45 may operate individually and selectively according to the thermal condition and charging condition of the battery 41, the operating condition of the HVAC subsystem 11, and the like.

The battery cooling subsystem 12 may include a three-way valve 62 mounted in at least one of the first and second connection conduits 22c and 22d.

Referring to FIG. 1, the three-way valve 62 may be disposed at the outlet of the first connection conduit 22c. That is, the three-way valve 62 may be disposed at a junction between the first connection conduit 22c and the first coolant conduit 22a.

When the three-way valve 62 is switched to open the outlet of the first connection conduit 22c, the first coolant conduit 22a may be fluidly connected to the second coolant conduit 22b through the first connection conduit 22c and the second connection conduit 22d, and accordingly the battery-side coolant may entirely circulate through the first coolant conduit 22a and the second coolant conduit 22b.

When the three-way valve 62 is switched to close the outlet of the first connection conduit 22c, the first coolant conduit 22a may be fluidly separated from the second coolant conduit 22b, and accordingly the battery-side coolant may circulate in the first coolant conduit 22a and the second coolant conduit 22b independently of each other. Specifically, in a state in which the three-way valve 62 is switched to close the outlet of the first connection conduit 22c, a portion of the battery-side coolant may independently circulate in the first coolant conduit 22a through the first battery-side pump 44 so that it may sequentially pass through the second passage 37b of the battery chiller 37, the heater 42, and the battery 41, and a remaining portion of the battery-side coolant may independently circulate in the second coolant conduit 22b through the second battery-side pump 45 so that it may sequentially pass through the battery radiator 43, the reservoir tank 48, and the third passage 73 of the water-cooled heat exchanger 70.

The battery cooling subsystem 12 may be controlled by a battery management system 1100. The battery management system 1100 may monitor the state of the battery 41, and perform the cooling of the battery 41 when the temperature of the battery 41 is higher than or equal to a threshold temperature. The battery management system 1100 may transmit an instruction for the cooling of the battery 41 to the controller 1000, and accordingly the controller 1000 may control the compressor 32 to operate and control the chiller-side expansion valve 17 to open. When the operation of the HVAC system 11 is not required during the cooling operation of the battery 41, the controller 1000 may control the cooling-side expansion valve 15 to close. In addition, the battery management system 1100 may control the operation of the first battery-side pump 44, the operation of the second battery-side pump 45, and the switching of the three-way valve 62 as necessary so that the battery-side coolant may selectively flow through the first coolant conduit 22a and the second coolant conduit 22b.

According to another exemplary embodiment, the battery coolant loop 22 may include the first coolant conduit 22a, and the first coolant conduit 22a may be fluidly connected to the powertrain coolant loop 23 through an integrated valve. The second coolant conduit 22b and the third passage 73 of the water-cooled heat exchanger 70 may be removed, and accordingly the battery coolant loop 22 may not be thermally connected to the water-cooled heat exchanger 70.

(Powertrain Cooling Subsystem)

The powertrain cooling subsystem 13 according to an exemplary embodiment of the present disclosure may be configured to cool the plurality of powertrain components using the powertrain-side coolant circulating in the powertrain coolant loop 23.

According to an exemplary embodiment, the plurality of powertrain components may include a first electric motor 51a driving front wheels, a second electric motor 51b driving rear wheels, a first inverter 52a controlling the speed and direction of the first electric motor 51a, a second inverter 52b controlling the speed and direction of the second electric motor 51b, and an integrated power conversion component 52c in which an on-board charger (OBC) and a low DC-DC converter (LDC) are integrated.

According to the exemplary embodiment illustrated in FIG. 1, the powertrain coolant loop 23 may be fluidly connected to a powertrain radiator 53, a reservoir tank 56, a powertrain-side pump 54, the plurality of powertrain components 51a, 51b, 52a, 52b, and 52c, and the second passage 72 of the water-cooled heat exchanger 70.

Each of the electric motors 51a and 51b may have a coolant passage provided inside or outside thereof, and the powertrain-side coolant may pass through the coolant passage. The powertrain coolant loop 23 may be fluidly connected to the coolant passage of each of the electric motors 51a and 51b. Each of the inverters 52a and 52b and the integrated power conversion component 52c may have a coolant passage provided inside or outside thereof, and the powertrain-side coolant may pass through the coolant passage. The powertrain coolant loop 23 may be fluidly connected to the coolant passage of each of the inverters 52a and 52b and the coolant passage of the integrated power conversion component 52c.

The powertrain radiator 53 may be adjacent to the front grille of the vehicle, and the powertrain radiator 53 may be cooled using the ambient air forcibly blown by the cooling fan 75. The exterior heat exchanger 35, the battery radiator 43, and the powertrain radiator 53 may be disposed adjacent to each other on the front of the vehicle, and the cooling fan 75 may be disposed behind the exterior heat exchanger 35, the battery radiator 43, and the powertrain radiator 53.

The powertrain-side pump 54 may be configured to allow the powertrain-side coolant to circulate through the powertrain coolant loop 23. The powertrain-side pump 54 may be an electric pump driven by electric energy. The powertrain-side pump 54 may be disposed on the upstream or downstream side of the plurality of powertrain components 51a, 51b, 52a, 52b, and 52c. According to the exemplary embodiment illustrated in FIG. 1, the powertrain-side pump 54 may be disposed on the upstream side of the plurality of powertrain components 51a, 51b, 52a, 52b, and 52c.

The powertrain cooling subsystem 13 may further include a powertrain bypass conduit 55 allowing the powertrain-side coolant to bypass the powertrain radiator 53. The powertrain bypass conduit 55 may directly connect an upstream point of the powertrain radiator 53 and a downstream point of the powertrain radiator 53 in the powertrain coolant loop 23 so that the powertrain-side coolant discharged from the second passage 72 of the water-cooled heat exchanger 70 may be directed into an inlet of the powertrain-side pump 54 through the powertrain bypass conduit 55, and accordingly the powertrain-side coolant may bypass the powertrain radiator 53.

An inlet of the powertrain bypass conduit 55 may be connected to an upstream point of the powertrain radiator 53 in the powertrain coolant loop 23. Specifically, the inlet of the powertrain bypass conduit 55 may be connected to a point between an inlet of the powertrain radiator 53 and the second passage 72 of the water-cooled heat exchanger 70 in the powertrain coolant loop 23.

An outlet of the powertrain bypass conduit 55 may be connected to the downstream point of the powertrain radiator 53 in the powertrain coolant loop 23. Specifically, the outlet of the powertrain bypass conduit 55 may be connected to a point between an outlet of the powertrain radiator 53 and the reservoir tank 56 in the powertrain coolant loop 23.

The powertrain cooling subsystem 13 may include a three-way valve 63 disposed at the inlet of the powertrain bypass conduit 55. When the three-way valve 63 is switched to open the inlet of the powertrain bypass conduit 55, the powertrain-side coolant may pass through the powertrain bypass conduit 55 so that the powertrain-side coolant may bypass the powertrain radiator 53, and accordingly the powertrain-side coolant may sequentially pass through the second passage 72 of the water-cooled heat exchanger 70, the powertrain bypass conduit 55, the reservoir tank 56, and the powertrain components 52c, 52b, 52a, 51b, and 51a by the operation of the powertrain-side pump 54. When the three-way valve 63 is switched to close the inlet of the powertrain bypass conduit 55, the powertrain-side coolant may not be directed to the powertrain bypass conduit 55, and accordingly the powertrain-side coolant may sequentially pass through the second passage 72 of the water-cooled heat exchanger 70, the powertrain radiator 53, the reservoir tank 56, the powertrain-side pump 54, and the powertrain components 52c, 52b, 52a, 51b, and 51a.

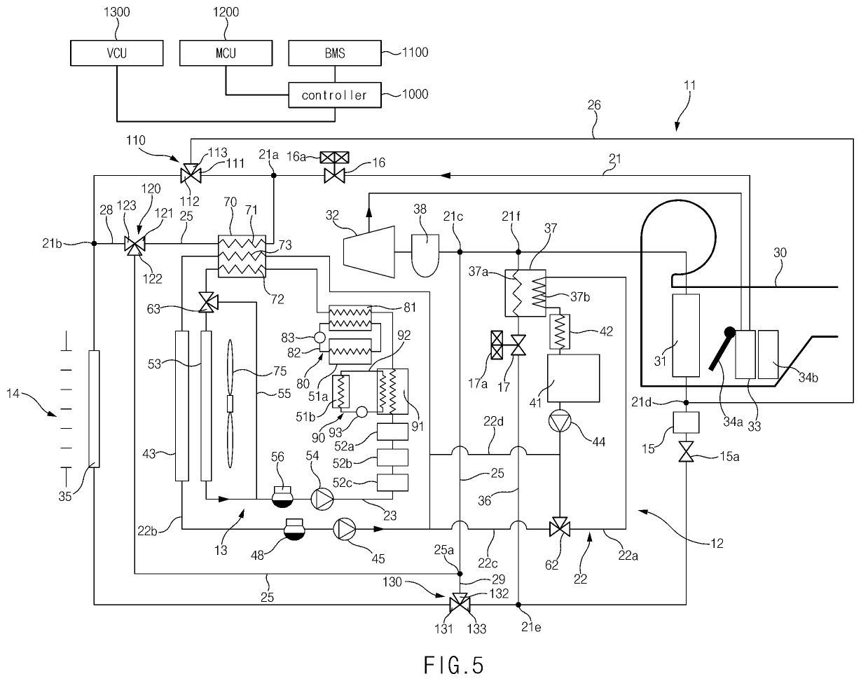

According to an exemplary embodiment illustrated in FIG. 5, the first electric motor 51a and the second electric motor 51b may be an oil cooling structure which is cooled by oil.

Referring to FIG. 5, the first electric motor 51a may be cooled through heat exchange between the powertrain-side coolant and oil. The first electric motor 51a may be thermally connected to the coolant loop 23 through a first oil circuit 80, and the first electric motor 51a may have an oil passage through which the oil passes. The first oil circuit 80 may include a first oil cooler 81 connected to the coolant loop 23, a first oil loop 82 connecting the first oil cooler 81 and the first electric motor 51a, and a first oil pump 83 disposed in the first oil loop 82. The first oil cooler 81 may include a coolant passage fluidly connected to the coolant loop 23, and an oil passage fluidly connected to the first oil loop 82. The first oil loop 82 may connect the oil passage of the first oil cooler 81 and the oil passage of the first electric motor 51a. Accordingly, the first electric motor 51a may be cooled through heat exchange between the powertrain-side coolant circulating in the coolant loop 23 and the oil circulating in the first oil circuit 80.

Referring to FIG. 5, the second electric motor 51b may be cooled through heat exchange between the powertrain-side coolant and oil. The second electric motor 51b may be thermally connected to the coolant loop 23 through a second oil circuit 90, and the second electric motor 51b may have an oil passage through which the oil passes. The second oil circuit 90 may include a second oil cooler 91 connected to the coolant loop 23, a second oil loop 92 connecting the second oil cooler 91 and the second electric motor 51b, and a second oil pump 93 disposed in the second oil loop 92. The second oil cooler 91 may include a coolant passage fluidly connected to the coolant loop 23, and an oil passage fluidly connected to the second oil loop 92. The second oil loop 92 may connect the oil passage of the second oil cooler 91 and the oil passage of the second electric motor 51b. Accordingly, the second electric motor 51b may be cooled through heat exchange between the powertrain-side coolant circulating in the coolant loop 23 and the oil circulating in the second oil circuit 90.

Referring to FIG. 5, the powertrain coolant loop 23 may be fluidly connected to the first oil cooler 81, the second oil cooler 91, the first inverter 52a, the second inverter 52b, and the integrated power conversion component 52c. Each of the first inverter 52a, the second inverter 52b, and the integrated power conversion component 52c may have a coolant passage provided inside or outside thereof, and the powertrain-side coolant may pass through the coolant passage. The powertrain coolant loop 23 may be fluidly connected to the coolant passage of the first inverter 52a, the coolant passage of the second inverter 52b, and the coolant passage of the integrated power conversion component 52c.

According to an exemplary embodiment, the powertrain cooling subsystem 13 may be controlled by a powertrain controller 1200. The powertrain controller 1200 may monitor temperatures of the powertrain components (the electric motors, the inverters, and the like) and a temperature of the powertrain-side coolant exchanging heat with the powertrain components, and may control the operation of the powertrain-side pump 54, the operations of the oil pumps 83 and 93, the operation of the cooling fan 75, and the operation of the three-way valve 63 in order to cool the powertrain components when the temperatures of the powertrain components and the temperature of the powertrain-side coolant are higher than or equal to a threshold temperature.

According to another exemplary embodiment, the powertrain controller 1200 may indirectly control the powertrain cooling subsystem 13 through the controller 1000 to be described below. That is, the powertrain controller 1200 may transmit a control signal to the controller 1000 so that the controller 1000 may control the powertrain cooling subsystem 13.

According to another exemplary embodiment, the powertrain controller 1200 and the controller 1000 may be configured as an integrated controller.

When the HVAC subsystem 11 operates in the heating mode, the shut-off valve 15a of the cooling-side expansion valve 15 may be closed, and the compressor 32 may operate at predetermined rpm so that the refrigerant may flow from the compressor 32 to the interior condenser 33. The refrigerant may be condensed by the interior condenser 33, and the condensed refrigerant may be expanded by the heating-side expansion valve 16. The expanded refrigerant may be directed to the exterior heat exchanger 35 and/or the first passage 71 of the water-cooled heat exchanger 70 by the first control valve 110 and the second control valve 120, and the expanded refrigerant may be evaporated by the exterior heat exchanger 35 and/or the water-cooled heat exchanger 70. The evaporated refrigerant may be directed to the compressor 32 and/or the first passage 37a of the battery chiller 37 by the third control valve 130. That is, when the HVAC subsystem 11 operates in the heating mode, the refrigerant may circulate in the refrigerant loop 21 of the HVAC subsystem 11 in the heating mode. When the HVAC subsystem 11 operates in the heating mode, the powertrain-side coolant may circulate in the powertrain coolant loop 23 of the powertrain cooling subsystem 13.

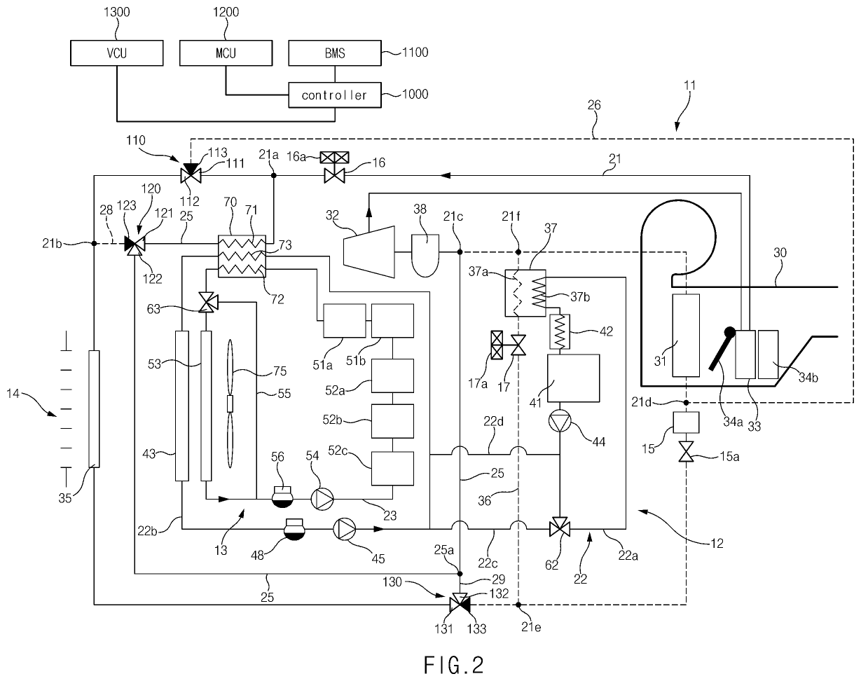

When a temperature of the ambient air and a temperature of the powertrain-side coolant are enough to evaporate low-temperature refrigerant, the low-temperature refrigerant discharged from the heating-side expansion valve 16 may be evaporated by the ambient air and the powertrain-side coolant. Referring to FIG. 2, the first control valve 110 may fully open the first outlet port 112, the second control valve 120 may fully open the first outlet port 122 and fully close the second outlet port 123, and the third control valve 130 may fully open the first outlet port 132 and fully close the second outlet port 133 so that the low-temperature refrigerant discharged from the heating-side expansion valve 16 may be appropriately distributed to the exterior heat exchanger 35 and the water-cooled heat exchanger 70. Accordingly, the low-temperature refrigerant directed into the exterior heat exchanger 35 may absorb heat from the ambient air, and the low-temperature refrigerant passing through the first passage 71 of the water-cooled heat exchanger 70 may absorb heat from the powertrain-side coolant passing through the second passage 72 of the water-cooled heat exchanger 70. Here, the powertrain-side coolant directed into the second passage 72 of the water-cooled heat exchanger 70 may be in a heated state (that is, the temperature of the powertrain-side coolant has been relatively increased) by absorbing heat generated from the powertrain components 51a, 51b, 52a, 52b, and 52c.

When the vehicle is driving at low speed, the powertrain components 51a, 51b, 52a, 52b, and 52c may operate under low load conditions. In a condition in which the amount of heat generated from the powertrain components 51a, 51b, 52a, 52b, and 52c is relatively low, the controller 1000 may control the first control valve 110 and the second control valve 120 to cause the refrigerant to absorb a relatively large amount of heat from the ambient air compared to the powertrain-side coolant. In particular, in a condition in which it is better to evaporate the refrigerant using the ambient air, the controller 1000 may control the first control valve 110 and the second control valve 120 in a manner that allows the flow rate of the refrigerant into the exterior heat exchanger 35 to be higher than the flow rate of the refrigerant into the first passage 71 of the water-cooled heat exchanger 70. Accordingly, most of the refrigerant may absorb heat from the ambient air through the exterior heat exchanger 35, and the rest of the refrigerant may absorb heat from the powertrain components 51a, 51b, 52a, 52b, and 52c.

With a predetermined time having elapsed since the vehicle's low-speed driving, as the vehicle accelerates or decelerates, the amount of heat generated from the powertrain components 51a, 51b, 52a, 52b, and 52c may start to gradually increase or the low-temperature refrigerant may not be sufficiently evaporated by only the ambient air. Accordingly, the controller 1000 may control the opening degree of the first outlet port 112 of the first control valve 110 and the opening degree of the first outlet port 122 of the second control valve 120 so that a ratio between the flow rate of the refrigerant into the exterior heat exchanger 35 and the flow rate of the refrigerant into the first passage 71 of the water-cooled heat exchanger 70 may be adjusted relative to each other. Thus, the refrigerant may absorb heat from the ambient air and the powertrain-side coolant at a predetermined ratio.

When the vehicle is driving at high speed or the vehicle is towing a trailer, the amount of heat generated from the powertrain components 51a, 51b, 52a, 52b, and 52c may be greater than or equal to a predetermined reference heat generating amount. In particular, in a condition in which it is better to evaporate the refrigerant using the powertrain-side coolant, the controller 1000 may control the first control valve 110 and the second control valve 120 in a manner that allows the flow rate of the refrigerant into the first passage 71 of the water-cooled heat exchanger 70 to be higher than the flow rate of the refrigerant into the exterior heat exchanger 35. Accordingly, the refrigerant may absorb a relatively large amount of heat from the powertrain components 51a, 51b, 52a, 52b, and 52c, and may absorb a relatively large amount of heat from the ambient air through the exterior heat exchanger 35.

When the vehicle is driving at high speed or the vehicle is towing the trailer, the amount of heat generated from the battery 41 may be greater than or equal to a predetermined reference heat generating amount. As the battery-side coolant circulates through the battery cooling subsystem 12, the battery-side coolant may cool the battery 41. The controller 1000 may control the third control valve 130 to fully open the second outlet port 133 of the third control valve 130 (the opening degree of the second outlet port 133 is 100%) or partially open the second outlet port 133 of the third control valve 130 so that at least a portion of the refrigerant may be directed into the first passage 37a of the battery chiller 37. Accordingly, the refrigerant may sufficiently absorb heat from the battery chiller 37, and thus the evaporation of the refrigerant may be ensured. A refrigerant sensor may be adjacent to the battery chiller 37, and the refrigerant sensor may measure the temperature and pressure of the refrigerant discharged from the first passage 37a of the battery chiller 37 so that waste heat of the battery may be appropriately recovered from the battery chiller 37.

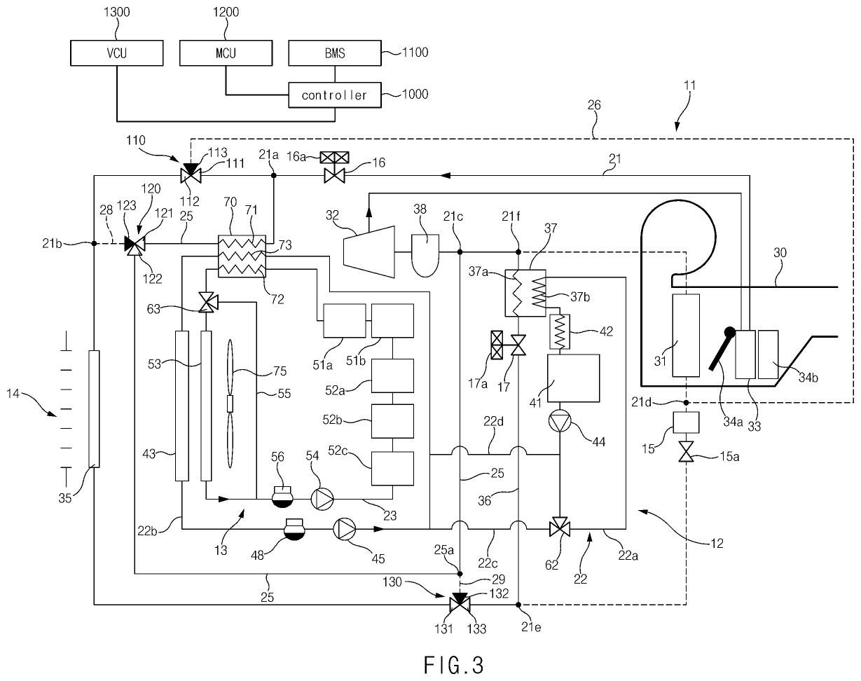

Referring to FIG. 3, the second control valve 120 may fully open the first outlet port 122 and fully close the second outlet port 123, the third control valve 130 may fully close the first outlet port 132 and fully open the second outlet port 133, and the first control valve 110 may adjust the opening degree of the first outlet port 112 so that the refrigerant discharged from the exterior heat exchanger 35 may be directed into the first passage 37a of the battery chiller 37, and accordingly the refrigerant passing through the first passage 37a of the battery chiller 37 may absorb heat from the battery-side coolant passing through the second passage 37b of the battery chiller 37. Here, the battery-side coolant directed into the second passage 37b of the battery chiller 37 may be in a heated state (that is, the temperature of the battery-side coolant has been relatively increased) by absorbing heat generated from the battery 41.

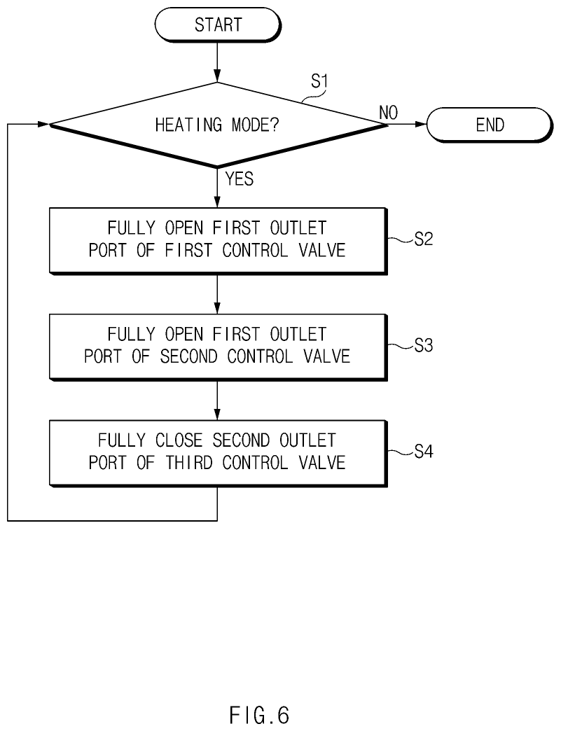

FIG. 6 illustrates a method for controlling the flow of the refrigerant and/or the flow rate of the refrigerant when the HVAC subsystem operates in a heating mode.

Referring to FIG. 6, it may be determined whether the HVAC subsystem 11 operates in a heating mode (S1). When it is determined that the HVAC subsystem 11 does not operate in the heating mode, the method may end.

When it is determined that the HVAC subsystem 11 operates in the heating mode, the controller 1000 may control the first control valve 110 to fully open the first outlet port 112 (S2). Here, the controller 1000 may control the first control valve 110 to adjust the opening/closing, opening degree, and the like of the second outlet port 113 based on whether dehumidification in the passenger compartment is required.

Thereafter, the controller 1000 may control the second control valve 120 to fully open the first outlet port 122 and fully close the second outlet port 123 (S3). As the first outlet port 112 of the first control valve 110 is fully opened, and the first outlet port 122 of the second control valve 120 is fully opened, the low-temperature refrigerant may be uniformly distributed to the exterior heat exchanger 35 and the first passage 71 of the water-cooled heat exchanger 70.

Then, the controller 1000 may control the third control valve 130 to adjust the opening degree of the first outlet port 132 and to fully close the second outlet port 133 (S4). As the opening degree of the first outlet port 132 of the third control valve 130 is adjusted, and the second outlet port 133 of the third control valve 130 is fully closed, the refrigerant may be directed to the compressor 32 through the accumulator 38, and the refrigerant may not be directed to the first passage 37a of the battery chiller 37.

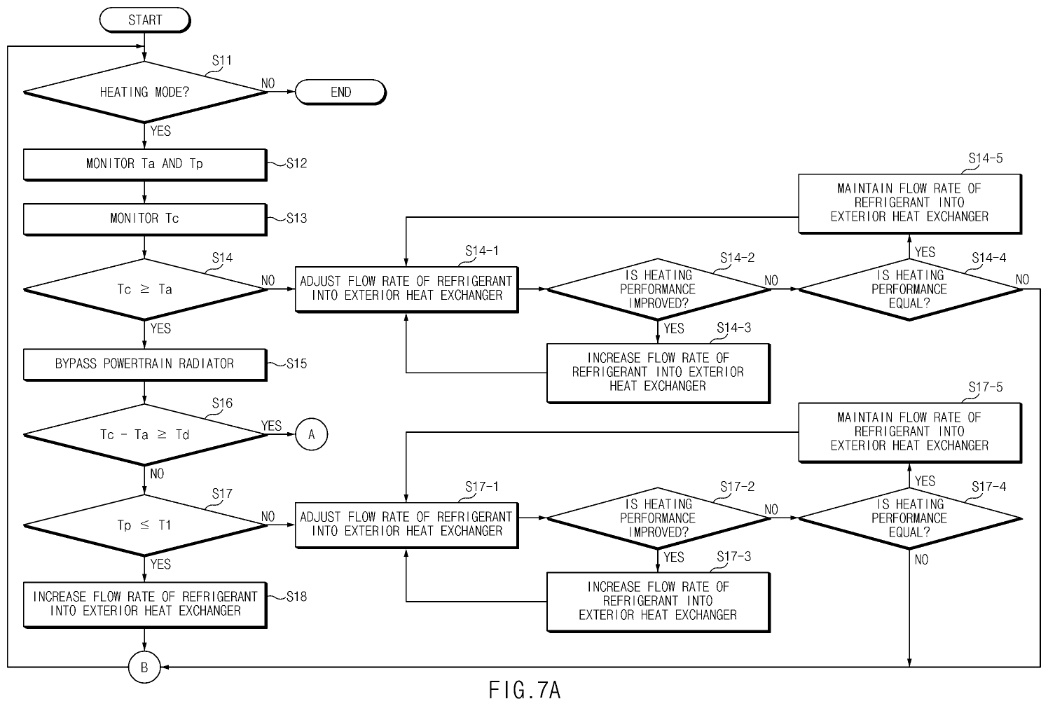

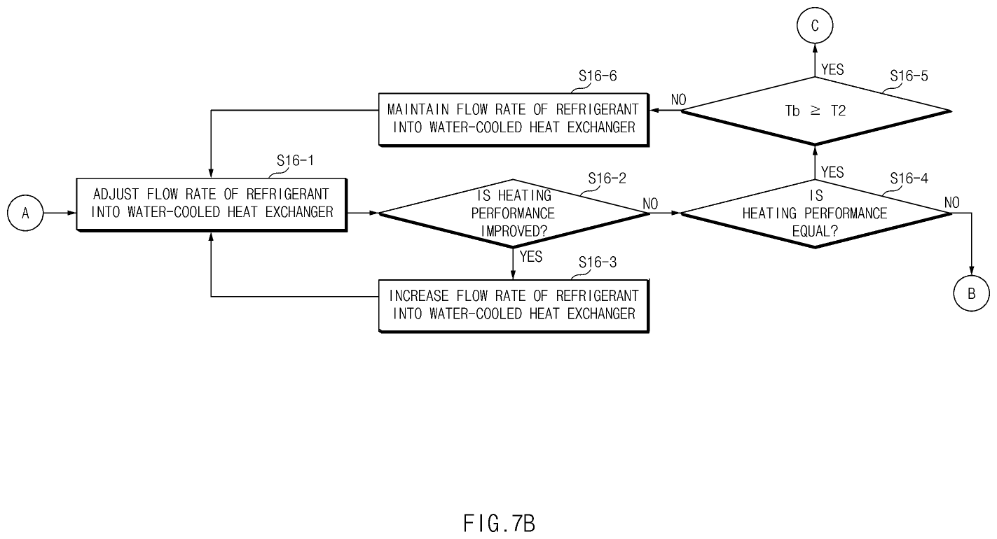

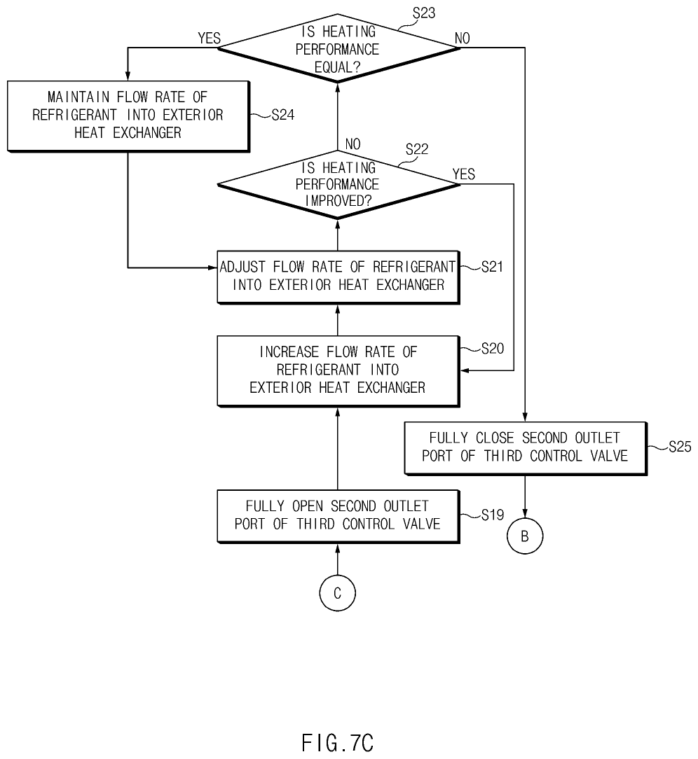

FIGS. 7A to 7C illustrate a method for controlling the flow of the refrigerant and/or the flow rate of the refrigerant based on the temperature of the powertrain-side coolant when the HVAC subsystem 11 operates in a heating mode.

Referring to FIG. 7A, it may be determined whether the HVAC subsystem 11 operates in a heating mode (S11). When it is determined that the HVAC subsystem 11 does not operate in the heating mode, the method may end.

When it is determined that the HVAC subsystem 11 operates in the heating mode, a temperature Ta of the ambient air and a temperature Tp of the powertrain component may be measured and monitored (S12).

Thereafter, a temperature Tc of the powertrain-side coolant may be measured and monitored (S13). Here, the temperature Tc of the powertrain-side coolant may be measured by a temperature sensor disposed at the upstream point adjacent to the inlet of the powertrain radiator 53 or the downstream point adjacent to the outlet of the powertrain radiator 53.

To see whether the temperature of the powertrain-side coolant decreases in the water-cooled heat exchanger 70 through heat exchange between the powertrain-side coolant and the refrigerant, it may be determined whether the temperature Tc of the powertrain-side coolant is higher than or equal to the temperature Ta of the ambient air (S14).

When it is determined in S14 that the temperature Tc of the powertrain-side coolant is higher than or equal to the temperature Ta of the ambient air, the controller 1000 may control the three-way valve 63 to cause the powertrain-side coolant to bypass the powertrain radiator 53 (S15).

It may be determined whether a temperature difference value between the temperature Tc of the powertrain-side coolant and the temperature Ta of the ambient air is greater than or equal to a threshold value Td (S16). The threshold value Td may be defined as a temperature difference value between a temperature of the powertrain-side coolant and a temperature of the ambient air which have increased enough to evaporate the low-temperature refrigerant. That is, the threshold value Td may relate to a state in which the low-temperature refrigerant can be sufficiently evaporated by the waste heat of the powertrain component. When the temperature difference value between the temperature Tc of the powertrain-side coolant and the temperature Ta of the ambient air is greater than or equal to the threshold value Td, the amount of heat generated from the powertrain components 51a, 51b, 52a, 52b, and 52c may be greater than or equal to a reference heat generating amount. Accordingly, as the powertrain-side coolant has been heated (the temperature of the powertrain-side coolant has been increased) by the waste heat of the powertrain component, the low-temperature refrigerant may be sufficiently evaporated by the powertrain-side coolant.

When the temperature difference value between the temperature Tc of the powertrain-side coolant and the temperature Ta of the ambient air is less than the threshold value Td, it may be determined whether the temperature Tp of the powertrain component is lower than or equal to a first reference temperature T1 (S17). The first reference temperature T1 refers to a reference temperature at which each of the powertrain components 51a, 51b, 52a, 52b, and 52c operates normally. When the temperature Tp of the powertrain component is lower than or equal to the first reference temperature T1, circulation of the powertrain-side coolant may be minimized by adjusting rpm of the powertrain-side pump 54 of the powertrain cooling subsystem 13 to minimum rpm or stopping the powertrain-side pump 54. When the temperature Tp of the powertrain component is lower than or equal to the first reference temperature T1, the temperature Tp of the powertrain component may be excessively low so that the low-temperature refrigerant may be difficult to absorb heat from the powertrain-side coolant. Accordingly, it may be necessary to minimize the flow rate of the refrigerant into the first passage 71 of the water-cooled heat exchanger 70, and to increase the flow rate of the refrigerant into the exterior heat exchanger 35. According to an exemplary embodiment, the temperature Tp of the powertrain component may be a coil temperature of the electric motors 51a and 51b, and the first reference temperature T1 may be a reference coil temperature of the electric motors 51a and 51b.

When it is determined in S17 that the temperature Tp of the powertrain component is lower than or equal to the first reference temperature T1, the controller 1000 may control the first control valve 110 and the second control valve 120 to relatively increase the flow rate of the refrigerant into the exterior heat exchanger 35 (S18). Specifically, the controller 1000 may control the first control valve 110 and the second control valve 120 to increase the flow rate of the refrigerant into the exterior heat exchanger 35 above the flow rate of the refrigerant into the first passage 71 of the water-cooled heat exchanger 70.

According to an exemplary embodiment, the controller 1000 may control the first control valve 110 to fully open the first outlet port 112, and the controller 1000 may control the second control valve 120 to relatively reduce the opening degree of the first outlet port 122. Accordingly, the flow rate of the refrigerant into the exterior heat exchanger 35 may be relatively increased above the flow rate of the refrigerant into the first passage 71 of the water-cooled heat exchanger 70. When the opening degree of the first outlet port 122 of the second control valve 120 is less than the opening degree of the first outlet port 112 of the first control valve 110, resistance to the flow of the refrigerant in the second control valve 120 may be relatively increased and the flow rate of the refrigerant passing through the first control valve 110 may be relatively increased, and accordingly the flow rate of the refrigerant into the exterior heat exchanger 35 may be relatively increased. In particular, the opening degree of the first outlet port 122 of the second control valve 120 may be determined based on the measured temperature Ta of the ambient air, the measured temperature Tc of the powertrain-side coolant, and the measured temperature Tp of the powertrain component using a valve opening-degree map.

According to another exemplary embodiment, the controller 1000 may control the first control valve 110 to fully open the first outlet port 112, and the controller 1000 may control the second control valve 120 to relatively reduce the opening degree of the first outlet port 122 and relatively increase the opening degree of the second outlet port 123. Accordingly, the refrigerant discharged from the first outlet port 112 of the first control valve 110 may be directed into the exterior heat exchanger 35, and the refrigerant discharged from the first passage 71 of the water-cooled heat exchanger 70 may be directed into the exterior heat exchanger 35 through the second outlet port 123 of the second control valve 120 so that the flow rate of the refrigerant into the exterior heat exchanger 35 may be relatively increased.

When it is determined in S14 that the temperature Tc of the powertrain-side coolant is lower than the temperature Ta of the ambient air, the controller 1000 may determine that the temperature Tc of the powertrain-side coolant is lowered through the water-cooled heat exchanger 70, and the controller 1000 may control the first control valve 110 and the second control valve 120 to adjust the flow rate of the refrigerant into the exterior heat exchanger 35 (S14-1). Specifically, the controller 1000 may control the first control valve 110 and the second control valve 120 to increase the flow rate of the refrigerant into the exterior heat exchanger 35 above the flow rate of the refrigerant into the first passage 71 of the water-cooled heat exchanger 70. The flow rate of the refrigerant into the exterior heat exchanger 35 may be determined based on the measured temperature Ta of the ambient air, the measured temperature Tc of the powertrain-side coolant, and the measured temperature Tp of the powertrain component. Specifically, the opening degree of the first outlet port 112 of the first control valve 110 and the opening degree of the first outlet port 122 and/or the opening degree of the second outlet port 123 of the second control valve 120 may be determined using an opening-degree map of the first control valve 110 and an opening-degree map of the second control valve 120. The opening-degree map of the first control valve 110 may include the opening degree of the first outlet port 112 of the first control valve 110 determined based on the temperature Ta of the ambient air, the temperature Tc of the powertrain-side coolant, and the temperature Tp of the powertrain component, and the opening-degree map of the second control valve 120 may include the opening degree of the first outlet port 122 and/or the opening degree of the second outlet port 123 of the second control valve 120 determined based on the temperature Ta of the ambient air, the temperature Tc of the powertrain-side coolant, and the temperature Tp of the powertrain component.

After the flow rate of the refrigerant into the exterior heat exchanger 35 is adjusted in S14-1, it may be determined whether actual heating performance of the HVAC subsystem 11 for the passenger compartment is higher than reference heating performance (S14-2). Here, the reference heating performance refers to heating performance obtained when the HVAC subsystem uses at least a portion of the indoor air in the passenger compartment.

Specifically, by determining whether an actual temperature increase in the passenger compartment is greater than a reference temperature increase, it may be determined whether the actual heating performance of the HVAC subsystem 11 for the passenger compartment is higher than the reference heating performance. Here, the reference temperature increase refers to a temperature increase in the passenger compartment when the HVAC subsystem uses at least a portion of the indoor air in the passenger compartment.

When it is determined in S14-2 that the actual heating performance of the HVAC subsystem 11 for the passenger compartment is higher than the reference heating performance, the controller 1000 may control the first control valve 110 and the second control valve 120 to increase the flow rate of the refrigerant into the exterior heat exchanger 35 by a predetermined flow rate (S14-3).

When it is determined in S14-2 that the actual heating performance of the HVAC subsystem 11 for the passenger compartment is not higher than the reference heating performance, it may be determined whether the actual heating performance of the HVAC subsystem 11 for the passenger compartment is equal to the reference heating performance (S14-4). Specifically, by determining whether the actual temperature increase in the passenger compartment is equal to the reference temperature increase, it may be determined whether the actual heating performance of the HVAC subsystem 11 for the passenger compartment is equal to the reference heating performance.

When it is determined in S14-4 that the actual heating performance of the HVAC subsystem 11 for the passenger compartment is equal to the reference heating performance, the controller 1000 may control the first control valve 110 and the second control valve 120 to maintain the flow rate of the refrigerant into the exterior heat exchanger 35 at the flow rate of the refrigerant determined in S14-1 (S14-5).

When it is determined in S14-4 that the actual heating performance of the HVAC subsystem 11 for the passenger compartment is not equal to the reference heating performance, the method may return to S11.

When it is determined in S17 that the temperature Tp of the powertrain component exceeds the first reference temperature T1, the controller 1000 may control the first control valve 110 and the second control valve 120 to adjust the flow rate of the refrigerant into the exterior heat exchanger 35 (S17-1). Specifically, the controller 1000 may control the first control valve 110 and the second control valve 120 to increase the flow rate of the refrigerant into the exterior heat exchanger 35 above the flow rate of the refrigerant into the first passage 71 of the water-cooled heat exchanger 70. The flow rate of the refrigerant into the exterior heat exchanger 35 may be determined based on the measured temperature Ta of the ambient air, the measured temperature Tc of the powertrain-side coolant, and the measured temperature Tp of the powertrain component. Specifically, the opening degree of the first outlet port 112 of the first control valve 110 and the opening degree of the first outlet port 122 and/or the opening degree of the second outlet port 123 of the second control valve 120 may be determined using an opening-degree map of the first control valve 110 and an opening-degree map of the second control valve 120. The opening-degree map of the first control valve 110 may include the opening degree of the first outlet port 112 of the first control valve 110 determined based on the temperature Ta of the ambient air, the temperature Tc of the powertrain-side coolant, and the temperature Tp of the powertrain component, and the opening-degree map of the second control valve 120 may include the opening degree of the first outlet port 122 and/or the opening degree of the second outlet port 123 of the second control valve 120 determined based on the temperature Ta of the ambient air, the temperature Tc of the powertrain-side coolant, and the temperature Tp of the powertrain component.

After S17-1, it may be determined whether actual heating performance of the HVAC subsystem 11 for the passenger compartment is higher than reference heating performance (S17-2). Here, the reference heating performance refers to heating performance obtained when the HVAC subsystem uses at least a portion of the indoor air in the passenger compartment.

Specifically, by determining whether an actual temperature increase in the passenger compartment is greater than a reference temperature increase, it may be determined whether the actual heating performance of the HVAC subsystem 11 for the passenger compartment is higher than the reference heating performance. Here, the reference temperature increase refers to a temperature increase in the passenger compartment when the HVAC subsystem uses at least a portion of the indoor air in the passenger compartment.

When it is determined in S17-2 that the actual heating performance of the HVAC subsystem 11 for the passenger compartment is higher than the reference heating performance, the controller 1000 may control the first control valve 110 and the second control valve 120 to increase the flow rate of the refrigerant into the exterior heat exchanger 35 by a predetermined flow rate (S17-3).

When it is determined in S17-2 that the actual heating performance of the HVAC subsystem 11 for the passenger compartment is not higher than the reference heating performance, it may be determined whether the actual heating performance of the HVAC subsystem 11 for the passenger compartment is equal to the reference heating performance (S17-4). Specifically, by determining whether the actual temperature increase in the passenger compartment is equal to the reference temperature increase, it may be determined whether the actual heating performance of the HVAC subsystem 11 for the passenger compartment is equal to the reference heating performance.

When it is determined in S17-4 that the actual heating performance of the HVAC subsystem 11 for the passenger compartment is equal to the reference heating performance, the controller 1000 may control the first control valve 110 and the second control valve 120 to maintain the flow rate of the refrigerant into the exterior heat exchanger 35 at the flow rate of the refrigerant determined in S17-1 (S17-5).

When it is determined in S17-4 that the actual heating performance of the HVAC subsystem 11 for the passenger compartment is not equal to the reference heating performance, the method may return to S11.

FIG. 7B illustrates a method for controlling the flow of the refrigerant and/or the flow rate of the refrigerant when the temperature difference value between the temperature Tc of the powertrain-side coolant and the temperature Ta of the ambient air is greater than or equal to the threshold value Td.

Referring to FIG. 7B, when the temperature difference value between the temperature Tc of the powertrain-side coolant and the temperature Ta of the ambient air is greater than or equal to the threshold value Td, the controller 1000 may control the first control valve 110 and the second control valve 120 to adjust the flow rate of the refrigerant into the first passage 71 of the water-cooled heat exchanger 70 (S16-1). Specifically, the controller 1000 may control the first control valve 110 and the second control valve 120 to increase the flow rate of the refrigerant into the first passage 71 of the water-cooled heat exchanger 70 above the flow rate of the refrigerant into the exterior heat exchanger 35. The flow rate of the refrigerant into the first passage 71 of the water-cooled heat exchanger 70 may be determined based on the measured temperature Ta of the ambient air, the measured temperature Tc of the powertrain-side coolant, and the measured temperature Tp of the powertrain component. Specifically, the opening degree of the first outlet port 112 of the first control valve 110 and the opening degree of the first outlet port 122 and/or the opening degree of the second outlet port 123 of the second control valve 120 may be determined using an opening-degree map of the first control valve 110 and an opening-degree map of the second control valve 120. The opening-degree map of the first control valve 110 may include the opening degree of the first outlet port 112 of the first control valve 110 determined based on the temperature Ta of the ambient air, the temperature Tc of the powertrain-side coolant, and the temperature Tp of the powertrain component, and the opening-degree map of the second control valve 120 may include the opening degree of the first outlet port 122 and/or the opening degree of the second outlet port 123 of the second control valve 120 determined based on the temperature Ta of the ambient air, the temperature Tc of the powertrain-side coolant, and the temperature Tp of the powertrain component.

After the flow rate of the refrigerant into the first passage 71 of the water-cooled heat exchanger 70 is adjusted in S16-1, it may be determined whether the actual heating performance of the HVAC subsystem 11 for the passenger compartment is higher than the reference heating performance (S16-2). Here, the reference heating performance refers to heating performance obtained when the HVAC subsystem uses at least a portion of the indoor air in the passenger compartment.

Specifically, by determining whether an actual temperature increase in the passenger compartment is greater than a reference temperature increase, it may be determined whether the actual heating performance of the HVAC subsystem 11 for the passenger compartment is higher than the reference heating performance. Here, the reference temperature increase refers to a temperature increase in the passenger compartment when the HVAC subsystem uses at least a portion of the indoor air in the passenger compartment.

When it is determined in S16-2 that the actual heating performance of the HVAC subsystem 11 for the passenger compartment is higher than the reference heating performance, the controller 1000 may control the first control valve 110 and the second control valve 120 to increase the flow rate of the refrigerant into the water-cooled heat exchanger 70 by a predetermined flow rate (S16-3).

When it is determined in S16-2 that the actual heating performance of the HVAC subsystem 11 for the passenger compartment is not higher than the reference heating performance, it may be determined whether the actual heating performance of the HVAC subsystem 11 for the passenger compartment is equal to the reference heating performance (S16-4).

Specifically, by determining whether the actual temperature increase in the passenger compartment is equal to the reference temperature increase, it may be determined whether the actual heating performance of the HVAC subsystem 11 for the passenger compartment is equal to the reference heating performance.

When it is determined in S16-4 that the actual heating performance of the HVAC subsystem 11 for the passenger compartment is not equal to the reference heating performance, the method may return to S11.

When it is determined in S16-4 that the actual heating performance of the HVAC subsystem 11 for the passenger compartment is equal to the reference heating performance, it may be determined whether a temperature Tb of the battery 41 or a temperature of the battery-side coolant is higher than or equal to a second reference temperature T2 (S16-5). The second reference temperature T2 refers to a temperature of the battery or the battery-side coolant which has increased enough to evaporate the refrigerant. When the temperature Tb of the battery 41 or the temperature of the battery-side coolant is higher than or equal to the second reference temperature T2, the refrigerant may be additionally evaporated by absorbing heat generated from the battery 41 in the battery chiller 37.

When it is determined in S16-5 that the temperature Tb of the battery 41 or the temperature of the battery-side coolant is lower than the second reference temperature T2, the controller 1000 may control the first control valve 110 and the second control valve 120 to maintain the flow rate of the refrigerant into the first passage 71 of the water-cooled heat exchanger 70 at the flow rate of the refrigerant determined in S16-1 (S16-6).

FIG. 7C illustrates a method for controlling the flow of the refrigerant and/or the flow rate of the refrigerant when the temperature Tb of the battery 41 or the temperature of the battery-side coolant is higher than or equal to the second reference temperature T2.

Referring to FIG. 7C, when the temperature Tb of the battery 41 or the temperature of the battery-side coolant is higher than or equal to the second reference temperature T2, the controller 1000 may control the third control valve 130 to fully open the second outlet port 133 (S19). Referring to FIG. 3, as the second outlet port 133 of the third control valve 130 is fully opened, the refrigerant discharged from the exterior heat exchanger 35 may be directed to the first passage 37a of the battery chiller 37, and the refrigerant passing through the first passage 37a of the battery chiller 37 may absorb heat from the battery-side coolant passing through the second passage 37b of the battery chiller 37 and be evaporated.

After the second outlet port 133 of the third control valve 130 is fully opened, the controller 1000 may control the first control valve 110 and the second control valve 120 to relatively increase the flow rate of the refrigerant into the exterior heat exchanger 35 (S20). Specifically, the controller 1000 may control the first control valve 110 and the second control valve 120 to increase the flow rate of the refrigerant into the exterior heat exchanger 35 above the flow rate of the refrigerant into the first passage 71 of the water-cooled heat exchanger 70.

Thereafter, the controller 1000 may control the first control valve 110 and the second control valve 120 to adjust the flow rate of the refrigerant into the exterior heat exchanger 35 (S21). Specifically, the controller 1000 may control the first control valve 110 and the second control valve 120 to increase the flow rate of the refrigerant into the exterior heat exchanger 35 above the flow rate of the refrigerant into the first passage 71 of the water-cooled heat exchanger 70. The flow rate of the refrigerant into the exterior heat exchanger 35 may be determined based on the measured temperature Ta of the ambient air, the measured temperature Tc of the powertrain-side coolant, and the measured temperature Tp of the powertrain component. Specifically, the opening degree of the first outlet port 112 of the first control valve 110 and the opening degree of the first outlet port 122 and/or the opening degree of the second outlet port 123 of the second control valve 120 may be determined using an opening-degree map of the first control valve 110 and an opening-degree map of the second control valve 120. The opening-degree map of the first control valve 110 may include the opening degree of the first outlet port 112 of the first control valve 110 determined based on the temperature Ta of the ambient air, the temperature Tc of the powertrain-side coolant, and the temperature Tp of the powertrain component, and the opening-degree map of the second control valve 120 may include the opening degree of the first outlet port 122 and/or the opening degree of the second outlet port 123 of the second control valve 120 determined based on the temperature Ta of the ambient air, the temperature Tc of the powertrain-side coolant, and the temperature Tp of the powertrain component.

After S21, it may be determined whether actual heating performance of the HVAC subsystem 11 for the passenger compartment is higher than reference heating performance (S22). Here, the reference heating performance refers to heating performance obtained when the HVAC subsystem uses at least a portion of the indoor air in the passenger compartment.

Specifically, by determining whether an actual temperature increase in the passenger compartment is greater than a reference temperature increase, it may be determined whether the actual heating performance of the HVAC subsystem 11 for the passenger compartment is higher than the reference heating performance. Here, the reference temperature increase refers to a temperature increase in the passenger compartment when the HVAC subsystem uses at least a portion of the indoor air in the passenger compartment.

When it is determined in S22 that the actual heating performance of the HVAC subsystem 11 for the passenger compartment is higher than the reference heating performance, the controller 1000 may control the first control valve 110 and the second control valve 120 to increase the flow rate of the refrigerant into the exterior heat exchanger 35 by a predetermined flow rate (S20).

When it is determined in S22 that the actual heating performance of the HVAC subsystem 11 for the passenger compartment is not higher than the reference heating performance, it may be determined whether the actual heating performance of the HVAC subsystem 11 for the passenger compartment is equal to the reference heating performance (S23). Specifically, by determining whether the actual temperature increase in the passenger compartment is equal to the reference temperature increase, it may be determined whether the actual heating performance of the HVAC subsystem 11 for the passenger compartment is equal to the reference heating performance.

When it is determined in S23 that the actual heating performance of the HVAC subsystem 11 for the passenger compartment is equal to the reference heating performance, the controller 1000 may control the first control valve 110 and the second control valve 120 to maintain the flow rate of the refrigerant into the exterior heat exchanger 35 at the flow rate of the refrigerant determined in S21 (S24).

When it is determined in S23 that the actual heating performance of the HVAC subsystem 11 for the passenger compartment is not equal to the reference heating performance, the controller 1000 may control the third control valve 130 to fully close the second outlet port 133 (S25).

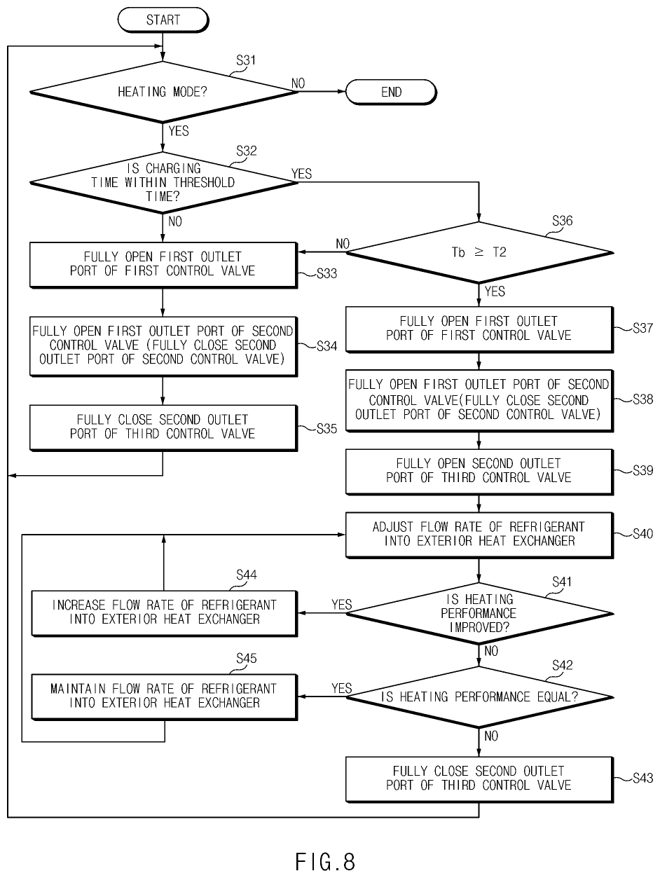

FIG. 8 illustrates a method for controlling the flow of the refrigerant and/or the flow rate of the refrigerant in a condition in which the battery 41 is overheated due to fast charging, etc. When the battery 41 is overheated, it may be advantageous to absorb waste heat of the battery 41.

Referring to FIG. 8, it may be determined whether the HVAC subsystem 11 operates in a heating mode (S31). When it is determined that the HVAC subsystem 11 does not operate in the heating mode, the method may end.

When the HVAC subsystem 11 operates in the heating mode, the controller 1000 may determine whether a charging time of the battery 41 is within a threshold time through the battery management system 1100 (S32). Here, the threshold time refers to a charging time used for determining whether the battery 41 is rapidly charged.

When it is determined in S32 that the charging time of the battery 41 exceeds the threshold time, the controller 1000 may control the first control valve 110 to fully open the first outlet port 112 (S33). Here, the controller 1000 may control the first control valve 110 to adjust the opening/closing, opening degree, and the like of the second outlet port 113 based on whether dehumidification in the passenger compartment is required.

After the first outlet port 112 of the first control valve 110 is fully opened, the controller 1000 may control the second control valve 120 to fully open the first outlet port 122 and fully close the second outlet port 123 (S34). As the first outlet port 112 of the first control valve 110 is fully opened, and the first outlet port 122 of the second control valve 120 is fully opened, the low-temperature refrigerant may be uniformly distributed to the exterior heat exchanger 35 and the first passage 71 of the water-cooled heat exchanger 70.

Thereafter, the controller 1000 may control the third control valve 130 to adjust the opening degree of the first outlet port 132 and to fully close the second outlet port 133 (S35). As the opening degree of the first outlet port 132 of the third control valve 130 is adjusted, and the second outlet port 133 of the third control valve 130 is fully closed, the refrigerant may be directed to the compressor 32 through the accumulator 38, and the refrigerant may not be directed to the first passage 37a of the battery chiller 37.

When it is determined in S32 that the charging time of the battery 41 is within the threshold time, the controller 1000 may determine whether the temperature Tb of the battery 41 or the temperature of the battery-side coolant is higher than or equal to the second reference temperature T2 (S36).

When it is determined in S36 that the temperature Tb of the battery 41 or the temperature of the battery-side coolant is lower than the second reference temperature T2, the method may return to S33.

When it is determined in S36 that the temperature Tb of the battery 41 or the temperature of the battery-side coolant is higher than or equal to the second reference temperature T2, the controller 1000 may control the first control valve 110 to fully open the first outlet port 112 (S37).

After the first outlet port 112 of the first control valve 110 is fully opened, the controller 1000 may control the second control valve 120 to fully open the first outlet port 122 and fully close the second outlet port 123 (S38).

Thereafter, the controller 1000 may control the third control valve 130 to fully open the second outlet port 133 (S39). Referring to FIG. 3, as the second outlet port 133 of the third control valve 130 is fully opened, the refrigerant discharged from the exterior heat exchanger 35 may be directed to the first passage 37a of the battery chiller 37, and the refrigerant passing through the first passage 37a of the battery chiller 37 may absorb heat from the battery-side coolant passing through the second passage 37b of the battery chiller 37 and be evaporated.

After the second outlet port 133 of the third control valve 130 is fully opened, the controller 1000 may control the first control valve 110 and the second control valve 120 to adjust the flow rate of the refrigerant into the exterior heat exchanger 35 (S40). Specifically, the controller 1000 may control the first control valve 110 and the second control valve 120 to increase the flow rate of the refrigerant into the exterior heat exchanger 35 above the flow rate of the refrigerant into the first passage 71 of the water-cooled heat exchanger 70. The flow rate of the refrigerant into the exterior heat exchanger 35 may be determined based on the measured temperature Ta of the ambient air, the measured temperature Tc of the powertrain-side coolant, and the measured temperature Tp of the powertrain component. Specifically, the opening degree of the first outlet port 112 of the first control valve 110 and the opening degree of the first outlet port 122 and/or the opening degree of the second outlet port 123 of the second control valve 120 may be determined using an opening-degree map of the first control valve 110 and an opening-degree map of the second control valve 120. The opening-degree map of the first control valve 110 may include the opening degree of the first outlet port 112 of the first control valve 110 determined based on the temperature Ta of the ambient air, the temperature Tc of the powertrain-side coolant, and the temperature Tp of the powertrain component, and the opening-degree map of the second control valve 120 may include the opening degree of the first outlet port 122 and/or the opening degree of the second outlet port 123 of the second control valve 120 determined based on the temperature Ta of the ambient air, the temperature Tc of the powertrain-side coolant, and the temperature Tp of the powertrain component.

After S40, it may be determined whether actual heating performance of the HVAC subsystem 11 for the passenger compartment is higher than reference heating performance (S41). Here, the reference heating performance refers to heating performance obtained when the HVAC subsystem uses at least a portion of the indoor air in the passenger compartment.

Specifically, by determining whether an actual temperature increase in the passenger compartment is greater than a reference temperature increase, it may be determined whether the actual heating performance of the HVAC subsystem 11 for the passenger compartment is higher than the reference heating performance. Here, the reference temperature increase refers to a temperature increase in the passenger compartment when the HVAC subsystem uses at least a portion of the indoor air in the passenger compartment.

When it is determined in S41 that the actual heating performance of the HVAC subsystem 11 for the passenger compartment is higher than the reference heating performance, the controller 1000 may control the first control valve 110 and the second control valve 120 to increase the flow rate of the refrigerant into the exterior heat exchanger 35 by a predetermined flow rate (S44).

When it is determined in S41 that the actual heating performance of the HVAC subsystem 11 for the passenger compartment is not higher than the reference heating performance, it may be determined whether the actual heating performance of the HVAC subsystem 11 for the passenger compartment is equal to the reference heating performance (S42). Specifically, by determining whether the actual temperature increase in the passenger compartment is equal to the reference temperature increase, it may be determined whether the actual heating performance of the HVAC subsystem 11 for the passenger compartment is equal to the reference heating performance.

When it is determined in S42 that the actual heating performance of the HVAC subsystem 11 for the passenger compartment is equal to the reference heating performance, the controller 1000 may control the first control valve 110 and the second control valve 120 to maintain the flow rate of the refrigerant into the exterior heat exchanger 35 at the flow rate of the refrigerant determined in S40 (S45).

When it is determined in S42 that the actual heating performance of the HVAC subsystem 11 for the passenger compartment is not equal to the reference heating performance, the controller 1000 may control the third control valve 130 to fully close the second outlet port 133 (S43).

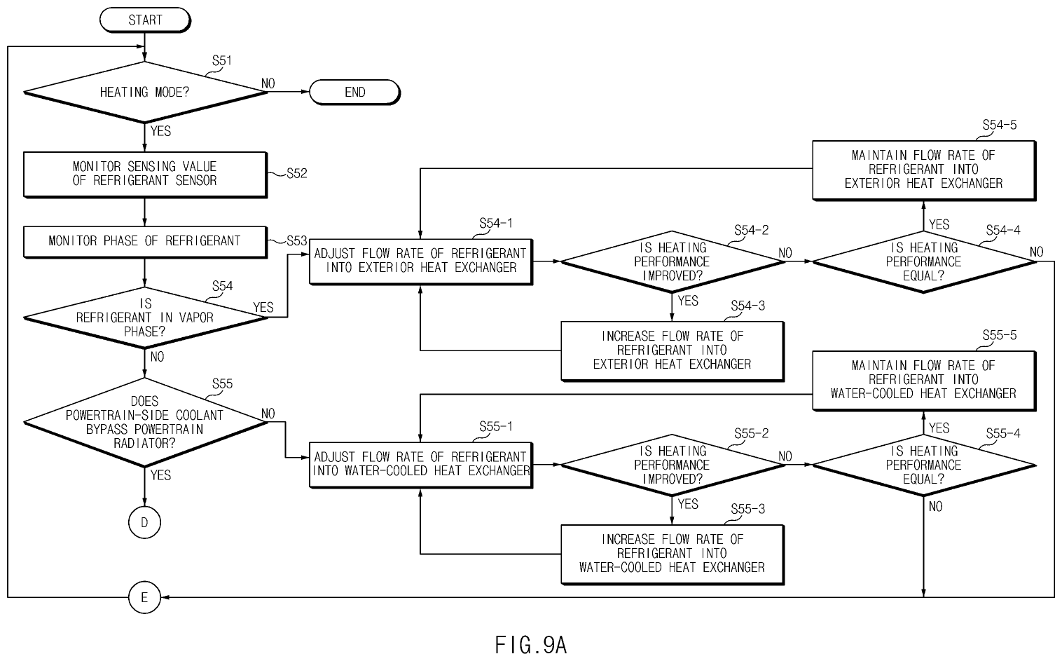

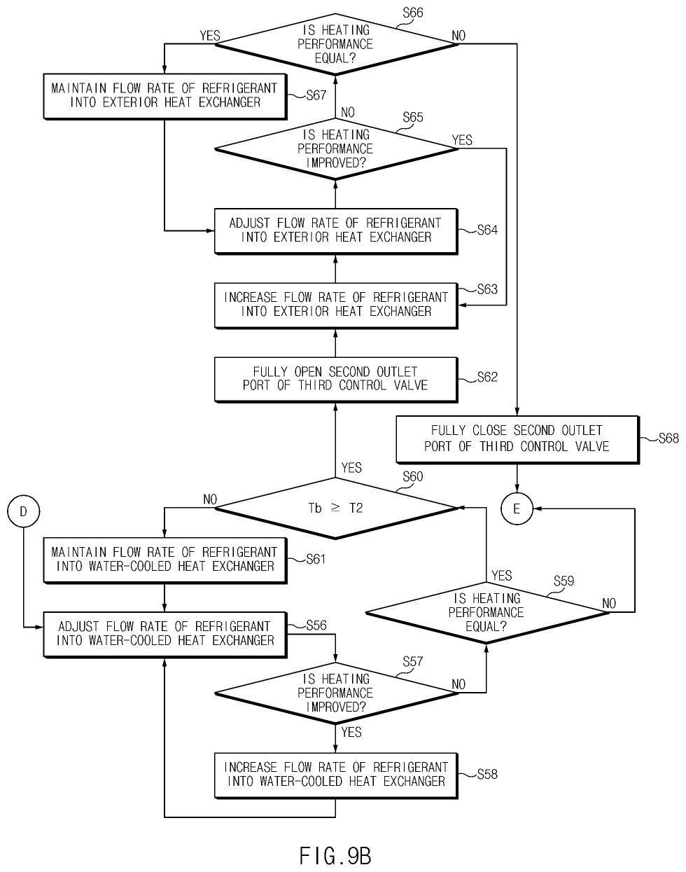

FIGS. 9A and 9B illustrate a method for controlling the flow of the refrigerant and/or the flow rate of the refrigerant based on a phase of the refrigerant when the HVAC subsystem 11 operates in a heating mode.

Referring to FIG. 9A, it may be determined whether the HVAC subsystem 11 operates in a heating mode (S51). When it is determined that the HVAC subsystem 11 does not operate in the heating mode, the method may end.

When it is determined that the HVAC subsystem 11 operates in the heating mode, a sensing value of the refrigerant sensor may be monitored (S52). The refrigerant sensor may be disposed on the downstream side of the exterior heat exchanger 35 and/or the downstream side of the first passage 71 of the water-cooled heat exchanger 70, and accordingly the refrigerant sensor may sense the temperature and pressure of the refrigerant discharged from the exterior heat exchanger 35 and/or the temperature and pressure of the refrigerant discharged from the first passage 71 of the water-cooled heat exchanger 70. The controller 1000 may monitor the sensing value (temperature and pressure) of the refrigerant sensor disposed on the downstream side of the exterior heat exchanger 35 and/or the downstream side of the first passage 71 of the water-cooled heat exchanger 70.

The controller 1000 may monitor a phase of the refrigerant discharged from the exterior heat exchanger 35 and/or a phase of the refrigerant discharged from the first passage 71 of the water-cooled heat exchanger 70 based on the sensing value of the refrigerant sensor (S53).

The controller 1000 may determine whether the refrigerant is in a saturated vapor phase based on the sensing value of the refrigerant sensor (S54). When the controller 1000 determines that the refrigerant is in the saturated vapor phase, it can be seen that the refrigerant is sufficiently evaporated by the exterior heat exchanger 35 and/or the water-cooled heat exchanger 70. When the controller 1000 determines that the refrigerant is not in the saturated vapor phase, it can be seen that the refrigerant is not sufficiently evaporated by the exterior heat exchanger 35 and/or the water-cooled heat exchanger 70 so that the refrigerant may be in two phases including vapor and liquid phases.

When it is determined in S54 that the refrigerant is in the saturated vapor phase, the controller 1000 may control the first control valve 110 and the second control valve 120 to adjust the flow rate of the refrigerant into the exterior heat exchanger 35 (S54-1). Specifically, the controller 1000 may control the first control valve 110 and the second control valve 120 to increase the flow rate of the refrigerant into the exterior heat exchanger 35 above the flow rate of the refrigerant into the first passage 71 of the water-cooled heat exchanger 70. The flow rate of the refrigerant into the exterior heat exchanger 35 may be determined based on the temperature and pressure of the refrigerant measured by the refrigerant sensor. Specifically, the opening degree of the first outlet port 112 of the first control valve 110 and the opening degree of the first outlet port 122 and/or the opening degree of the second outlet port 123 of the second control valve 120 may be determined using an opening-degree map of the first control valve 110 and an opening-degree map of the second control valve 120. The opening-degree map of the first control valve 110 may include the opening degree of the first outlet port 112 of the first control valve 110 determined based on the temperature and pressure of the refrigerant measured by the refrigerant sensor, and the opening-degree map of the second control valve 120 may include the opening degree of the first outlet port 122 and/or the opening degree of the second outlet port 123 of the second control valve 120 determined based on the temperature and pressure of the refrigerant measured by the refrigerant sensor.

After the flow rate of the refrigerant into the exterior heat exchanger 35 is adjusted in S54-1, it may be determined whether actual heating performance of the HVAC subsystem 11 for the passenger compartment is higher than reference heating performance (S54-2). Here, the reference heating performance refers to heating performance obtained when the HVAC subsystem uses at least a portion of the indoor air in the passenger compartment.

Specifically, by determining whether an actual temperature increase in the passenger compartment is greater than a reference temperature increase, it may be determined whether the actual heating performance of the HVAC subsystem 11 for the passenger compartment is higher than the reference heating performance. Here, the reference temperature increase refers to a temperature increase in the passenger compartment when the HVAC subsystem uses at least a portion of the indoor air in the passenger compartment.

When it is determined in S54-2 that the actual heating performance of the HVAC subsystem 11 for the passenger compartment is higher than the reference heating performance, the controller 1000 may control the first control valve 110 and the second control valve 120 to increase the flow rate of the refrigerant into the exterior heat exchanger 35 by a predetermined flow rate (S54-3).

When it is determined in S54-2 that the actual heating performance of the HVAC subsystem 11 for the passenger compartment is not higher than the reference heating performance, it may be determined whether the actual heating performance of the HVAC subsystem 11 for the passenger compartment is equal to the reference heating performance (S54-4). Specifically, by determining whether the actual temperature increase in the passenger compartment is equal to the reference temperature increase, it may be determined whether the actual heating performance of the HVAC subsystem 11 for the passenger compartment is equal to the reference heating performance.

When it is determined in S54-4 that the actual heating performance of the HVAC subsystem 11 for the passenger compartment is equal to the reference heating performance, the controller 1000 may control the first control valve 110 and the second control valve 120 to maintain the flow rate of the refrigerant into the exterior heat exchanger 35 at the flow rate of the refrigerant determined in S54-1 (S54-5).

When it is determined in S54-4 that the actual heating performance of the HVAC subsystem 11 for the passenger compartment is not equal to the reference heating performance, the method may return to S51.

When it is determined in S54 that the refrigerant is not in the saturated vapor phase, the controller 1000 may determine whether the powertrain-side coolant bypasses the powertrain radiator 53 (S55). For example, the controller 1000 or powertrain controller 1200 may control the three-way valve 63 to cause the powertrain-side coolant in the powertrain cooling subsystem 13 to bypass the powertrain radiator 53 when the temperature of the powertrain-side coolant is relatively low. Specifically, the controller 1000 may determine that the powertrain-side coolant bypasses the powertrain radiator 53 by the operation of the three-way valve 63 when the temperature Tc of the powertrain-side coolant is higher than or equal to the temperature Ta of the ambient air. The controller 1000 may determine that the powertrain-side coolant does not bypass the powertrain radiator 53 by the operation of the three-way valve 63 when the temperature Tc of the powertrain-side coolant is lower than the temperature Ta of the ambient air.

When it is determined in S55 that the powertrain-side coolant does not bypass the powertrain radiator 53, the controller 1000 may control the first control valve 110 to adjust the flow rate of the refrigerant into the first passage 71 of the water-cooled heat exchanger 70 (S55-1). Specifically, the controller 1000 may control the first control valve 110 to increase the flow rate of the refrigerant into the first passage 71 of the water-cooled heat exchanger 70 above the flow rate of the refrigerant into the exterior heat exchanger 35. The controller 1000 may adjust the opening degree of the first outlet port 112 of the first control valve 110, thereby adjusting the flow rate of the refrigerant into the first passage 71 of the water-cooled heat exchanger 70. For example, when the opening degree of the first outlet port 112 of the first control valve 110 is relatively reduced, the flow rate of the refrigerant into the first passage 71 of the water-cooled heat exchanger 70 may be relatively increased.

The flow rate of the refrigerant into the first passage 71 of the water-cooled heat exchanger 70 may be determined based on the temperature and pressure of the refrigerant measured by the refrigerant sensor. Specifically, the opening degree of the first outlet port 112 of the first control valve 110 may be determined using an opening-degree map of the first control valve 110. The opening-degree map of the first control valve 110 may include the opening degree of the first outlet port 112 of the first control valve 110 determined based on the temperature and pressure of the refrigerant measured by the refrigerant sensor.

After the flow rate of the refrigerant into the first passage 71 of the water-cooled heat exchanger 70 is adjusted in S55-1, it may be determined whether the actual heating performance of the HVAC subsystem 11 for the passenger compartment is higher than the reference heating performance (S55-2). Here, the reference heating performance refers to heating performance obtained when the HVAC subsystem uses at least a portion of the indoor air in the passenger compartment.

Specifically, by determining whether an actual temperature increase in the passenger compartment is greater than a reference temperature increase, it may be determined whether the actual heating performance of the HVAC subsystem 11 for the passenger compartment is higher than the reference heating performance. Here, the reference temperature increase refers to a temperature increase in the passenger compartment when the HVAC subsystem uses at least a portion of the indoor air in the passenger compartment.

When it is determined in S55-2 that the actual heating performance of the HVAC subsystem 11 for the passenger compartment is higher than the reference heating performance, the controller 1000 may control the first control valve 110 to increase the flow rate of the refrigerant into the first passage 71 of the water-cooled heat exchanger 70 by a predetermined flow rate (S55-3).

When it is determined in S55-2 that the actual heating performance of the HVAC subsystem 11 for the passenger compartment is not higher than the reference heating performance, it may be determined whether the actual heating performance of the HVAC subsystem 11 for the passenger compartment is equal to the reference heating performance (S55-4). Specifically, by determining whether the actual temperature increase in the passenger compartment is equal to the reference temperature increase, it may be determined whether the actual heating performance of the HVAC subsystem 11 for the passenger compartment is equal to the reference heating performance.

When it is determined in S55-4 that the actual heating performance of the HVAC subsystem 11 for the passenger compartment is equal to the reference heating performance, the controller 1000 may control the first control valve 110 to maintain the flow rate of the refrigerant into the first passage 71 of the water-cooled heat exchanger 70 at the flow rate of the refrigerant determined in S55-1 (S55-5).

When it is determined in S55-4 that the actual heating performance of the HVAC subsystem 11 for the passenger compartment is not equal to the reference heating performance, the method may return to S51.

FIG. 9B illustrates a method for controlling the flow of the refrigerant and/or the flow rate of the refrigerant when the powertrain-side coolant bypasses the powertrain radiator 53.

Referring to FIG. 9B, when it is determined that the powertrain-side coolant bypasses the powertrain radiator 53, the controller 1000 may control the first control valve 110 to adjust the flow rate of the refrigerant into the first passage 71 of the water-cooled heat exchanger 70 (S56). Specifically, the controller 1000 may control the first control valve 110 to increase the flow rate of the refrigerant into the first passage 71 of the water-cooled heat exchanger 70 above the flow rate of the refrigerant into the exterior heat exchanger 35. The controller 1000 may adjust the opening degree of the first outlet port 112 of the first control valve 110, thereby adjusting the flow rate of the refrigerant into the first passage 71 of the water-cooled heat exchanger 70. For example, when the opening degree of the first outlet port 112 of the first control valve 110 is relatively reduced, the flow rate of the refrigerant into the first passage 71 of the water-cooled heat exchanger 70 may be relatively increased.

The flow rate of the refrigerant into the first passage 71 of the water-cooled heat exchanger 70 may be determined based on the temperature and pressure of the refrigerant measured by the refrigerant sensor. Specifically, the opening degree of the first outlet port 112 of the first control valve 110 may be determined using an opening-degree map of the first control valve 110. The opening-degree map of the first control valve 110 may include the opening degree of the first outlet port 112 of the first control valve 110 determined based on the temperature and pressure of the refrigerant measured by the refrigerant sensor.

After the flow rate of the refrigerant into the first passage 71 of the water-cooled heat exchanger 70 is adjusted in S56, it may be determined whether actual heating performance of the HVAC subsystem 11 for the passenger compartment is higher than reference heating performance (S57). Here, the reference heating performance refers to heating performance obtained when the HVAC subsystem uses at least a portion of the indoor air in the passenger compartment.

Specifically, by determining whether an actual temperature increase in the passenger compartment is greater than a reference temperature increase, it may be determined whether the actual heating performance of the HVAC subsystem 11 for the passenger compartment is higher than the reference heating performance. Here, the reference temperature increase refers to a temperature increase in the passenger compartment when the HVAC subsystem uses at least a portion of the indoor air in the passenger compartment.

When it is determined in S57 that the actual heating performance of the HVAC subsystem 11 for the passenger compartment is higher than the reference heating performance, the controller 1000 may control the first control valve 110 to increase the flow rate of the refrigerant into the first passage 71 of the water-cooled heat exchanger 70 by a predetermined flow rate (S58).

When it is determined in S57 that the actual heating performance of the HVAC subsystem 11 for the passenger compartment is not higher than the reference heating performance, it may be determined whether the actual heating performance of the HVAC subsystem 11 for the passenger compartment is equal to the reference heating performance (S59). Specifically, by determining whether the actual temperature increase in the passenger compartment is equal to the reference temperature increase, it may be determined whether the actual heating performance of the HVAC subsystem 11 for the passenger compartment is equal to the reference heating performance.

When it is determined in S59 that the actual heating performance of the HVAC subsystem 11 for the passenger compartment is equal to the reference heating performance, it may be determined whether the temperature Tb of the battery 41 or the temperature of the battery-side coolant is higher than or equal to the second reference temperature T2 (S60). The second reference temperature T2 refers to a temperature of the battery or the battery-side coolant which has increased enough to evaporate the refrigerant. When the temperature Tb of the battery 41 or the temperature of the battery-side coolant is higher than or equal to the second reference temperature T2, the refrigerant may be additionally evaporated by absorbing heat generated from the battery 41 in the battery chiller 37.

When it is determined in S60 that the temperature Tb of the battery 41 or the temperature of the battery-side coolant is lower than the second reference temperature T2, the controller 1000 may control the first control valve 110 to maintain the flow rate of the refrigerant into the first passage 71 of the water-cooled heat exchanger 70 at the flow rate of the refrigerant determined in S56 (S61).

When it is determined in S59 that the actual heating performance of the HVAC subsystem 11 for the passenger compartment is not equal to the reference heating performance, the method may return to S51.

When it is determined in S60 that the temperature Tb of the battery 41 or the temperature of the battery-side coolant is higher than or equal to the second reference temperature T2, the controller 1000 may control the third control valve 130 to fully open the second outlet port 133 (S62). Referring to FIG. 3, as the second outlet port 133 of the third control valve 130 is fully opened, the refrigerant discharged from the exterior heat exchanger 35 may be directed to the first passage 37a of the battery chiller 37, and the refrigerant passing through the first passage 37a of the battery chiller 37 may absorb heat from the battery-side coolant passing through the second passage 37b of the battery chiller 37 and be evaporated.

After the second outlet port 133 of the third control valve 130 is fully opened, the controller 1000 may control the first control valve 110 to increase the flow rate of the refrigerant into the exterior heat exchanger 35 (S63). Specifically, the controller 1000 may increase the flow rate of the refrigerant into the exterior heat exchanger 35 by relatively increasing the opening degree of the first outlet port 112 of the first control valve 110.

Thereafter, the controller 1000 may control the first control valve 110 to adjust the flow rate of the refrigerant into the exterior heat exchanger 35 (S64). Specifically, the controller 1000 may adjust the opening degree of the first outlet port 112 of the first control valve 110, thereby adjusting the flow rate of the refrigerant into the exterior heat exchanger 35. For example, when the opening degree of the first outlet port 112 of the first control valve 110 is relatively increased, the flow rate of the refrigerant into the exterior heat exchanger 35 may be relatively increased.

The flow rate of the refrigerant into the exterior heat exchanger 35 may be determined based on the temperature and pressure of the refrigerant measured by the refrigerant sensor. Specifically, the opening degree of the first outlet port 112 of the first control valve 110 may be determined using an opening-degree map of the first control valve 110. The opening-degree map of the first control valve 110 may include the opening degree of the first outlet port 112 of the first control valve 110 determined based on the temperature and pressure of the refrigerant.

After S64, it may be determined whether the actual heating performance of the HVAC subsystem 11 for the passenger compartment is higher than the reference heating performance (S65). Here, the reference heating performance refers to heating performance obtained when the HVAC subsystem uses at least a portion of the indoor air in the passenger compartment.

Specifically, by determining whether an actual temperature increase in the passenger compartment is greater than a reference temperature increase, it may be determined whether the actual heating performance of the HVAC subsystem 11 for the passenger compartment is higher than the reference heating performance. Here, the reference temperature increase refers to a temperature increase in the passenger compartment when the HVAC subsystem uses at least a portion of the indoor air in the passenger compartment.

When it is determined in S65 that the actual heating performance of the HVAC subsystem 11 for the passenger compartment is higher than the reference heating performance, the controller 1000 may control the first control valve 110 to increase the flow rate of the refrigerant into the exterior heat exchanger 35 by a predetermined flow rate (S63).

When it is determined in S65 that the actual heating performance of the HVAC subsystem 11 for the passenger compartment is not higher than the reference heating performance, it may be determined whether the actual heating performance of the HVAC subsystem 11 for the passenger compartment is equal to the reference heating performance (S66). Specifically, by determining whether the actual temperature increase in the passenger compartment is equal to the reference temperature increase, it may be determined whether the actual heating performance of the HVAC subsystem 11 for the passenger compartment is equal to the reference heating performance.

When it is determined in S66 that the actual heating performance of the HVAC subsystem 11 for the passenger compartment is equal to the reference heating performance, the controller 1000 may control the first control valve 110 to maintain the flow rate of the refrigerant into the exterior heat exchanger 35 at the flow rate of the refrigerant determined in S64 (S67).

When it is determined in S66 that the actual heating performance of the HVAC subsystem 11 for the passenger compartment is not equal to the reference heating performance, the controller 1000 may control the third control valve 130 to fully close the second outlet port 133 (S68). Then, the method may return to S51.

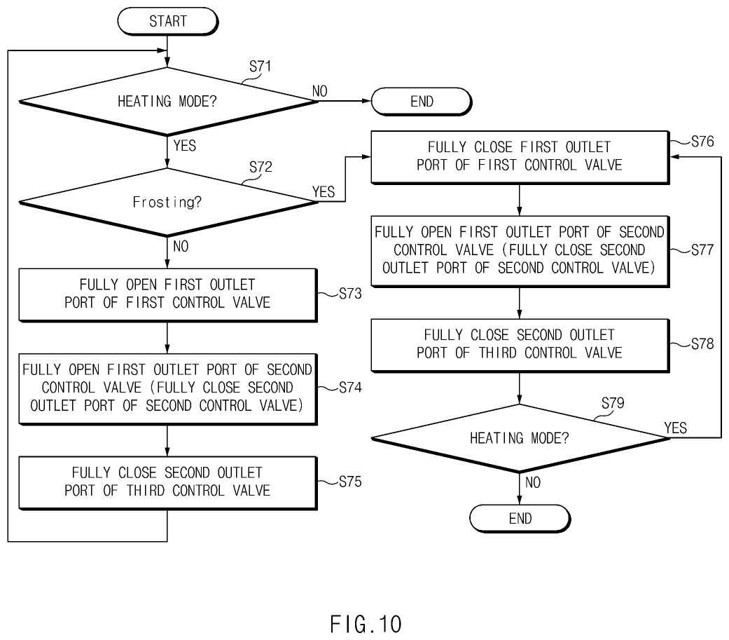

FIG. 10 illustrates a method for controlling the flow of the refrigerant and/or the flow rate of the refrigerant based on whether frosting occurs in the exterior heat exchanger 35.

Referring to FIG. 10, it may be determined whether the HVAC subsystem 11 operates in a heating mode (S71). When it is determined that the HVAC subsystem 11 does not operate in the heating mode, the method may end.

The controller 1000 may determine whether frosting occurs in the exterior heat exchanger 35 (S72). The controller 1000 may determine whether frosting has occurred in the exterior heat exchanger using various sensors disposed on the exterior heat exchanger 35.

When it is determined that frosting does not occur in the exterior heat exchanger 35, the controller 1000 may control the first control valve 110 to fully open the first outlet port 112 (S73). Here, the controller 1000 may control the first control valve 110 to adjust the opening/closing, opening degree, and the like of the second outlet port 113 based on whether dehumidification in the passenger compartment is required.

Thereafter, the controller 1000 may control the second control valve 120 to fully open the first outlet port 122 and fully close the second outlet port 123 (S74). As the first outlet port 112 of the first control valve 110 is fully opened, and the first outlet port 122 of the second control valve 120 is fully opened, the low-temperature refrigerant may be uniformly distributed to the exterior heat exchanger 35 and the first passage 71 of the water-cooled heat exchanger 70.

Then, the controller 1000 may control the third control valve 130 to adjust the opening degree of the first outlet port 132 and to fully close the second outlet port 133 (S75). As the opening degree of the first outlet port 132 of the third control valve 130 is adjusted, and the second outlet port 133 of the third control valve 130 is fully closed, the refrigerant may be directed to the compressor 32 through the accumulator 38, and the refrigerant may not be directed to the first passage 37a of the battery chiller 37.

When it is determined that frosting occurs in the exterior heat exchanger 35, the controller 1000 may control the first control valve 110 to fully close the first outlet port 112 of the first control valve 110 (S76).

Thereafter, the controller 1000 may control the second control valve 120 to fully open the first outlet port 122 and fully close the second outlet port 123 (S77). As the first outlet port 112 of the first control valve 110 is fully closed, and the second outlet port 123 of the second control valve 120 is fully closed, the low-temperature refrigerant may only be directed to the first passage 71 of the water-cooled heat exchanger 70.

Then, the controller 1000 may control the third control valve 130 to adjust the opening degree of the first outlet port 132 and to fully close the second outlet port 133 (S78). As the opening degree of the first outlet port 132 of the third control valve 130 is adjusted, and the second outlet port 133 of the third control valve 130 is fully closed, the refrigerant may be directed to the compressor 32 through the accumulator 38, and the refrigerant may not be directed to the first passage 37a of the battery chiller 37.

Then, it may be determined whether the HVAC subsystem 11 operates in the heating mode (S79). When it is determined that the HVAC subsystem 11 operates in the heating mode, the method may return to S76. When it is determined that the HVAC subsystem 11 does not operate in the heating mode, the method may end.

As set forth above, the vehicle thermal management system and the method for controlling the same according to exemplary embodiments of the present disclosure may be designed to allow the refrigerant to selectively absorb heat from the ambient air and/or the waste heat of the powertrain component based on the temperature of the ambient air, the temperature of the powertrain component (the powertrain-side coolant), and the phase of the refrigerant, thereby improving the refrigerant evaporation performance and heating performance of the HVAC subsystem.

According to exemplary embodiments of the present disclosure, as the refrigerant is allowed to selectively absorb heat from the ambient air and/or the waste heat of the powertrain component, the heating performance may be improved. Accordingly, power consumption of the PTC heater may be relatively reduced, and energy efficiency of the vehicle may be improved. When the HVAC subsystem operates in the heating mode in a low ambient temperature condition, all electric range (AER) of the vehicle may be increased.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A vehicle thermal management system, comprising:
a heating, ventilation, and air conditioning (HVAC) subsystem thermally connected to a passenger compartment; and
a powertrain cooling subsystem thermally connected to a powertrain component,
wherein the HVAC subsystem includes a compressor, an interior condenser disposed on a downstream side of the compressor, a heating-side expansion valve disposed on the downstream side of the interior condenser, an exterior heat exchanger disposed on the downstream side of the heating-side expansion valve, a first distribution conduit extending from a downstream point of the heating-side expansion valve to an upstream point of the compressor, a water-cooled heat exchanger disposed on the first distribution conduit, a first control valve disposed on an upstream side of the exterior heat exchanger, a second control valve disposed on the first distribution conduit, a third control valve disposed on the downstream side of the exterior heat exchanger, a cooling-side expansion valve disposed on the downstream side of the third control valve, and an evaporator disposed on the downstream side of the cooling-side expansion valve, and
the water-cooled heat exchanger is configured to transfer heat between the first distribution conduit and the powertrain cooling subsystem.

2. The vehicle thermal management system according to claim 1, wherein the first control valve includes an inlet port communicating with the heating-side expansion valve, and a first outlet port communicating with the exterior heat exchanger, and
the first control valve is configured to adjust an opening degree of the first outlet port.

3. The vehicle thermal management system according to claim 2, further comprising a dehumidification bypass conduit extending from the downstream point of the heating-side expansion valve to an upstream point of the evaporator,
wherein the first control valve further includes a second outlet port communicating with the dehumidification bypass conduit.

4. The vehicle thermal management system according to claim 1, wherein the second control valve includes an inlet port communicating with the water-cooled heat exchanger, and a first outlet port communicating with the compressor, and
the second control valve is configured to adjust an opening degree of the first outlet port.

5. The vehicle thermal management system according to claim 4, further comprising a first branch conduit extending from the first distribution conduit to an upstream point of the exterior heat exchanger,
wherein the second control valve further includes a second outlet port communicating with the first branch conduit, and
the second control valve is configured to adjust an opening degree of the second outlet port.

6. The vehicle thermal management system according to claim 1, further comprising a second branch conduit extending from the first distribution conduit to a downstream point of the exterior heat exchanger.

7. The vehicle thermal management system according to claim 6, wherein the third control valve includes an inlet port communicating with the exterior heat exchanger and a first outlet port communicating with the second branch conduit.

8. The vehicle thermal management system according to claim 7, further comprising a battery cooling subsystem thermally connected to a battery;
a second distribution conduit extending from an upstream point of the cooling-side expansion valve to the upstream point of the compressor; and
a battery chiller configured to transfer heat between the second distribution conduit and the battery cooling subsystem.

9. The vehicle thermal management system according to claim 8, wherein the third control valve further includes a second outlet port communicating with the battery chiller.

10. A method for controlling a vehicle thermal management system, the method comprising:
allowing a powertrain-side coolant to circulate through a powertrain cooling subsystem;
allowing a refrigerant to circulate through an HVAC subsystem in a heating mode; and
selectively adjusting a flow rate of the refrigerant into an exterior heat exchanger and/or a flow rate of the refrigerant into a water-cooled heat exchanger based on a temperature of the powertrain-side coolant or a phase of the refrigerant,
wherein the exterior heat exchanger is configured to transfer heat between ambient air and the refrigerant, and
the water-cooled heat exchanger is configured to transfer heat between the refrigerant and the powertrain-side coolant.

11. The method according to claim 10, further comprising:
adjusting the flow rate of the refrigerant into the exterior heat exchanger based on the temperature of the powertrain-side coolant, a temperature of the ambient air, and a temperature of a powertrain component when the temperature of the powertrain-side coolant is lower than the temperature of the ambient air; and
increasing the flow rate of the refrigerant into the exterior heat exchanger by a predetermined flow rate when actual heating performance of the HVAC subsystem for a passenger compartment is higher than reference heating performance.

12. The method according to claim 10, further comprising:
adjusting the flow rate of the refrigerant into the water-cooled heat exchanger based on the temperature of the powertrain-side coolant, a temperature of the ambient air, and a temperature of a powertrain component when a temperature difference value between the temperature of the powertrain-side coolant and the temperature of the ambient air is greater than or equal to a threshold value; and
increasing the flow rate of the refrigerant into the water-cooled heat exchanger by a predetermined flow rate when actual heating performance of the HVAC subsystem for a passenger compartment is higher than reference heating performance.

13. The method according to claim 10, further comprising increasing the flow rate of the refrigerant into the exterior heat exchanger above the flow rate of the refrigerant into the water-cooled heat exchanger when a temperature of a powertrain component is higher than or equal to a first reference temperature.

14. The method according to claim 13, further comprising:
adjusting the flow rate of the refrigerant into the exterior heat exchanger based on the temperature of the powertrain-side coolant, the temperature of the ambient air, and the temperature of the powertrain component when the temperature of the powertrain component is lower than the first reference temperature; and
increasing the flow rate of the refrigerant into the water-cooled heat exchanger by a predetermined flow rate when actual heating performance of the HVAC subsystem for a passenger compartment is higher than reference heating performance.

15. The method according to claim 10, further comprising:
allowing a battery-side coolant to circulate through a battery cooling subsystem; and
directing the refrigerant discharged from the exterior heat exchanger to a battery chiller when a temperature of a battery is higher than or equal to a second reference temperature,
wherein the battery chiller is configured to transfer heat between the refrigerant and the battery-side coolant.

16. The method according to claim 15, further comprising:
adjusting the flow rate of the refrigerant into the exterior heat exchanger based on the temperature of the powertrain-side coolant, a temperature of the ambient air, and a temperature of a powertrain component; and
increasing the flow rate of the refrigerant into the water-cooled heat exchanger by a predetermined flow rate when actual heating performance of the HVAC subsystem for a passenger compartment is higher than reference heating performance.

17. The method according to claim 10, further comprising:
allowing a battery-side coolant to circulate through a battery cooling subsystem when a charging time of a battery is within a threshold time; and
directing the refrigerant discharged from the exterior heat exchanger to a battery chiller when a temperature of the battery is higher than or equal to a second reference temperature,
wherein the battery chiller is configured to transfer heat between the refrigerant and the battery-side coolant.

18. The method according to claim 10, further comprising:
adjusting the flow rate of the refrigerant into the exterior heat exchanger based on temperature and pressure of the refrigerant when the refrigerant discharged from the exterior heat exchanger or the water-cooled heat exchanger is in a vapor phase; and
increasing the flow rate of the refrigerant into the water-cooled heat exchanger by a predetermined flow rate when actual heating performance of the HVAC subsystem for a passenger compartment is higher than reference heating performance.

19. The method according to claim 10, further comprising:
determining whether the powertrain-side coolant bypasses a powertrain radiator when the refrigerant discharged from the exterior heat exchanger or the water-cooled heat exchanger is in two phases; and
adjusting the flow rate of the refrigerant into the water-cooled heat exchanger based on temperature and pressure of the refrigerant when the powertrain-side coolant bypasses the powertrain radiator.
